(19) United States
(12) Patent Application Publication
(10) Pub. No.: US 2016/0042610 A1
(43) Pub. Date: Feb. 11, 2016

(54) Gaming Machine

(71) Applicants: Universal Entertainment Corporation, Tokyo (JP); Aruze Gaming America, Inc., Las Vegas (JP)

(72) Inventors: Kenta KITAMURA, Tokyo (JP); Yuuki TERADA, Tokyo (JP); Takeshi NARITA, Tokyo (JP); Hiromoto YAMAUCHI, Tokyo (JP)

(21) Appl. No.: 14/820,232

(22) Filed: Aug. 6, 2015

(30) Foreign Application Priority Data
Aug. 7, 2014 (JP) 2014-161658

(51) Int. Cl. G07F 17/32; G07F 17/34

(52) U.S. Cl. CPC G07F 17/3267; G07F 17/34; G07F 17/3244

(57) ABSTRACT

There are provided highly entertaining games. A gaming machine 300 includes reels 151 to 155 each of which is configured to allow a predetermined type of symbols 502 to be stacked thereon. In a free game, a payout for establishment of a prize is multiplied by a multiplying factor depending on the number of rearranged wild symbols 503b.

### CROSS REFERENCE TO RELATED APPLICATION

The present application claims priority from Japanese Patent Application No. 2014-161658, which was filed on Aug. 7, 2014, the disclosure of which is herein incorporated by reference in its entirety.

### FIELD OF THE INVENTION

The present invention relates to a gaming machine configured to rearrange symbols after variably displaying the same.

### BACKGROUND OF THE INVENTION

A known slot machine is disclosed, for example, in Patent Literature 1 (U.S. Patent Publication No. 2011/0250947). In such a slot machine, a plurality of symbols in a symbol display area at the front side of its cabinet are scrolled when a player inserts a coin, a bill, or the like into an insertion slot of the slot machine and operates a spin button. The symbols are then automatically stopped. Various prizes such as a bonus are established based on how the symbols are stopped.

In gaming machines such as the known slot machine above, when a trigger condition is established in a normal game, shifting from the normal game to a bonus game is achieved. As such, the gaming machines allow players to play highly entertaining games. In other words, providing highly entertaining games has been an important point in the gaming machines.

In view of the above, an object of the present invention is to provide a highly-entertaining gaming machine.

### BRIEF SUMMARY OF THE INVENTION

According to an aspect of the present invention, a gaming machine including one or more reels each of which is configured to allow a predetermined type of symbols to be stacked thereon includes: a symbol display device configured to variably display and rearrange symbols including the predetermined type of symbols and one or more wild symbols which are able to substitute for the predetermined type of symbols on reels in a plurality of columns; and a controller programmed to execute the processes of: (a1) executing a free game when a trigger condition is established based on a rearrangement manner of the symbols on the symbol display device, and (a2) awarding a special payout when, in the free game, there is caused a rearrangement manner where a prize is established with the one or more wild symbols rearranged, the special payout being calculated by multiplying a payout for the prize by a multiplying factor depending on the number of the rearranged wild symbols.

With the above structure, establishment of a prize is facilitated since the predetermined type of symbols are stacked on the one or more reels. In addition to this, in the free game, the wild symbols function not only as substitute symbols but also as symbols depending on which the multiplying factor for the payout is determined. This eliminates the necessity to additionally provide a symbol for the multiplying factor as generally provided, and a large amount of special payout to be awarded is calculated by multiplying a payout for a prize by a multiplying factor depending on the rearranged wild symbols.

According to another aspect of the present invention, a gaming machine including one or more reels each of which is configured to allow a predetermined type of symbols to be stacked thereon includes: a symbol display device configured to variably display and rearrange symbols including the predetermined type of symbols and one or more wild symbols which are able to substitute for the predetermined type of symbols on reels in a plurality of columns; a symbol data table in which the symbols are stored in association with the reels in the plurality of columns; and a controller programmed to execute the following processes.

(b1) executing a normal game by rearranging the symbols on the symbol display device based on the symbol data table; (b2) determining whether a trigger condition is established in the normal game based on a rearrangement manner of the symbols; (b3) when it is determined that the trigger condition is established, executing a free game as a feature game by rearranging the symbols based on the symbol data table, and changing setting so that, in the feature game, the wild symbols function as substitute symbols for the predetermined type of symbols and as symbols used for determining a multiplying factor; and (b4) awarding a special payout when, in the free game as the feature game, there is caused a rearrangement manner where a prize is established with the one or more wild symbols rearranged, the special payout being calculated by multiplying a payout for the prize by a multiplying factor depending on the number of the rearranged wild symbols.

With the above structure, establishment of a prize is facilitated since the predetermined type of symbols are stacked on the one or more reels. In addition to this, in the free game, the wild symbols function not only as substitute symbols, as are in the normal game, but also as symbols used to determine the multiplying factor for the payout. This eliminates the necessity to additionally provide a symbol for the multiplying factor as generally provided, and a large amount of special payout to be awarded is calculated by multiplying a payout for a prize by a multiplying factor depending on the rearranged wild symbols.

The gaming machine of the present invention may be adapted so that: the symbol data table includes a symbol data table for the normal game and a symbol data table for the feature game; the number of the wild symbols in the symbol data table for the feature game is larger than the number of the wild symbols in the symbol data table for the normal game; and the controller uses the symbol data table for the normal game as the symbol data table in the process of (b1), and uses the symbol data table for the feature game as the symbol data table in the process of (b3).

With the above structure, the symbol data table having the larger number of the wild symbols than that for the normal game is used in the feature game, and this increases the possibility of rearrangement of the wild symbols.

The gaming machine of the present invention may be adapted so that: the symbol data table includes a symbol data table for the normal game and a symbol data table for the feature game; the symbol data table for the feature game has a data structure in which the number of the predetermined symbols stacked is larger than that in the symbol data table for the normal game; and the controller uses the symbol data table for the normal game as the symbol data table in the process of (b1), and uses the symbol data table for the feature game as the symbol data table in the process of (b3).

With the above structure, the symbol data table having the data structure in which the number of the predetermined type of symbols stacked is larger than that for the normal game is used in the feature game, and this increases the possibility of establishment of a plurality of prizes.

The gaming machine of the present invention may be adapted so that: the controller is programmed to execute a process of rearranging the symbols, on the symbol display device, for each column sequentially from the first column to the last column of the reels; and the symbol data table for the feature game has a data structure in which an increase in the number of the predetermined type of symbols stacked on the reel of the last column is the largest among those on all the reels in the columns.

With the above structure, the increase in the number of the predetermined type of symbols stacked on the reel of the last column is the largest among those on all the reels in the columns. This increases the possibility that a plurality of prizes are established at the last of the free game in the feature game.

The gaming machine of the present invention may be adapted so that the symbol data table for the feature game stores therein the wild symbols only in association with the reels of one or more columns interposed between the first column and the last column.

With the above structure, one or more wild symbols may be rearranged in the course of rearrangement of the symbols for each column of the reel sequentially from the first column to the last column. This provides a player with expectation for the possibility that a large prize is established.

The gaming machine of the present invention may be adapted so that the symbol data table for the feature game has a data structure in which the wild symbols are placed so as to sandwich a stack of the predetermined type of symbols.

With the above structure, the stack of the predetermined type of symbols is sandwiched by the wild symbols. This increases the possibility that the wild symbols are rearranged adjacent to the rearranged stack of the predetermined symbols. Thereby, expectation for a large payout is provided to the player.

The gaming machine of the present invention may be adapted so that: in the normal game, the controller determines whether a prize is established utilizing a function of the wild symbols as a substitute for any type of symbols; and in the free game of the feature game, the controller determines whether a prize is established utilizing the function of the wild symbols as a substitute for any type of symbols, and calculates a payout by multiplying a payout for the prize by a multiplying factor depending on the number of the rearranged wild symbols utilizing a function of the wild symbols as a basis for the multiplying factor.

With the above structure, the functions of the wild symbols are used differently between the normal game and the free game of the feature game. After shifting to the feature game, a game is executed with the wild symbols having increased functions. Further, in the free game of the feature game, the wild symbols function not only as the substitute symbols but also the symbols based on which the multiplying factor is determined. This eliminates the necessity to additionally provide a symbol for the multiplying factor as generally provided.

The present invention provides highly entertaining games.

### BRIEF DESCRIPTION OF THE DRAWINGS

FIG. 1 illustrates an operation state of a gaming machine.

FIG. 2 is a diagram showing a function flow of the gaming machine.

FIG. 3 is a diagram showing a function flow of the gaming machine.

FIG. 4 is a block diagram of a gaming system.

FIG. 5 is a block diagram of a PTS system.

FIG. 6 is a block diagram of the PTS system.

FIG. 7 is a perspective view of a slot machine in the gaming machine.

FIG. 8 is an electrical block diagram of the slot machine in the gaming machine.

FIG. 9 illustrates winning combinations.

FIG. 10A illustrates a symbol.

FIG. 10B illustrates a symbol.

FIG. 10C illustrates a symbol.

FIG. 10D illustrates a symbol.

FIG. 10E illustrates a symbol.

FIG. 10F illustrates a symbol.

FIG. 10G illustrates a symbol.

FIG. 10H illustrates a symbol.

FIG. 10I illustrates a symbol.

FIG. 10J illustrates a symbol.

FIG. 10K illustrates a symbol.

FIG. 10L illustrates a symbol.

FIG. 10M illustrates a symbol.

FIG. 10N illustrates a spin table of spin data.

FIG. 11A illustrates a symbol table.

FIG. 11B illustrates the symbol table.

FIG. 12A illustrates a symbol table.

FIG. 12B illustrates the symbol table.

FIG. 13A illustrates a symbol table.

FIG. 13B illustrates the symbol table.

FIG. 14A illustrates a symbol table.

FIG. 14B illustrates the symbol table.

FIG. 15A illustrates a symbol table.

FIG. 15B illustrates the symbol table.

FIG. 16A illustrates a symbol table.

FIG. 16B illustrates the symbol table.

FIG. 17A illustrates a symbol table.

FIG. 17B illustrates the symbol table.

FIG. 18A illustrates a symbol table.

FIG. 18B illustrates the symbol table.

FIG. 19A illustrates a symbol table.

FIG. 19B illustrates the symbol table.

FIG. 20A illustrates a symbol table.

FIG. 20B illustrates the symbol table.

FIG. 21 is a frontal view of a control panel.

FIG. 22 illustrates the control panel.

FIG. 23 illustrates the button configuration of the control panel.

FIG. 24 illustrates the button configuration of the control panel.

FIG. 25 illustrates a game screen.

FIG. 26 illustrates a game screen.

FIG. 27 illustrates a WIN meter.

FIG. 28 illustrates a system font area.

FIG. 29A shows a language switching touch button.

FIG. 29B illustrates the language switching touch button.

FIG. 29C illustrates the language switching touch button.

FIG. 29D illustrates the language switching touch button.

FIG. 29E illustrates the language switching touch button.

FIG. 29F illustrates the language switching touch button.

FIG. 29G illustrates the language switching touch button.

FIG. 29H illustrates the language switching touch button.

FIG. 30 shows the lighting state of the language switching touch button.

FIG. 31 illustrates the language switching touch button.

FIG. 32 illustrates a sound volume switching touch button.

FIG. 33 illustrates an AUDIT screen.

FIG. 34 illustrates an AUDIT screen.

FIG. 35 illustrates an AUDIT screen.

FIG. 36 illustrates display languages.

FIG. 37 illustrates an AUDIT screen.

FIG. 38 illustrates a help screen.

FIG. 39 illustrates a help screen.

FIG. 40 illustrates the relationship between the control panel and the buttons.

FIG. 41A illustrates 4 WAYS bet.

FIG. 41B illustrates 16 WAYS bet.

FIG. 41C illustrates 64 WAYS bet.

FIG. 41D illustrates 256 WAYS bet.

FIG. 41E illustrates 1024 WAYS bet.

FIG. 42 illustrates a paytable in the help screen.

FIG. 43 illustrates a paytable in the help screen.

FIG. 44 illustrates command names in a presentation mode and their respective brief descriptions.

FIG. 45 is a flowchart of a normal game execution process.

FIG. 46 is a flowchart of a feature game execution process.

FIG. 47A illustrates a feature game.

FIG. 47B illustrates the feature game.

FIG. 47C illustrates the feature game.

FIG. 47D illustrates the feature game.

FIG. 47E illustrates the feature game.

FIG. 47F illustrates the feature game.

FIG. 47G illustrates the feature game.

FIG. 47H illustrates the feature game.

FIG. 47I illustrates the feature game.

FIG. 47J illustrates the feature game.

FIG. 48A illustrates a process of re-triggering.

FIG. 48B illustrates the process of re-triggering.

FIG. 48C illustrates the process of re-triggering.

FIG. 49A illustrates a WIN effect.

FIG. 49B illustrates a WIN effect.

FIG. 49C illustrates a WIN effect.

FIG. 49D illustrates a WIN effect.

FIG. 49E illustrates a WIN effect.

FIG. 49F illustrates a WIN effect.

FIG. 50A illustrates a WIN effect.

FIG. 50B illustrates a WIN effect.

FIG. 50C illustrates a WIN effect.

FIG. 50D illustrates a WIN effect.

FIG. 50E illustrates a WIN effect.

FIG. 50F illustrates a WIN effect.

FIG. 50G illustrates a WIN effect.

FIG. 51A illustrates a WIN effect.

FIG. 51B illustrates a WIN effect.

FIG. 51C illustrates a WIN effect.

FIG. 52A illustrates a WIN effect.

FIG. 52B illustrates a WIN effect.

FIG. 52C illustrates a WIN effect.

FIG. 53A illustrates a display on a WIN signboard.

FIG. 53B illustrates a display on the WIN signboard.

FIG. 54A illustrates a display on the WIN signboard.

FIG. 54B illustrates a display on the WIN signboard.

FIG. 55 illustrates WIN ranks.

FIG. 56 illustrates increments in the WIN effect.

FIG. 57 illustrates increments in the WIN effect for normal WIN.

FIG. 58 illustrates a sound effect provided when 3 feature symbols appear.

FIG. 59A illustrates a process of the sound effect.

FIG. 59B illustrates the process of the sound effect.

FIG. 59C illustrates the process of the sound effect.

FIG. 59D illustrates the process of the sound effect.

FIG. 60 illustrates the sound effect.

FIG. 61 illustrates the relationship among obtained credit amounts, effects, and display seconds.

FIG. 62A illustrates a total WIN signboard after a free game.

FIG. 62B illustrates the total WIN signboard after the free game.

FIG. 62C illustrates the total WIN signboard after the free game.

FIG. 63A illustrates a gamble game.

FIG. 63B illustrates the gamble game.

FIG. 63C illustrates the gamble game.

FIG. 63D illustrates the gamble game.

FIG. 63E illustrates the gamble game.

FIG. 63F illustrates the gamble game.

FIG. 63G illustrates the gamble game.

FIG. 64 illustrates a residual gamble game.

### DETAILED DESCRIPTION OF THE PREFERRED EMBODIMENT

The following will describe a gaming machine of the present invention with reference to figures.

### (Outline of Gaming Machine)

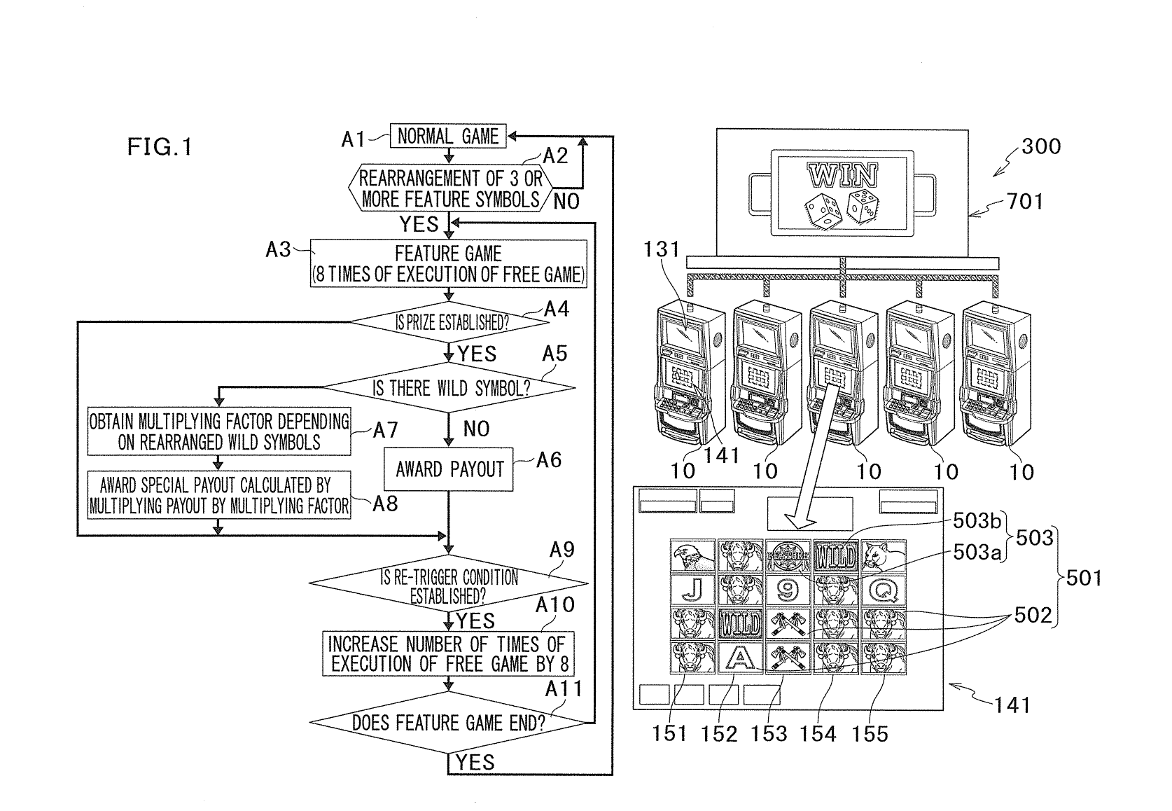

As shown in FIG. 1, a gaming machine 300 includes reels 151 to 155 which are configured to allow a predetermined type of symbols 502 to be stacked. In a free game, a payout for establishment of a prize is multiplied by a multiplying factor depending on the number of rearranged wild symbols 503b. Herein, “stacked” means the situation when symbols 501 are rearranged on a lower image display panel 141, two or more symbols 501 of the same type are contiguous to each other in a direction in which the reels 151 to 155 are variably displayed. In other words, “stacked” means that symbols 501 of the same type adjacent to each other in the direction in which the reels 151 to 155 are variably displayed are rearranged.

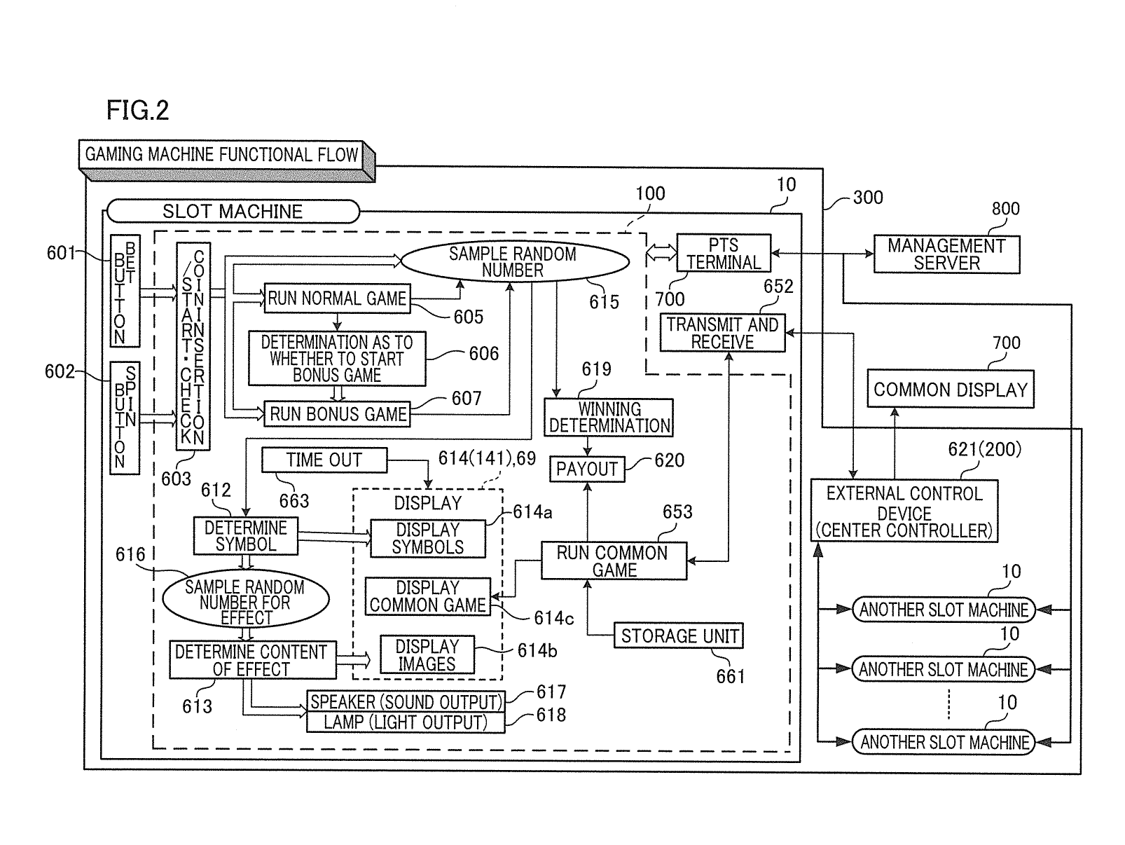

More specifically, the gaming machine 300 includes: the lower image display panel 141 (symbol display device) configured to variably display and rearrange symbols 501 including the predetermined type of symbols 502 and one or more wild symbols 503b which are able to substitute for the predetermined type of symbols 502, on the reels 151 to 155 in a plurality of, e.g., five columns; and a game controller 100 shown in FIG. 2 and programmed to execute the following processes (a1) and (a2). (a1) is the process of executing a free game when a trigger condition is established based on a rearrangement manner of the symbols 501 on the lower image display panel 141. (a2) is the process of awarding a special payout when, in the free game, there is caused a rearrangement manner where a prize is established with one or more wild symbols 503b rearranged. The special payout is calculated by multiplying a payout for the prize by a multiplying factor depending on the number of the rearranged wild symbols 503b.

With the above structure, in the gaming machine 300, establishment of a prize is facilitated since the predetermined type of symbols 502 are stacked on the one or more of the reels 151 to 155. In addition to this, in the free game, the wild symbols 503b function not only as substitute symbols but also as symbols used to determine the multiplying factor for the payout. This eliminates the necessity to additionally provide a symbol for the multiplying factor as generally provided. A large amount of special payout to be awarded is calculated by multiplying the payout for the prize by the multiplying factor depending on the number of the rearranged wild symbols 503b. Thus, highly entertaining games are provided.

More specifically, the gaming machine 300 includes: the lower image display panel 141 configured to variably display and rearrange symbols 501 including the predetermined type of symbols 502 and one or more wild symbols 503b which are able to substitute for the predetermined type of symbols 502 on the reels 151 to 155 in the plurality of columns; a later-described symbol data table in which the symbols 501 are stored in association with the reels 151 to 155 in the plurality of columns; and a game controller 100 programmed to execute the following processes (b1) to (b4).

(b1) is the process of executing a normal game by rearranging the symbols 501 on the lower image display panel 141 based on the symbol data table. (b2) is the process of determining whether a trigger condition is established in the normal game based on a rearrangement manner of the symbols 501. (b3) is the process of, when it is determined that the trigger condition is established, executing a free game as a feature game by rearranging the symbols 501 based on the symbol data table, and changing setting so that, in the feature game, the wild symbols 503b function as substitute symbols for the predetermined type of symbols 502 and as symbols used for determining a multiplying factor. (b4) is the process of awarding a special payout when, in the free game as the feature game, there is caused a rearrangement manner where a prize is established with the one or more wild symbols 503b rearranged, the special payout being calculated by multiplying a payout for the prize by a multiplying factor depending on the number of the rearranged wild symbols 503b.

With the above structure, in the gaming machine 300, establishment of a prize is facilitated since the predetermined type of symbols 502 are stacked. In addition to this, in the free game, the wild symbols 503b function not only as substitute symbols, as are in the normal game, but also as symbols used to determine the multiplying factor for the payout. This eliminates the necessity to additionally provide a symbol for the multiplying factor as generally provided, and a large amount of special payout to be awarded is calculated by multiplying a payout for a prize by a multiplying factor depending on the rearranged wild symbols 503b.

Further, the gaming machine 300 is structured as follows. The symbol data table includes a symbol data table for the normal game and a symbol data table for the feature game. The number of the wild symbols 503b in the symbol data table for the feature game is larger than the number of the wild symbols 503b in the symbol data table for the normal game. The game controller 100 uses the symbol data table for the normal game as the symbol data table in the process of (b1), and uses the symbol data table for the feature game as the symbol data table in the process of (b3).

With the above structure, in the gaming machine 300, the symbol data table having the larger number of the wild symbols 503b than that for the normal game is used in the feature game, and this increases the possibility of rearrangement of the wild symbols 503b.

Further, the symbol data table for the feature game has a data structure in which the number of the predetermined symbols stacked is larger than that in the symbol data table for the normal game. The game controller 100 uses the symbol data table for the normal game as the symbol data table in the process of (b1), and uses the symbol data table for the feature game as the symbol data table in the process of (b3).

With the above structure, in the gaming machine 300, the symbol data table having the data structure in which the number of the predetermined type of symbols stacked is larger than that for the normal game is used in the feature game, and this increases the possibility of establishment of a plurality of prizes.

The game controller 100 may be programmed to execute a process of rearranging the symbols 501, on the lower image display panel 141, for each column sequentially from the first column to the last column of the reels 151 to 155; and The symbol data table for the feature game may have a data structure in which an increase in the number of the predetermined type of symbols 502 stacked on the reel 155 of the last column is the largest among those on all the reels 151 to 155 in the columns.

With the above structure, in the gaming machine 300, the increase in the number of the predetermined type of symbols 502 stacked on the reel 155 of the last column is the largest among those on all the reels in the columns. This increases the possibility that a plurality of prizes are established at the last of the free game in the feature game.

Further, the symbol data table for the feature game may store therein the wild symbols 503b only in association with the reels 152, 153, and 154 of the columns interposed between the first column (the reel 151) and the last column (the reel 155).

With the above structure, one or more wild symbols 503b may be rearranged in the course of rearrangement of the symbols 501 for each column of the reel (151 to 155) sequentially from the first column to the last column. This provides a player with expectation for the possibility that a large prize is established.

Further, the symbol data table for the feature game has a data structure in which the wild symbols 503b are placed so as to sandwich a stack of the predetermined type of symbols 502. That is, the symbol data table for the feature game has the data structure in which: the wild symbols 503b are respectively placed upstream and downstream, in a rotational direction of the reels 151 to 155, of a symbol group constituted by the predetermined type of symbols 502 stacked in the rotational direction; and thereby the upstream wild symbol 503b and the downstream wild symbol 503b are placed so as to sandwich the symbol group.

With the above structure, in the gaming machine 300, the stack of the predetermined type of symbols 502 is sandwiched by the wild symbols 503b. This increases the possibility that the wild symbols 503b are rearranged adjacent to the rearranged stack of the predetermined symbols 502. Thereby, expectation for a large payout is provided to the player.

Further, in the normal game, the game controller 100 determines whether a prize is established utilizing a function of the wild symbols 503b as a substitute for any type of symbols 501; and in the free game of the feature game, the game controller 100 determines whether a prize is established utilizing the function of the wild symbols 503b as a substitute for any type of symbols 501, and calculates a payout by multiplying a payout for the prize by a multiplying factor depending on the number of the rearranged wild symbols 503b utilizing a function of the wild symbols 503b as a basis for the multiplying factor.

With the above structure, in the gaming machine 300, the functions of the wild symbols 503b are used differently between the normal game and the free game of the feature game. After shifting to the feature game, a game is executed with the wild symbols 503b having increased functions. Further, in the free game of the feature game, the wild symbols 503b function not only as the substitute symbols but also the symbols based on which the multiplying factor is determined. This eliminates the necessity to additionally provide a symbol for the multiplying factor.

The game controller 100 may be programmed to execute the following process(es) in addition to the above-described processes (a1) and (a2), (b1) to (b4), or the like. In the feature game, the game controller 100 may establish a re-trigger condition with a probability equal to or higher or lower than that of the trigger condition. Further, when the re-trigger condition is established in the feature game, the game controller 100 may raise a payout rate of the free game of the feature game. In this case, multiplication by the multiplying factor depending on the wild symbols 503b may also be conducted in addition to the above, and therefore expectation for further lager payout is brought. Alternatively, when the re-trigger condition is established in the feature game, the game controller 100 may increase the number of times of execution of the free game of the feature game.

The gaming machine 300 structured as above executes the normal game (A1), and when three or more feature symbols are rearranged (A2: YES), the gaming machine 300 executes the feature game which is 8 times of execution of the free game (A3). Then, when a prize is established in the feature game (A4: YES), it is determined whether there are one or more wild symbols 503b rearranged (A5). When there are one or more wild symbols 503b (A4: YES), a multiplying factor depending on the number of the rearranged wild symbols 503b is obtained (A7), and a special payout calculated by multiplying a payout by the thus obtained multiplying factor is awarded (A8). When there is no wild symbol 503b (A5: NO), a normal payout for the prize is awarded (A6). Thereafter, it is determined whether a re-trigger condition is established (A9). When the re-trigger condition is established (A9: YES), 8 is added to the number of times of execution of the free game. After the execution of the free game is completed and thereby the feature game ends (A10: YES), shifting to the normal game occurs.

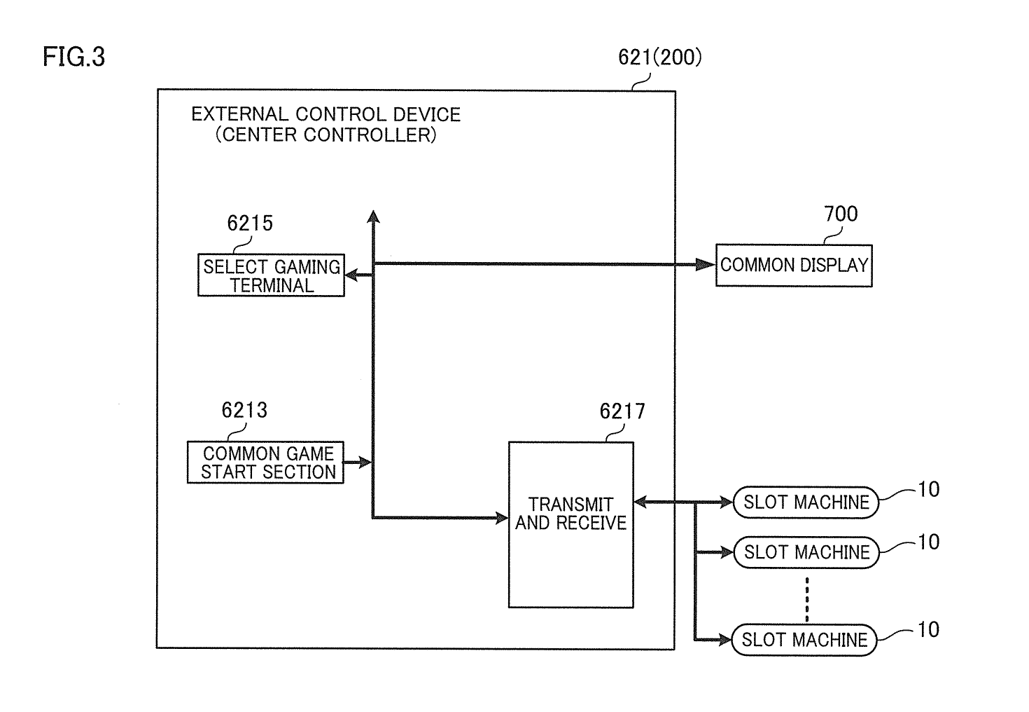

As shown in FIG. 2, the gaming machine 300 is a multi-player gaming machine in which a plurality of slot machines 10 that are gaming terminals are connected to a center controller 200 (FIG. 2 and FIG. 3) to be able to perform data communications with one another. The gaming machine 300 is able to run a terminal game such as a slot game at each slot machine 10 and run a common game at a common display device 701 or the like, while synchronizing the slot machines 10. The slot machines 10 and the center controller 200 are connected wireless, by wires, or by both of them. A unit of bet amount may be a currency of a country or area such as dollar, yen, euro, or the like, or may be a game point used exclusively in a hall having the gaming machine 300 or in the industry.

As shown in FIG. 1 to FIG. 3, the common game may be executed instead of the terminal game, or the common game may be executed in parallel with the terminal game. This embodiment is described using the gaming machine 300 having the center controller 200 aside from the slot machines 10; however, the present invention is not limited to this. In other words, the gaming machine 300 may be configured in such a manner that at least one slot machine 10 has a function of the center controller 200, and the slot machines 10 may be connected with each other so as to allow data communications therebetween. Further, the gaming machine may be a slot machine 10 itself.

### (Outline of Gaming Machine: Definitions)

The slot machine 10 above is a kind of gaming terminal in the gaming machine 300. Although the present embodiment deals with the slot machine 10 as an example of the gaming terminal, the disclosure is not limited to this, and any type of device having a game controller 100 that is able to independently run a terminal game may be used as the gaming terminal.

The “terminal game” in the present embodiment is run by the slot machine 10. The terminal game is a slot game where a plurality of symbols are rearranged. Note that the terminal game is not limited to the slot game, and the terminal game may be of any type as long as it is independently runnable at a gaming terminal such as the slot machine 10. That is, the terminal game is a game having a concept opposing to that of the common game. For example, a normal game and a bonus game, which will be described later, are included in the concept of the terminal game.

The rearrangement of the symbols in the slot game is conducted on the lower image display panel 141. The slot game includes: a process of executing a normal game of rearranging symbols on the lower image display panel 141 when a gaming value is bet and awarding a normal payout in accordance with the rearranged symbols; a process of, when the symbols are rearranged in a predetermined condition in the normal game, i.e., when a trigger condition is established, shifting to a feature game which is a bonus game; and a process of, when a re-trigger condition is established in the feature game, increasing a benefit awarded to the player in the bonus game. The “feature game” is a game in which one or more free games are run.

While the present embodiment deals with the slot game in which the normal game and the feature game (bonus game) are executed, however, the embodiment is not limited to this. In the slot game, a bonus game different from the feature game may be executed in place of or in addition to the feature game. For example, the slot game may include a process of executing a bonus game where symbols are rearranged in a condition in which the payout rate is higher than the payout rate in the normal game and a bonus payout is awarded in accordance with the rearranged symbols. Furthermore, the slot game may include a process of executing a rescue process when a rescue start condition is established.

Symbols 501 are constituted by a specific symbol 503 and a normal symbol 502. In other words, “symbol” is a superordinate concept to the specific symbol 503 and the normal symbol 502. The specific symbol 503 includes a wild symbol 503b and a trigger symbol 503a. The wild symbol 503b can be used as a substitute for any type of the symbol 501. While the present embodiment describes the wild symbol 503b functioning as a substitute for the symbol 501 other than the feature symbol, the disclosure is not limited to this.

The trigger symbol 503a is a symbol that triggers at least the execution of the bonus game. For example, the trigger symbol 503a functions as a trigger to shift the normal game to various types of the bonus game. In the present embodiment, the trigger condition and the re-trigger condition are established based on the trigger symbol 503a. In the present embodiment, furthermore, the trigger symbol 503a functions as a scatter symbol. That is to say, the trigger condition and the re-trigger condition are established based solely on the number of the rearranged trigger symbols 503a.

The trigger symbol 503a may function as a trigger of increase in the number of the specific symbols 503 in the bonus game, i.e., increase in the number of the specific symbols 503 of at least one of the trigger symbol 503a and the wild symbol 503b. Furthermore, the trigger symbol 503a may function as a trigger of increase in the number of times to run the bonus game. For example, the trigger symbol 503a may cause the establishment of the re-trigger condition which triggers the increase in the number of times of execution of the free game in the feature game which is the bonus game.

A coin, a bill, or electrically valuable information corresponding to these is used as a gaming value. Note that the gaming value in the present invention is not particularly limited. Examples of the gaming value include game media such as medals, tokens, cyber money, tickets, and the like. Further, a later-described ticket with a barcode may also be used. Alternatively, the gaming value may be a game point not including valuable information.

Each of the bonus game and the feature game may be a game of a different type as long as its gaming state is more advantageous than that of the normal game. Other types of the bonus game and/or the feature game may be additionally employed as long as the gaming state is advantageous for the player, i.e., the gaming state is more advantageous than that of the normal game. For example, in the bonus game and the feature game, various states such as a state in which more gaming values can be achieved as compared to the normal game, a state in which the probability of obtaining a gaming value is higher than the probability in the normal game, and a state in which the number of consumed gaming values is smaller than in the normal game are achieved independently or in combination.

The free game is a game which is executable with a smaller amount of gaming values bet than in the normal game. The expression “executable with a smaller amount of gaming value bet” includes a case where an amount of gaming values bet is zero. Therefore, the free game may be a game which is run without betting a gaming value and the gaming value is paid out for an amount corresponding to rearranged symbols. In other words, the free game may be a game that starts even if no gaming value is consumed. On the other hand, the normal game, which is also referred to as a “base game” in the present embodiment, is run on condition that a gaming value is bet, and is a game in which gaming value is paid out for an amount corresponding to rearranged symbols. In other words, the normal game is a game that starts with the consumption of the gaming value.

The term “rearrangement” indicates that the symbols are rearranged after the arrangement of the symbols is dismissed. The term “arrangement” indicates a state in which the symbols are visually recognizable by an external player. More specifically, “rearrangement” is a state in which, after the symbols on the reels are variably displayed as the reels rotate, the variable display of the symbols stops as the rotation of the reels stops, and the symbols stop in the display window.

The phrase “normal payout based on the rearranged symbols” indicates a normal payout corresponding to a winning combination resulting from the rearrangement. The phrase “bonus payout based on the rearranged symbols” indicates a bonus payout corresponding to a winning combination resulting from the rearrangement. It is noted that the term “winning combination” indicates that a prize is established.

Examples of “a condition in which the payout rate is higher than in the normal game” include the execution of a free game, increase in the number of the wild symbol 503b and the trigger symbol 503a, and the execution of a game using substituted symbol table. Examples of “rescue start condition” include a case where the normal game is excessively repeated, i.e., the normal game is repeated for a predetermined number or more of times and a case where the total amount of obtained payout is excessively small, i.e., the obtained normal payout and bonus payout are smaller than a predetermined amount after a single player repeats the game for a predetermined number or more of times. The rescue process is a process to relieve players. Examples of the rescue process include the execution of a free game, the increase in the number of the wild symbol 503b and the trigger symbol 503a, the execution of a game using a substituted symbol table, and the awarding of an insurance payout.

(Function Flow of Gaming Machine 300: Slot Machine)

The gaming machine 300 arranged as above includes, as shown in FIG. 2, slot machines 10 and an external controller 621 (center controller 200) connected to the slot machines 10 to be able to communicate therewith. The external controller 621 is able to communicate with the slot machines 10 provided in a hall.

Each slot machine 10 includes a BET button 601, a spin button 602, and a display 614 (such as a lower image display panel 141 shown in FIG. 1), and further includes a game controller 100 configured to control these units. The BET button 601 and the spin button 602 are kinds of input devices. The slot machine 10 further includes a transceiver unit 652 that makes it possible to perform data communication with the external controller 621.

The BET button 601 above has a function of receiving a bet amount input by the player. The spin button 602 has a function of receiving an instruction to start a game such as a normal game in response to an operation by the player, i.e., a start operation. The display 614 has a function of displaying still image information such as various symbols, numbers, and characters, and moving image information such as effect movies. Furthermore, the display 614 has a touch panel 69 as an input device, and has a function of receiving various instructions input by a pressing operation by the player. The display 614 has a symbol display region 614a, an image display region 614b, and a common game display region 614c. The symbol display region 614a displays a reel screen including the symbols shown in FIG. 1. The image display region 614b displays various types of effect image information (including the common indication effect and the individual indication effect) executed during a game, by means of moving images and still images. The common game display region 614c displays a common game.

Although in the present embodiment the symbol display region 614a, the image display region 614b, and the lower image display panel 141 are provided on the same screen, the disclosure is not limited to this arrangement. The common game display region 614c may be formed together with the symbol display region 614a and the image display region 614b, or may appear as a substitute only when a common game is run.

The game controller 100 includes a coin insertion/start-check unit 603, a normal game running unit 605, a bonus game start determining unit 606, a bonus game execution unit 607, a random number sampling unit 615, a symbol determining unit 612, an effect-use random number sampling unit 616, an effect determining unit 613, a speaker unit 617, a lamp unit 618, a winning determining unit 619, and a payout unit 620.

The normal game running unit 605 has a function of running a normal game when an operation of the BET button 601 is made. The bonus game start determining unit 606 determines whether to run a bonus game, based on a combination of the symbols rearranged in the normal game. That is to say, the bonus game start determining unit 606 has a function of determining that a bonus game is obtained when a trigger symbol 503a or the like is rearranged in a predetermined condition, and shifting the process to the bonus game execution unit 607 so that a bonus game is run from the next unit game.

It is noted that “unit game” is a series of operations from the start of the receiving of a bet to a state in which an award can be established. For example, a unit game in the normal game includes a single bet time for receiving a bet, a single game time of rearranging stopped symbols, and a single payout time of a payout process of awarding a payout. A unit game in the normal game is termed unit normal game.

The bonus game execution unit 607 has a function of running a bonus game in which a free game is repeated only by an operation of the spin button 602.

The symbol determining unit 612 has functions of: determining symbols to be rearranged with reference to a random number value from the random number sampling unit 615; rearranging the determined symbols on the symbol display region 614a of the display 614; outputting rearrangement information of the symbols to the winning determining unit 619; and outputting an effect specifying signal to the effect-use random number sampling unit 616 based on the state of the rearrangement of the symbols.

The effect-use random number sampling unit 616 has a function of sampling an effect random number when receiving an effect instruction signal from the symbol determining unit 612 and a function of outputting the effect random number to the effect determining unit 613. The effect determining unit 613 has a function of determining the effect content by using the effect random number, a function of outputting the image information of the determined effect content to the image display region 614b of the display 614, and a function of outputting audio/light information of the determined effect content to the speaker unit 617 and the lamp unit 618.

The winning determining unit 619 has a function of determining the presence of winning when obtaining rearrangement information of the symbols, which is a display state of rearrangement on the display 614, a function of calculating a payout amount based on the winning combination when it is determined that winning is achieved, and a function of outputting a payout signal to the payout unit 620 based on the payout amount. The payout unit 620 has a function of paying out a gaming value to the player, in the form of a coin, a medal, a credit, or the like. Furthermore, the payout unit 620 has a function of adding credit data corresponding to the credit to be paid out to credit data stored in an IC card inserted into the later-described PTS terminal 700.

In addition to the above, the game controller 100 includes a storage unit 661 that stores various types of bet amount data. The storage unit 661 stores data in a rewritable manner, e.g., in a hard disc device and a memory.

In addition to the above, the game controller 100 has a common game running unit 653. The common game running unit 653 has functions of: outputting bet amount information based on a bet amount bet on a normal game to the external controller 621 in each unit terminal game; executing a common game in response to a game start command from the external controller 621; and receiving a bet input through the BET button 601 for a bet amount corresponding to bet amount data for a common game, which is stored in the storage unit 661 and is bettable on a common game.

In addition to the above, the game controller 100 is connected to the PTS terminal 700. The PTS terminal 700 is a unit in which an LCD, a microphone, a human body detection camera, etc. are integrated, and has, for example, a function of executing an effect for a game by mutual communications with the game controller 100. In particular, the PTS terminal 700 has an card slot to which an IC card can be inserted. With this, the player is able to insert a IC card into the card slot and use the credits stored in the IC card in the slot machine 10. The mechanical structure of the PTS terminal 700 will be described later.

In addition to the above, when receiving credit data from the PTS terminal 700, the game controller 100 updates the credit display on the display 614. Furthermore, the game controller 100 outputs settled credit data to the PTS terminal 700 when the credits on a game are settled.

Furthermore, the PTS terminal 700 of each of the slot machines 10 constituting the gaming machine 300 is connected to a management server 800 to be able to communicate each other, and centrally manages the download of images, IC cards and credits.

(Function Flow of Gaming Machine 300: External Controller)

The slot machine 10 arranged as above is, as shown in FIG. 3, connected to the external controller 621. The external controller 621 has a function of remotely operating and monitoring the operation state of each slot machine 10 and processes such as changes in game setting values. Furthermore, the external controller 621 has a function of determining a common game start condition for each gaming terminal which is the slot machine 10, and executing a common game at a plurality of slot machines 10 when a determination result at any gaming terminal satisfies the common game start condition.

More specifically, the external controller 621 includes a common game start unit 6213, a gaming terminal selection unit 6215, and a transceiver unit 6217. The common game start determining unit 6213 has functions of: determining whether the common game start condition is established based on the accumulated bet amount information sent from the slot machine 10 in each unit terminal game; outputting a game start command to a plurality of slot machines 10; and displaying on the common display device 701 states until the common game start condition is established.

The determination as to whether the common game start condition is established is based on the accumulated bet amount information or based on all accumulated values that increase as the unit terminal game is repeated. For example, the number of times of running the terminal game and the game time of the terminal game may be used as the accumulated values.

In addition to the above, the common game start unit 6213 has a function of outputting a game start command to the slot machine 10 in which an accumulated value that increases as a result of the repetition of the terminal game satisfies a game running condition. With this, because the right to participate in the common game is not awarded to a slot machine 10 in which the accumulated value is lower than the minimum setting value, the common game start unit 6213 motivates the player to actively repeat the terminal game.

In addition to the above, the common game start unit 6213 has a function of monitoring a non-input time in which no start operation is performed, and outputting the game start command to the slot machines 10 except to the slot machine 10 in which the non-input time is equal to or longer than a timeout time. With this, the common game start unit 6213 is able to determine that no player is at a slot machine 10 where the terminal game has not been played at least for the timeout time, and able to avoid the execution of the common game at such a slot machine 10.

The gaming terminal selection unit 6215 has a function of selecting a specific slot machine 10 from the slot machines 10 and outputting a common game start command signal to that specific slot machine 10. The common game start command signal provides the specific slot machine 10 with the right to start the common game. The transceiver unit 6217 has a function of exchanging data with the slot machines 10.

(Operations of Gaming Machine 300)

The operations of the gaming machine 300 having the functional blocks above will be described. While in the present embodiment the “gaming terminal” shown in the flowcharts indicates a slot machine 10 executing a slot game, the disclosure is not limited to this arrangement.

(Operations of Slot Machine 10)

A slot machine 10 which is a gaming terminal executes terminal-side processes. More specifically, to begin with, a terminal game process (e.g., normal game) is executed. That is, a series of operations below are executed.

(Coin-Insertion/Start-Check)

First, the slot machine 10 checks whether or not a BET button 601 has been pressed by a player, and subsequently checks whether or not a spin button 602 has been pressed by the player.

(Symbol Determination)

Next, when a spin button unit 602 has been pressed by the player, the slot machine 10 extracts a random number for symbol determination, and determines symbols to be displayed for the player at the time of stopping the scroll of the symbol array, for respective video reels displayed on a display unit 614.

(Symbol Display)

Then the slot machine 10 starts the scroll of the symbol array of each video reel, and stops the scroll so that the determined symbols are displayed for the player.

(Winning Determination)

Subsequently, as the rotation of the symbol array of each video reel is stopped, the slot machine 10 determines whether the combination of the symbols displayed for the player is a combination related to winning.

(Payout)

When the combination of the symbols displayed for the player is a combination related to winning, the slot machine 10 offers, to the player, benefit according to the combination.

For example, when a combination of symbols related to a payout of coins has been displayed, the slot machine 10 pays out coins of the number corresponding to the combination of symbols to the player.

Subsequently, whether to win a bonus combination is determined. When winning the bonus combination, a bonus game process is executed. On the other hand, when not winning the bonus combination, the normal game is run again. During a period in which the terminal game including such a normal game and bonus game is being run, execution state information indicating the start and end of the unit game such as the normal game and the bet amount on the unit game is transmitted to the external controller 621. With this, the external controller 621 centrally manages the execution state information of each slot machine 10.

(Operation of External Controller 621)

When the slot machines 10 operate as above, the external controller 621 executes the following center-side processes in synchronization with the slot machines 10.

To begin with, the external controller 621 receives the execution state information from each slot machine 10 and obtains the execution state of the terminal game. Thereafter, based on the number of repetitions of the terminal game, the accumulated bet amount, or the like, whether the common game start condition is established at any slot machine 10 is determined. When the common game start condition is not established, the acquisition of the execution state of the terminal game at each slot machine 10 is continued.

In the meanwhile, when the common game start condition is established, the game start command is simultaneously output to the slot machines 10 that satisfy the game running condition. Thereafter, a specific slot machine 10 is selected from the slot machines 10 satisfying the game running condition, and a common game start right instruction is output to the specific slot machine 10.

Thereafter, the external controller 621 waits for the common game start command to be supplied from the specific slot machine 10. Upon receiving the common game start command, the result of the common game is determined as a game result. The game result is, for example, win, lose, or draw. When the game result is not draw, at least a part of a draw game result is skipped among a series of temporarily-stored game results, and the remaining game results are serially output to the slot machines 10, as game result information.

Thereafter, based on the winning or losing game result, whether to win in the common game is determined. When lost, the execution state of the terminal game at each slot machine 10 is newly obtained. On the other hand, when won, a payout amount is calculated based on the bet amount bet on the common game at each slot machine 10, and the payout amount is sent to each slot machine 10 as payout information.

(Overall Structure of Game System)

A game system 350 including the gaming machine 300 having the functions above will be described.

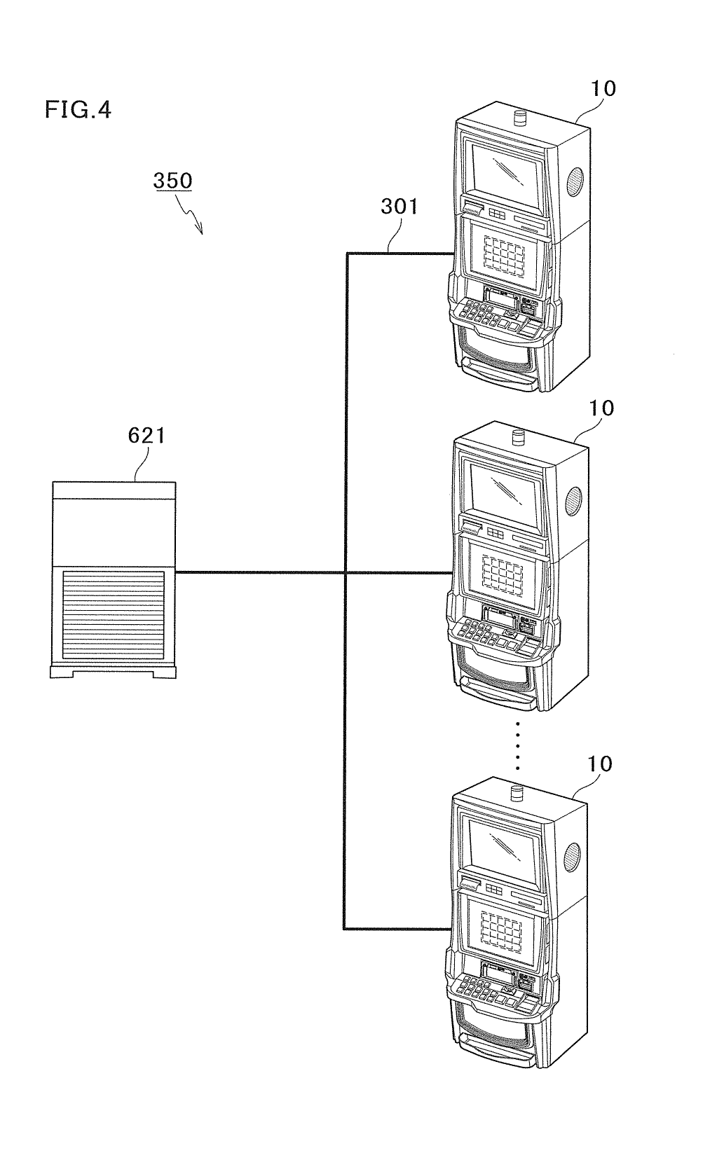

As shown in FIG. 4, the game system 350 includes the slot machines 10 and the external controller 621 connected to the slot machines 10 over a communication line 301. The external controller 621 is configured to control the slot machines 10. In the present embodiment, the external controller 621 is a so-called hall server provided in a gaming facility where a plurality of slot machines 10 are provided. Each of the slot machines 10 has a unique identification number, and the external controller 621 identifies which one of the slot machines 10 transmitted data, by referring to the identification number. Further, when transmitting data from the external controller 621 to any of the slot machines 10, the identification number is used for designating the transmission destination.

The game system 350 may be constructed in a single gaming facility such as a casino where various games are playable or may be constructed for a plurality of gaming facilities. Further, when the gaming system is constructed in a single gaming facility, the gaming system may be constructed in each floor or section of the gaming facility. The communication line 301 may be a wired or wireless line, and can adopt a dedicated line, an exchange line or the like.

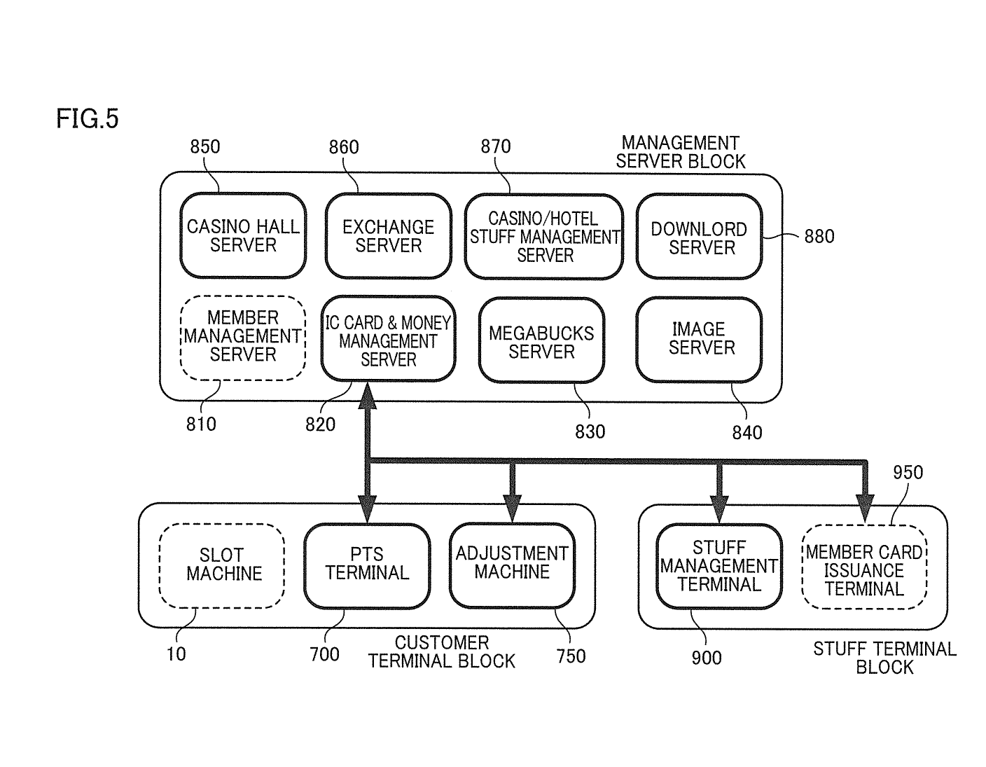

As shown in FIG. 5, the game system is roughly divided into a management server block, a customer terminal block, and a staff terminal block. The management server block includes a casino hall server 850, an exchange server 860, a casino/hotel staff management server 870, and a download server 880.

The casino hall server 850 is a server for managing the entire casino hall where the slot machines 10 are provided. The exchange server 860 is a server for generating exchange rate data based on exchange rate information or the like. The casino/hotel stuff management server 870 is a server for managing the staff members of the casino hall or a hotel related to the casino hall. The download server 880 is a server for, for example, downloading latest information such as game-related information and news and forwarding the information to players via the PTS terminal 700 of each slot machine 10.

The management server block includes a member management server 810, an IC card & money management server 820, a megabucks server 830, and an image server 840.

The member management server 810 is a server for managing member information or the like of the players of the slot machines 10. The IC card & money management server 820 is a server for managing IC cards used in the slot machines 10. More specifically, the IC card & money management server 820 is a server that stores fractional money data in association with an identification code and outputs the fractional money data to the PTS terminal 700. Furthermore, the IC card & money management server 820 generates and manages denomination rate data or the like. The megabucks server 830 is a server for, for example, managing Mega bucks which is a game in which the sum total of amounts bet on a plurality of slot machines 10 in a plurality of casino halls is dealt with as a payout. The image server 840 is, for example, a server that downloads latest images such as game-related images and news images and forwards the images to the player via the PTS terminal 700 of each slot machine 10.

The customer terminal block includes the slot machine 10, the PTS terminal 700, and a settlement machine 750. The PTS terminal 700 is attachable to the slot machine 10 and capable of mutually communicating with the management server 800. The settlement machine 750 exchanges money data stored in a player's IC card to real money and stores coins and bills in an IC card as money data.

The staff terminal block includes a staff management terminal 900 and a member card issuance terminal 950. The staff management terminal 900 is a terminal by which the staff of the casino hall manages the slot machines 10. In particular, in the present embodiment, the staff of the casino hall checks if the number of IC cards in the PTS terminal 700 is too large or too small. The member card issuance terminal 950 is a terminal by which a player obtains a member card to play games in the casino hall.

(PTS Terminal 700)

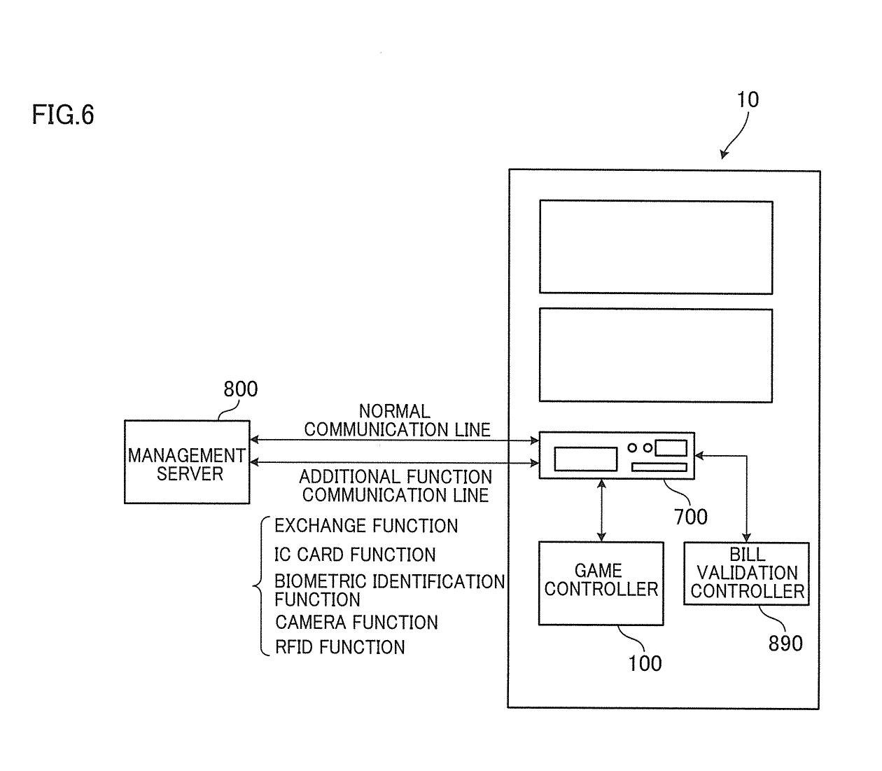

The PTS terminal 700 is incorporated in a PTS system as shown in FIG. 6. The PTS terminal 700 attached to the slot machine 10 is arranged to be able to communicate with the game controller 100 of the slot machine 10 and the bill validation controller 890.

The PTS terminal 700 conducts sound and image effects in games and updates the credit data, based on the communications with the game controller 100. Furthermore, the PTS terminal 700 sends credit data to the bill validation controller 890, which is required at the time of the settlement.

In addition to the above, the PTS terminal 700 is connected to the management server 800 to be able to communicate therewith. The PTS terminal 700 and the management server 800 are connected with each other by two lines, namely, a normal communication line and an additional function communication line.

The PTS terminal 700 exchanges, by the normal communication line, data such as money data, identification code data, member information of a player. On the other hand, by the additional function communication line, the PTS terminal 700 conducts communications concerning newly-added functions. In the present embodiment, the PTS terminal 700 conducts, by the additional function communication line, communications concerning an exchange function, an IC card function, a biometric identification function, a camera function, and an RFID (Radio Frequency IDentification) function of individual identification by radio waves.

(Mechanical Structure of Slot Machine)

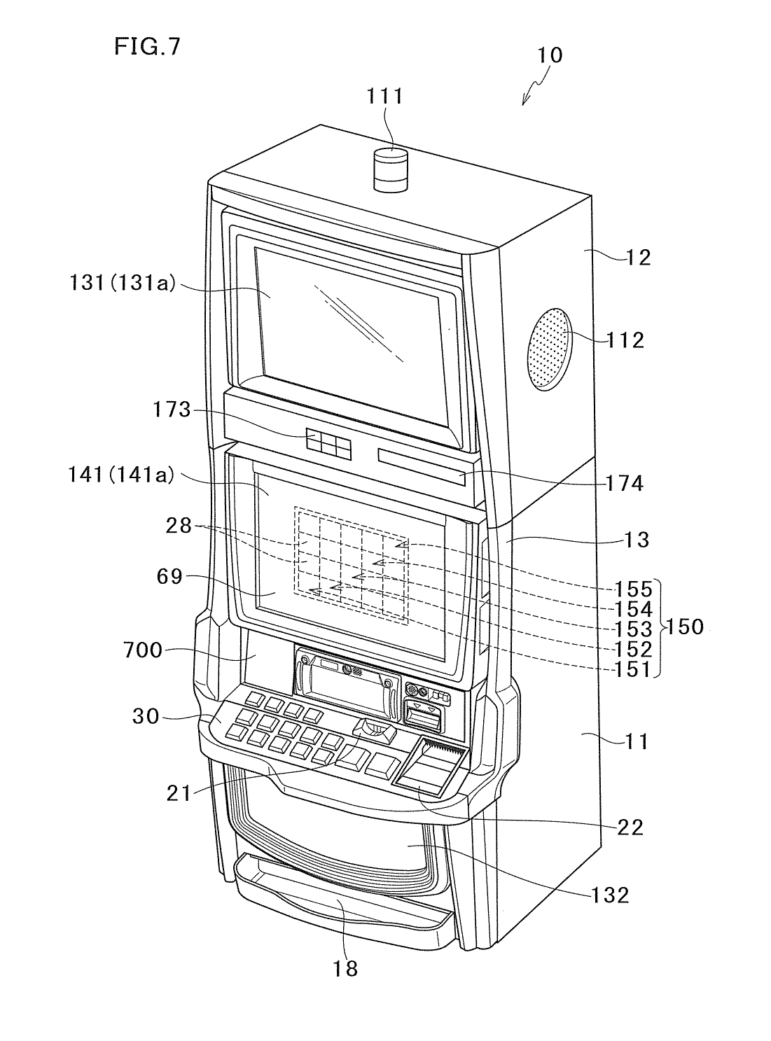

Referring to FIG. 7, the overall structure of the slot machine 10 will be described.

A coin, a bill, or electrically valuable information corresponding to these is used as a game medium in the slot machine 10. In the present embodiment, in particular, credit-related data such as money data stored in an IC card is used.

The slot machine 10 includes a cabinet 11, a top box 12 installed on the upper side of the cabinet 11, and a main door 13 provided at the front surface of the cabinet 11.

On the main door 13, a symbol display device termed lower image display panel 141 is provided. The symbol display device is formed by a transparent liquid crystal panel. The screen displayed on the lower image display panel 141 has a display window 150 at the central portion. The display window 150 is constituted by 20 display blocks 28 forming a matrix of 5 columns and 4 rows. The 4 display blocks 28 of each column form pseudo reels 151 to 155. On each of the reels 151 to 155, 4 display blocks 28 move downward with changes in speed, so that the symbols on the display blocks 28 are vertically rotated (variably displayed) and then stopped, in other words, the symbols are rearranged. The details of the display screen on the lower image display panel 141 will be given later.

While in the present embodiment the slot machines 10 are so-called video slot machines, mechanical reels may be substituted for some of the pseudo reels 151 to 155 in each slot machine 10 of the present invention.

On the front surface of the symbol display device is provided a touch panel 69. The touch panel 69 allows a player to input various instructions by touching the display screen of the lower image display panel 141. The input signal is transmitted from the touch panel 69 to the main CPU 71.

Below the lower image display panel 141 is provided a control panel 30. The control panel 30 is provided not only with buttons but also units such as the coin entry 21 that allows coins to enter the cabinet 11 and the bill entry 22. Details of the control panel 30 will be given later.

An upper image display panel 131 is provided at the front face of the top box 12. The upper image display panel 131 includes a liquid crystal panel, and forms the display. The upper image display panel 131 displays images related to effects and images showing introduction of the game contents and explanation of the game rules. Further, the top box 12 is provided with a speaker 112 and a lamp 111. The slot machine 10 produces effects by displaying images, outputting sounds, and outputting the light.

On the lower front surface of the main door 13, i.e., below the control panel 30, a belly glass 132 on which a character of the slot machine 10 or the like is depicted are provided. Between the lower image display panel 141 and the control panel 30, the PTS terminal 700 is attached. In the PTS terminal 700, devices having a microphone function, a camera function, a speaker function, a display function and the like form a single unit. More specifically, the PTS terminal 700 includes an LCD, a human detection camera, a microphone, a bass reflex speaker, or the like. The human detection camera makes it possible to detect the presence of a player by the camera function. The microphone is used for the player's participation in a game by voice and the authentication of a player by voice recognition. The speaker produces sound effects in games and outputs notification sound when an IC card is left inserted. Furthermore, the speaker outputs notification sound when an inserted IC card is not authenticated.

In addition to the above, the PTS terminal is provided with an LED and a card insertion slot. The LED emits light with plural colors to notify the remaining number of IC cards in a card stacker. The card insertion slot has a mechanism of allowing IC cards to be inserted and ejected. The IC card has a display region. The IC card is completely inside the machine when the player is playing games, and is ejected to expose the display region at the time of the settlement. This allows the player to recognize the credit-related data such as updated money data. Alternatively, the IC card may be arranged to expose the display region not to be completely inserted, even when the player is playing games. This allows the player to always recognize the update of the credits during games.

When it is confirmed by the human detection camera that no player is present at the time of the settlement of the credits, the IC card is drawn into and stored in the card stacker. With this arrangement, the IC card is not left inserted for a long time, even if the player left the machine without taking the IC card after recognizing that the remaining credits on the display region are small.

(Electrical Configuration of Slot Machine)

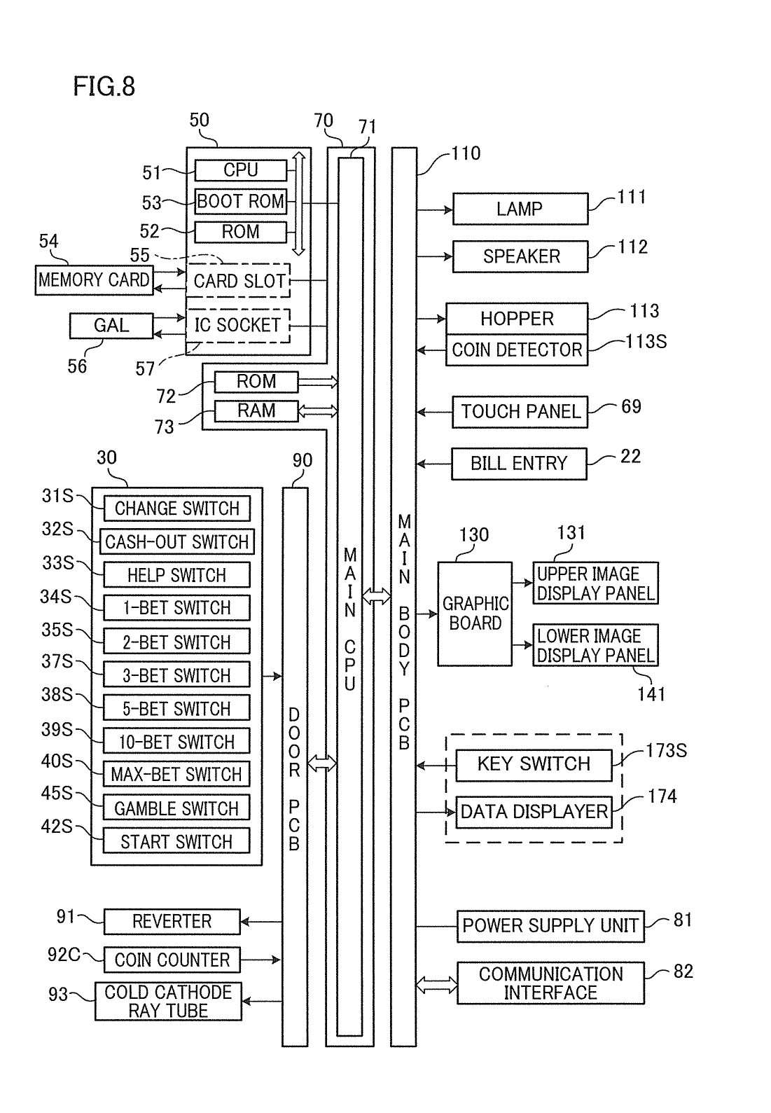

Now, referring to FIG. 8, the configuration of a circuit in the slot machine 10 will be described.

A gaming board 50 is provided with: a CPU 51, a ROM 52, and a boot ROM 53, which are mutually connected by an internal bus; a card slot 55 corresponding to a memory card 54; and an IC socket 57 corresponding to a GAL (Generic Array Logic) 56.

The memory card 54 includes a non-volatile memory, and stores a game program and a game system program. The game program includes a program related to game progression and a program for producing effects by images and sounds. The game program further includes a symbol determination program. The symbol determination program is a program for determining symbols to be rearranged on the display block 28.

Further, the card slot 55 is configured so that the memory card 54 can be inserted thereinto and removed therefrom, and is connected to a motherboard 70 by an IDE bus. The type and contents of the game to be played on the slot machine 10 can be changed by drawing out the memory card 54 from the card slot 53S, writing another game program into the memory card 54, and inserting the memory card 54 into the card slot 53S.

The GAL 56 is a type of PLD (Programmable Logic Device) having a fixed OR array structure. The GAL 56 is provided with a plurality of input ports and output ports, and predetermined input into the input port causes output of the corresponding data from the output port.

Further, the IC socket 57 is configured so that the GAL 56 can be inserted thereinto and removed therefrom, and is connected to the motherboard 70 by a PCI bus. The contents of the game to be played on the slot machine 10 can be changed by replacing the memory card 54 with another memory card 54 having another program written therein or by rewriting the program written into the memory card 54 as another program.

The CPU 51, the ROM 52 and the boot ROM 53 mutually connected by the internal bus are connected to the motherboard 70 by a PCI bus. The PCI bus enables a signal transmission between the motherboard 70 and the gaming board 50, and power supply from the motherboard 70 to the gaming board 50.

The ROM 52 stores an authentication program. The boot ROM 53 stores a pre-authentication program, a program (boot code) to be used by the CPU 51 for activating the pre-authentication program, and the like.

The authentication program is a program (falsification check program) for authenticating the game program and the game system program. The pre-authentication program is a program for authenticating the aforementioned authentication program. The authentication program and the pre-authentication program are written along a procedure (authentication procedure) for proving that the program to be the subject has not been falsified.

The motherboard 70 is constituted by a commercial general-purpose mother board (printed writing board on which basic components for personal computers are mounted) and is provided with a main CPU 71, a ROM (Read Only Memory) 72, a RAM (Random Access Memory) 73, and a communication interface 82. This motherboard 70 is equivalent to the game controller 100 of the present embodiment.

The ROM 72 includes a memory device such as a flash memory, and stores a program such as BIOS (Basic Input/Output System) to be executed by the main CPU 71, and permanent data. When the BIOS is executed by the main CPU 71, processing for initializing predetermined peripheral devices is conducted. Further, through the gaming board 50, processing of loading the game program and the game system program stored in the memory card 54 is started. In the present invention, the ROM 72 may be or may not be rewritable.

The RAM 73 stores data used for the operation of the main CPU 71 and programs such as the symbol determination program. For example, when the processing of loading the aforementioned game program, game system program or authentication program is conducted, the RAM 73 can store the program. The RAM 73 is provided with working areas used for operations in execution of these programs. Examples of the areas include: an area that stores counter which manages the number of games, the number of bets, the number of payouts, the number of credits and the like; and an area that stores symbols (code numbers) randomly determined.

The communication interface 82 is for communicating with the external controller 621 such as a server, through the communication line 301. Further, the motherboard 70 is connected with a later-described door PCB (Printed Circuit Board) 90 and a body PCB 110 by respective USBs. The motherboard 70 is also connected with a power supply unit 81. Furthermore, the motherboard 70 is connected with the PTS terminal 700 by an USB.

When the power is supplied from the power supply unit 81 to the motherboard 70, the main CPU 71 of the motherboard 70 is activated, and then the power is supplied to the gaming board 50 through the PCI bus so as to activate the CPU 51.

The door PCB 90 and the body PCB 110 are connected with input devices such as a switch and a sensor, and peripheral devices the operations of which are controlled by the main CPU 71.

The door PCB 90 is connected with a control panel 30, a reverter 91, a coin counter 92C and a cold cathode tube 93.

The control panel 30 is provided with a change switch 31S, a cash-out switch 32S, a help switch 33S, a 1-BET switch 34S, a 2-BET switch 35S, a 3-BET switch 37S, a 5-BET switch 38S, a 10-BET switch 39S, a MAX-BET switch 40S, a gamble switch 45S, and a start switch 46S, which correspond to the above-described buttons. Each of the switches outputs a signal to the main CPU 71 upon detection of press of the button corresponding thereto by the player.

Inside the coin entry 36 are provided a reverter 91 and a coin counter 92C. The reverter 91 validates a coin inserted into the coin entry 36, and discharges coins other than genuine coins through a coin payout opening. The coin counter 92C detects the received genuine coins and counts the number of the coins.

The reverter 91 operates based on a control signal output from the main CPU 71, and distributes valid coins validated by the coin counter 92C into a hopper 113 or a cash box. That is, coins are distributed into the hopper 113 when the hopper 113 is not filled with coins, while coins are distributed into the cash box when the hopper 113 is filled with coins.

The cold cathode tube 93 functions as a backlight installed on the rear face sides of the upper image display panel 131 and the lower image display panel 141, and lights up based on a control signal output from the main CPU 71.

The body PCB 110 is connected with the upper image display panel 131, the speakers 112, the hopper 113, a coin detecting portion 113S, the touch panel 69, the bill entry 22, a graphic board 130, a key switch 173S, and the data displayer 174. The speakers 112 output BGM sound or the like in accordance with a control signal output from the main CPU 71.

The hopper 113 operates based on a control signal output from the main CPU 71, and pays out coins of the specified number of payouts from the coin payout opening to an unillustrated coin tray. The coin detecting portion 113S outputs a signal to the main CPU 71 upon detection of coins paid out by the hopper 113.

The touch panel 69 detects a position on the lower image display panel 141 touched by a finger or the like of the player, and outputs a signal corresponding to the detected position to the main CPU 71.

The bill entry 22 authenticates the bills and receives genuine bills into the cabinet 11. The bills received by the cabinet 11 are converted onto the number of coins, and the credits equivalent to the converted coins are added as the credits owned by the player.

The graphic board 130 controls display of images conducted by the upper image display panel 131 and lower image display panel 141, based on a control signal output from the main CPU 71. The graphic board 130 is provided with a VDP (Video Display Processor) generating image data, a video RAM temporarily storing the image data generated by the VDP, and the like. It is to be noted that the image data used in generation of image data by the VDP is included in the game program that has been read from the memory card 54 and stored into the RAM 73.

The graphic board 130 is provided with a VDP (Video Display Processor) generating image data based on a control signal outputted from the main CPU 71, a video RAM temporarily storing the image data generated by the VDP, and the like. It is to be noted that the image data used in generation of image data by the VDP is included in the game program that has been read from the memory card 54 and stored into the RAM 73.

The key switch 173S is provided in the keypad 173, and outputs a predetermined signal to the main CPU 71 when the keypad 173 has been operated by the player. The data displayer 174 displays data read by the card reader 172 and data inputted by the player through the keypad 173, based on a control signal outputted from the main CPU 71.

(Symbols, Combinations, or the Like)

The symbols, which are displayed on the reels 151 to 155 of the slot machine 10, form symbol arrays. Each symbol constituting the symbol array has one of the code numbers 0 to 19 or more. Each symbol array is a combination of the symbols such as a wild symbol, a specific symbol 503, and a normal symbol.

The four successive symbols in the symbol array are, as shown in FIG. 7, displayed (provided) at the upper stage, the upper middle stage, the lower middle stage, and the lower stage of the display region of each of the reels 151 to 155, so that a symbol matrix of 5 columns and 4 rows is formed on the display window 150. The symbols forming the symbol matrix start to scroll at least when a game starts in response to the pressing of the spin button 46. After a predetermined time elapses from the start of the scroll, the scroll of the symbols stops (rearrangement).

In addition to the above, for the symbols, various winning combinations are set in advance. A winning combination indicates that a prize is established. A winning combination is a combination of symbols which is advantageous for the player. The advantageous state indicates states such as a state that coins corresponding to the winning combination are paid out, a state that the number of coins to be paid out is added to the credits, and a state that a bonus game starts.

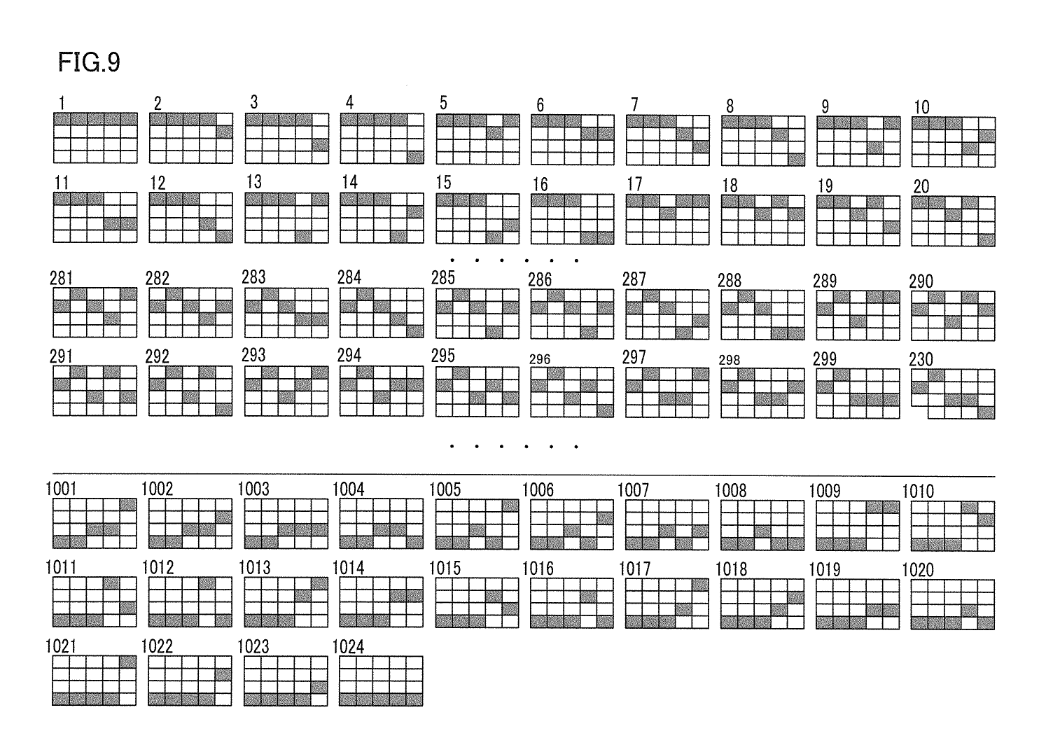

The winning combination in the present embodiment is established when symbols of at least one type are rearranged on any of 1024 (4 to the fifth power) ways on the symbol matrix of 5 columns and 4 rows. The combinations are specifically shown in FIG. 9. When a particular type of symbol is set as a scatter symbol, a winning combination is established when a predetermined number or more of such scatter symbols are rearranged, irrespective of the 1024 combinations.

The slot machine 10 may have one or more paylines L. In this case, the winning combination is a combination is established when a predetermined number or more of symbols of at least one type are rearranged on an activated payline L.

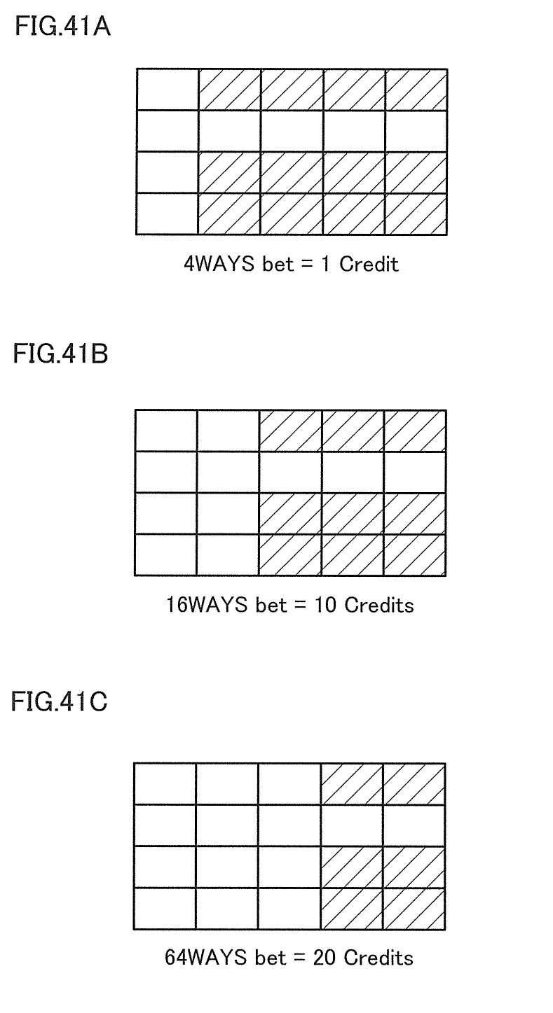

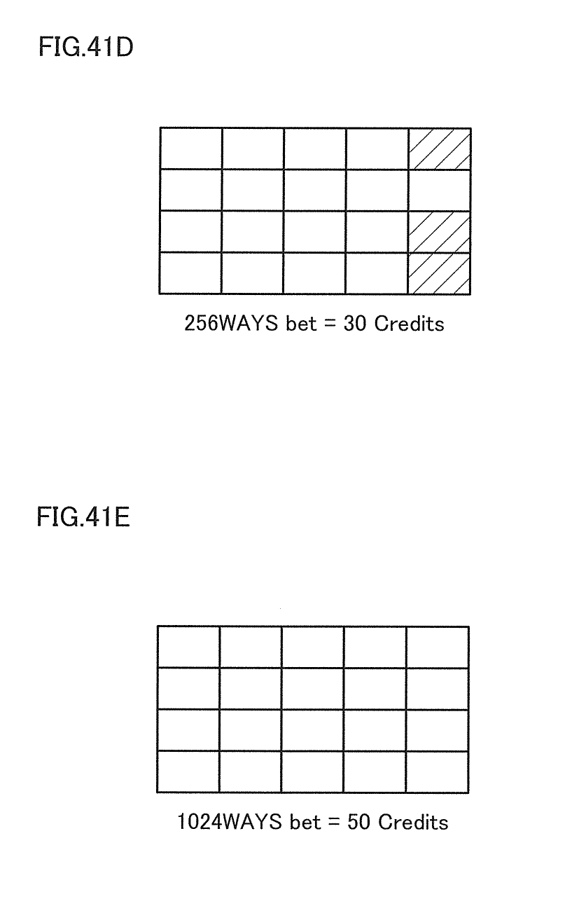

As for the bet pattern, the type of the WAY bet pattern based on which establishment of a winning combination is determined is selected depending on the number of credits to be bet. To be more specific, the number of credits to be bet is selectable, e.g., from “1, 2, 3, 4, 5”, “1, 2, 3, 5, 10”, “1, 2, 5, 10, 15”, “1, 2, 5, 10, 20”, “1, 10, 20, 30, 50”, or the like. As shown in FIG. 41A to FIG. 41E, for example, 4 WAYS bet pattern is selected for 1 credit, 16 WAYS bet pattern is selected for 10 credits, 64 WAYS bet pattern is selected for 20 credits, 256 WAYS bet pattern is selected for 30 credits, and 1024 WAYS bet pattern is selected for 50 credits.

Whether a prize is established is determined based on “Left to Right”, that is, the determination is made in a direction from the left end to the right end as seen from the player. That is, the determination is made in accordance with the order in which the reels 151 to 155 stop.

“Double Up Type” is a selection of red or black. The color of panel buttons is changed by the machine, and a prize is established with a probability of 50% as a result of selection of a red button or a black button. The slot machine 10 may be configured so that a jackpot is possible.

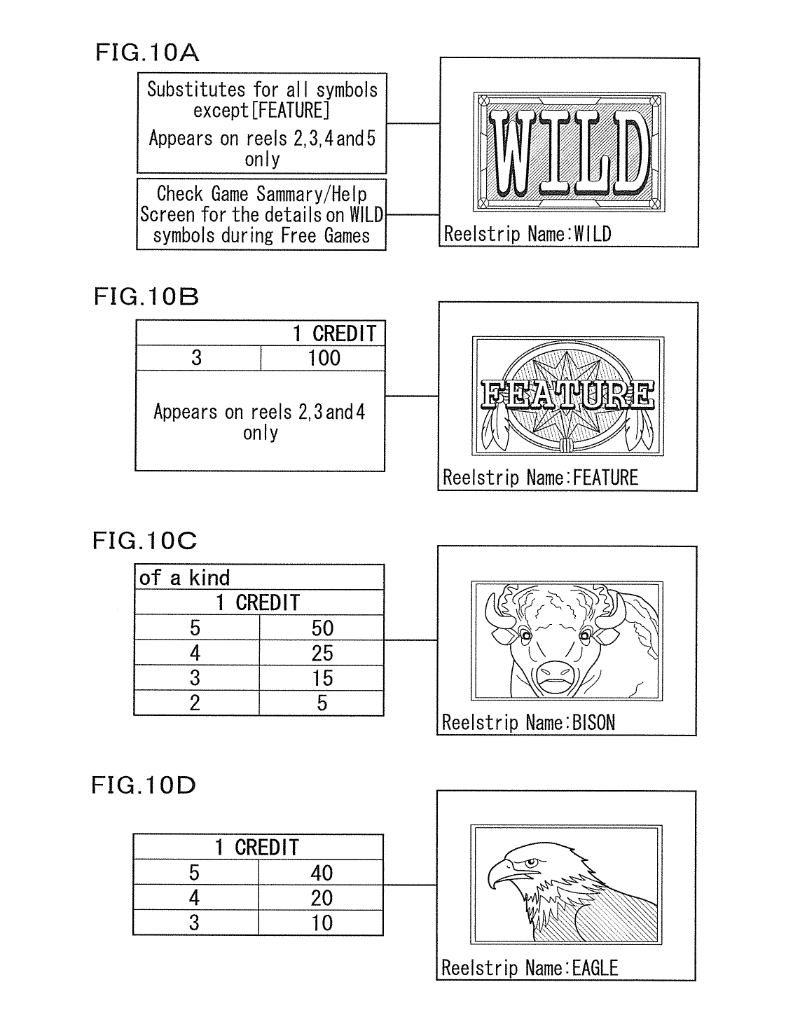

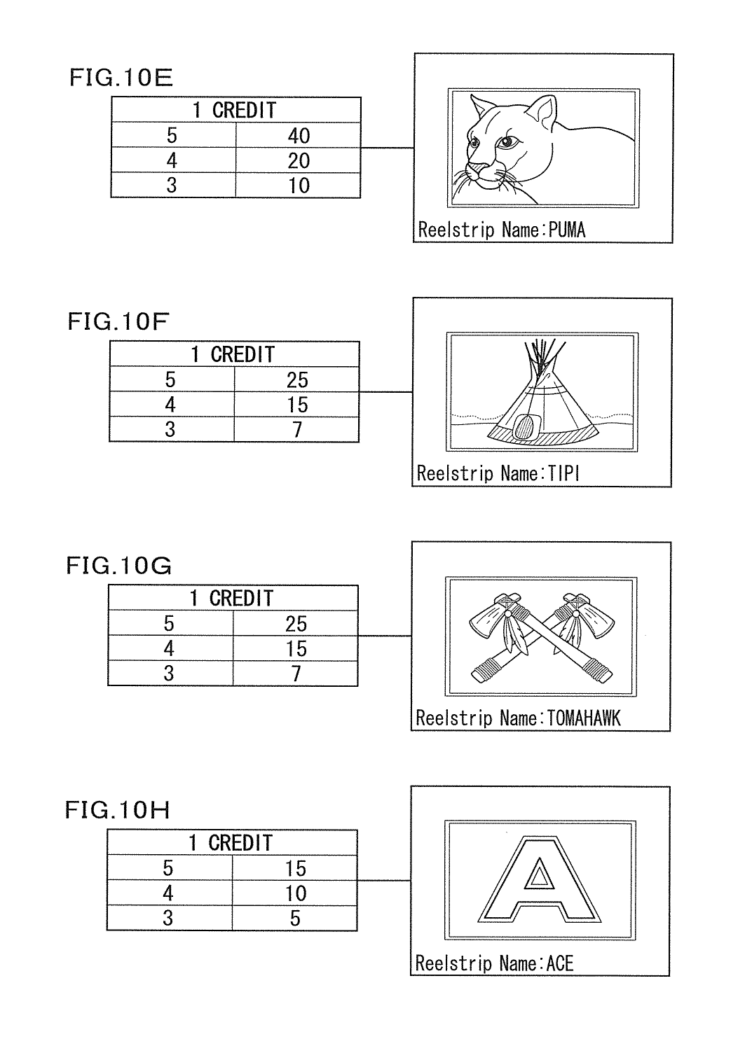

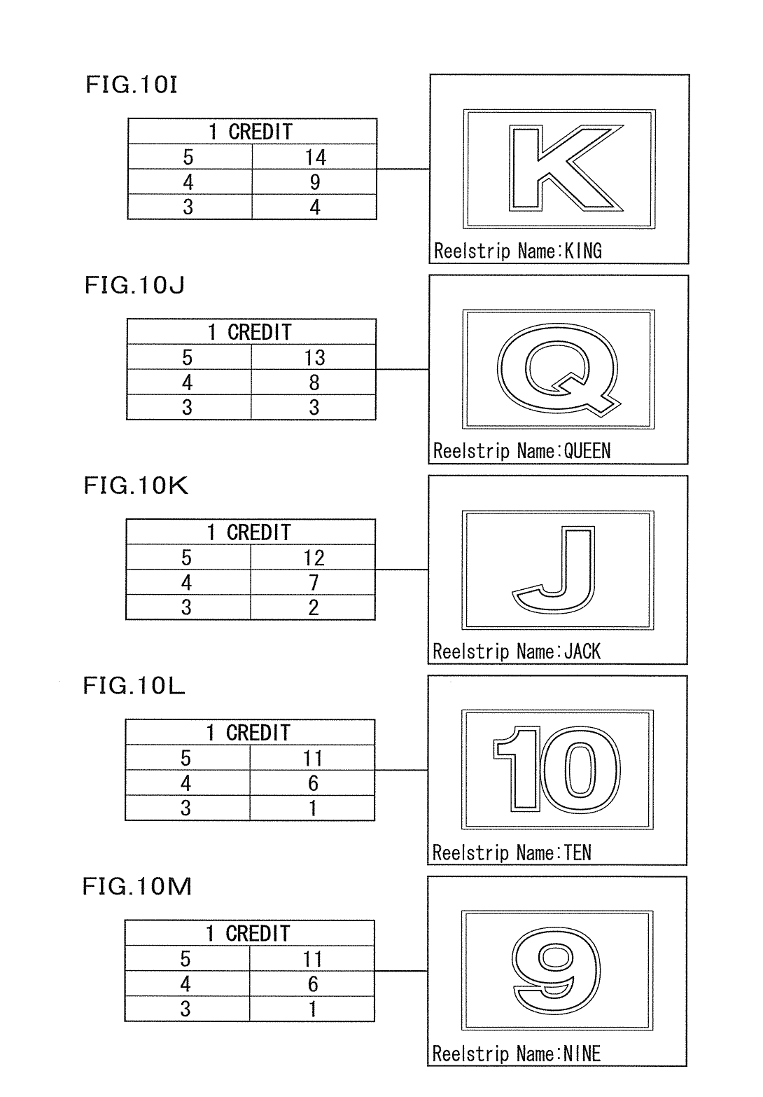

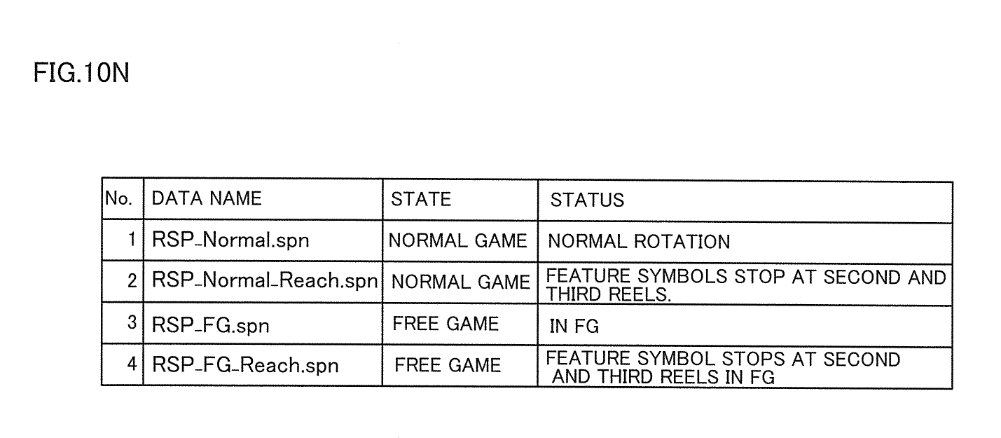

As shown in FIG. 10A to FIG. 10M, the symbol 501 includes the wild symbol 503b, the trigger symbol 503a, and the normal symbols 502. There are plural types of normal symbols 502, and the number of credits and the number of payouts are set for each type.

To be more specific, the wild symbol 503b has a function of substituting for any symbols except the trigger symbol 503a, which is the feature symbol. The wild symbols can appear on the second to fifth reels 152 to 155. In the feature game, the wild symbol 503b has a function of multiplying a payout by the number of symbols, in addition to the substitute function. The trigger symbols 503a can appear on the second to fourth reels 152 to 154. When three trigger symbols 503a are rearranged, a payout of 100 credits are paid out per 1 bet. As for the symbols 502 such as “BISON” and “EAGLE”, a payout according to the number of symbols is paid out.

(Spin Table)

FIG. 10N shows a spin table of sets of spin data used in different gaming states of the slot machine 10. The spin table includes number fields, data name fields, state fields, and status fields.

Associated with the number field “1” are the data name field “RSP_Normal.spn”, the state field “Normal Game”, and the status field “Normal Rotation”. Associated with the number field “2” are the data name field “RSP_Normal_Reach.spn”, the state field “Normal Game”, and the status field “FEATURE symbols stop at second and third reels”. Associated with the number field “3” are the data name field “RSP_FG.spn”, the state field “free game”, and the status field “in FG”. Associated with the number field “4” are the data name field “RSP_FG_Reach_{—}01.spn”, the state field “free game”, and the status field “FEATURE symbol stops at second and third reels in FG”.

(Symbol Data Table)

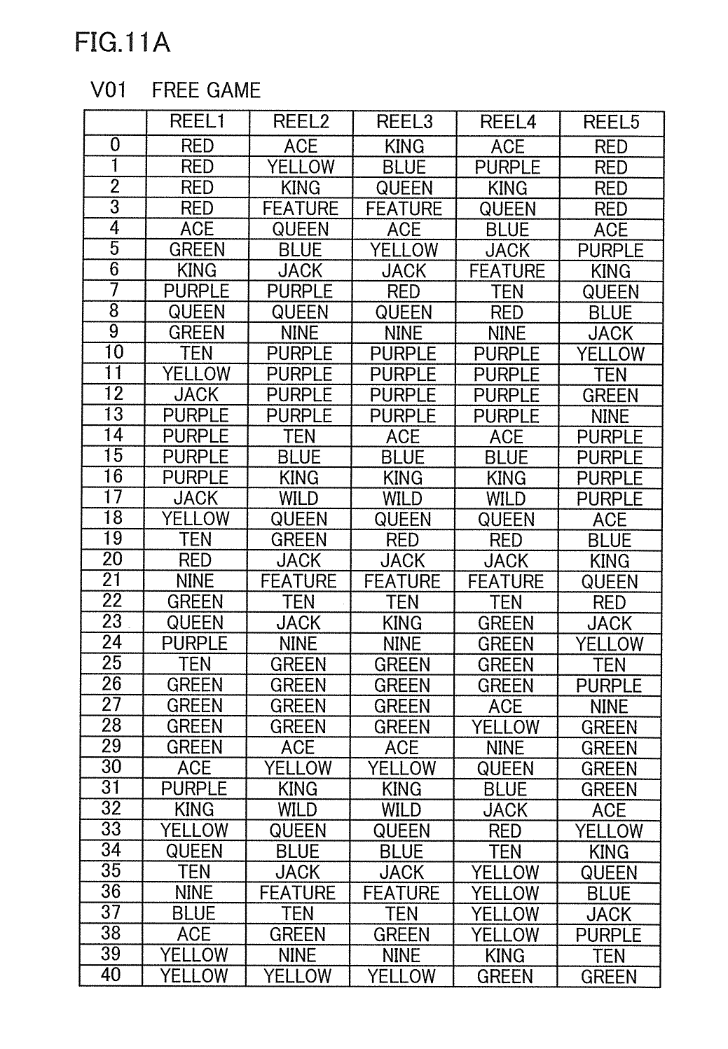

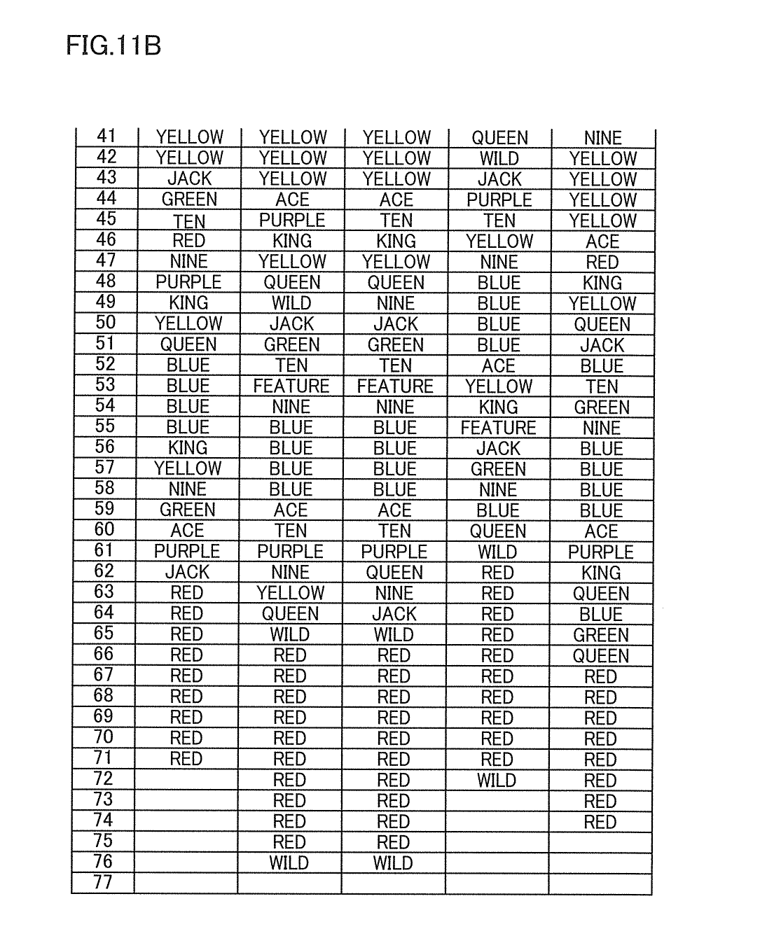

FIG. 11A to FIG. 20B show symbol tables. Each symbol table is used for determining which symbols 501 are the targets of rearrangement. In the symbol table, symbols on the display blocks 28 in each symbol array are associated with code numbers, and numerical ranges defined by dividing a numerical range of 0 to 65535 are associated with the respective code numbers.

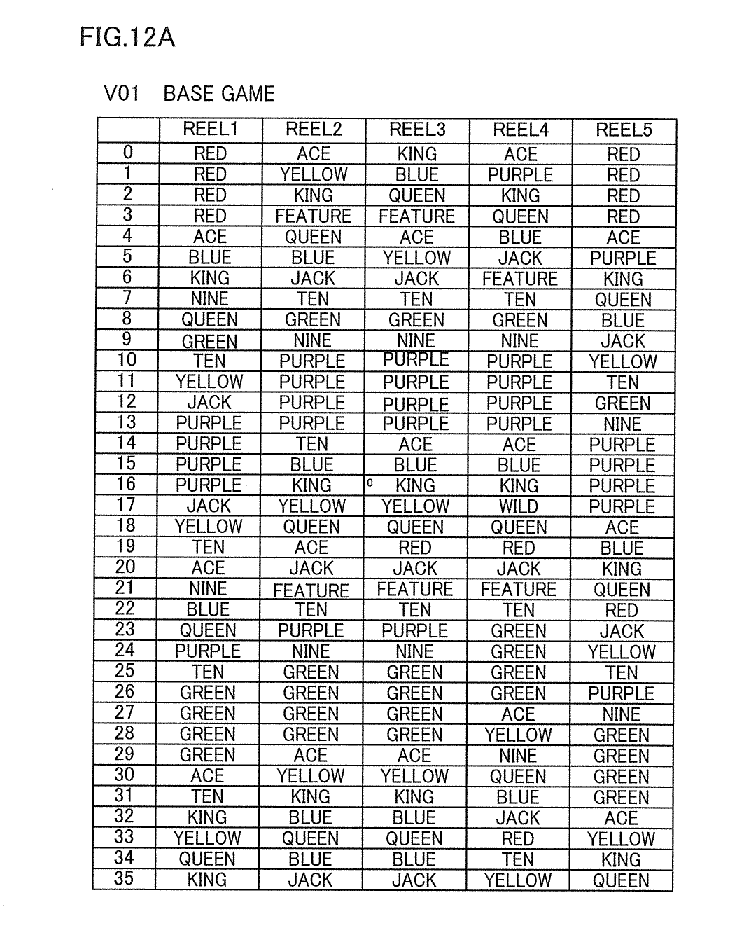

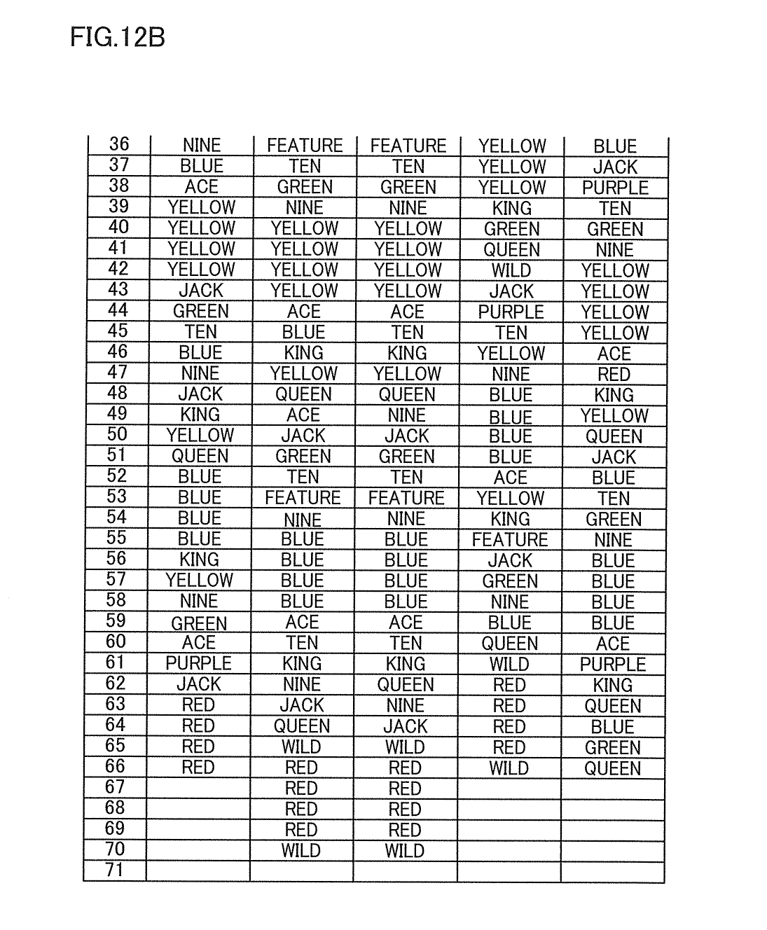

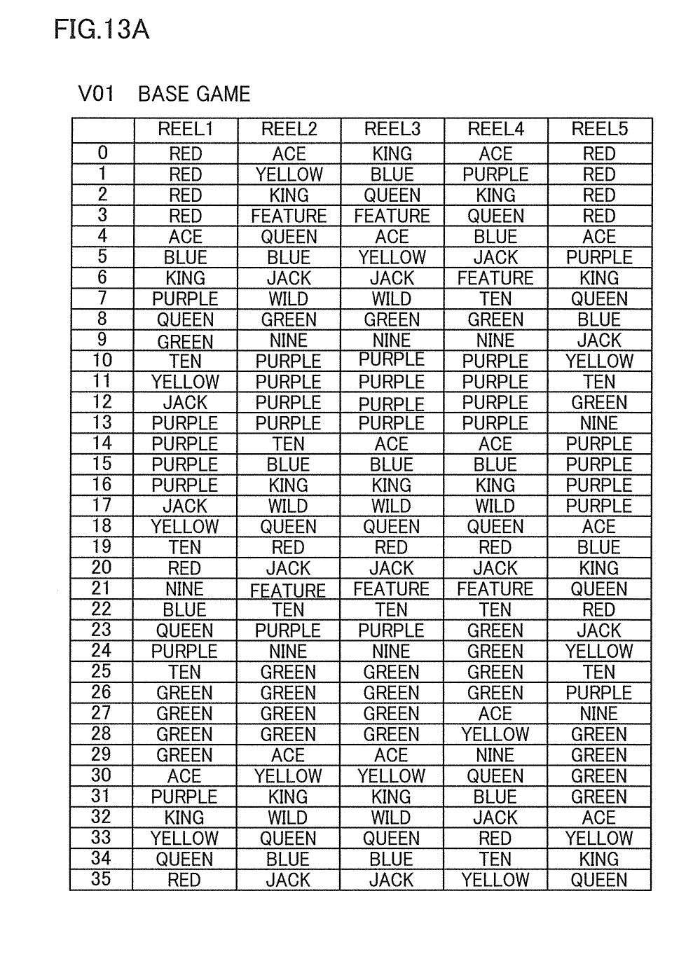

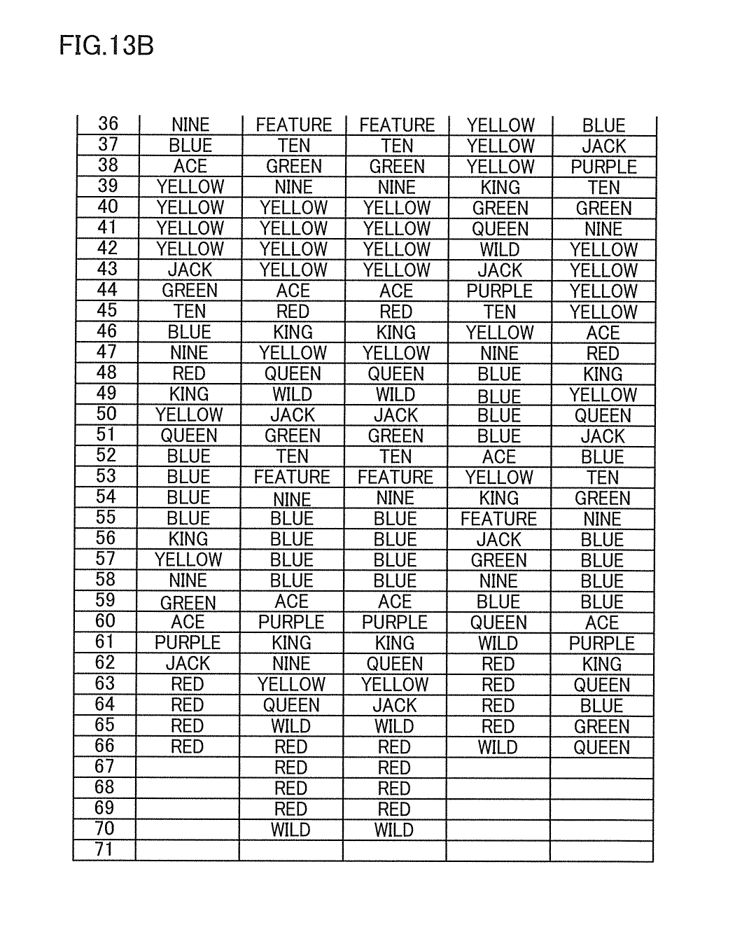

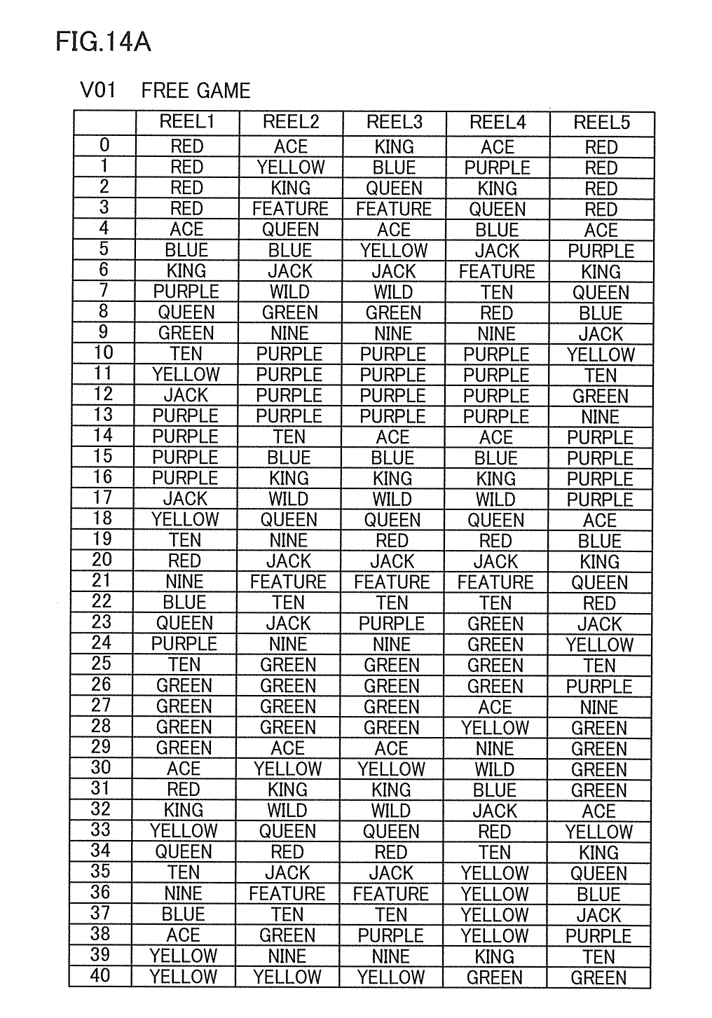

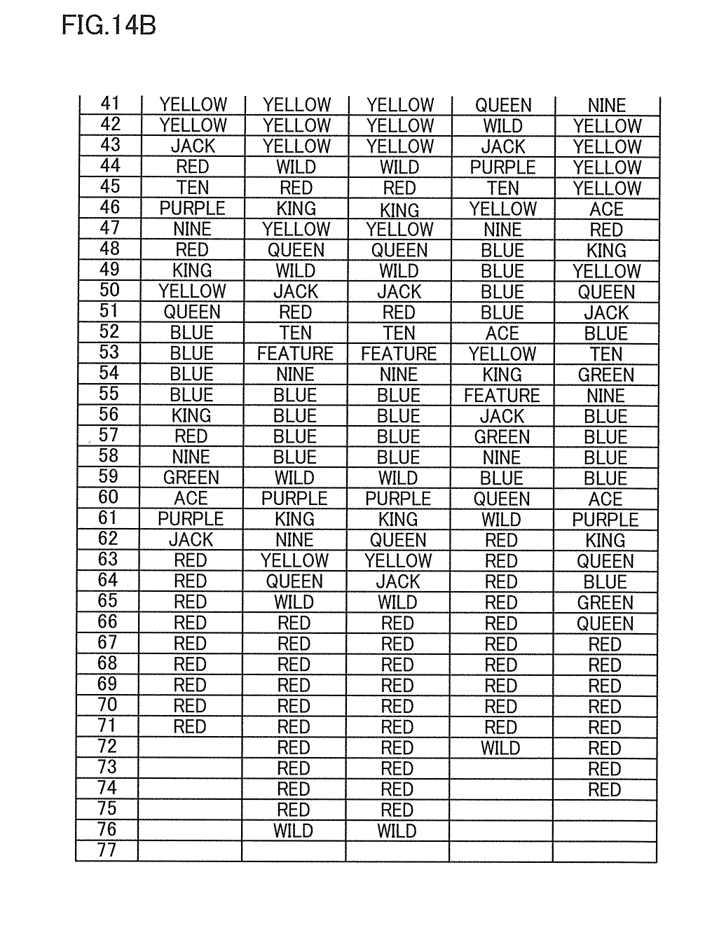

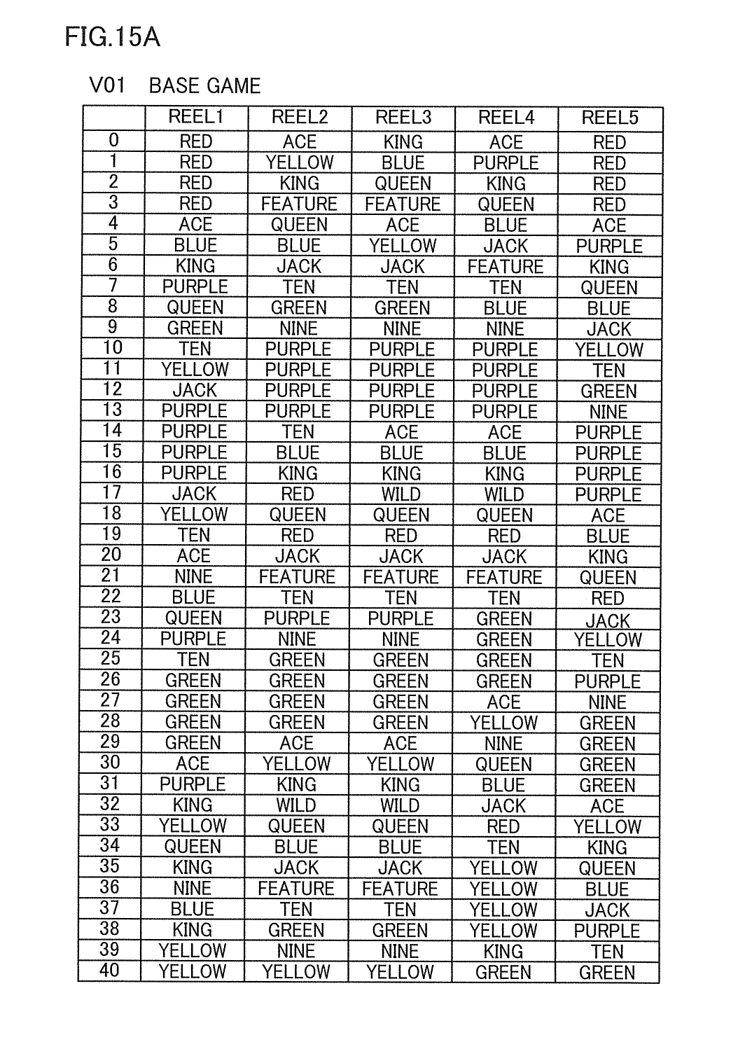

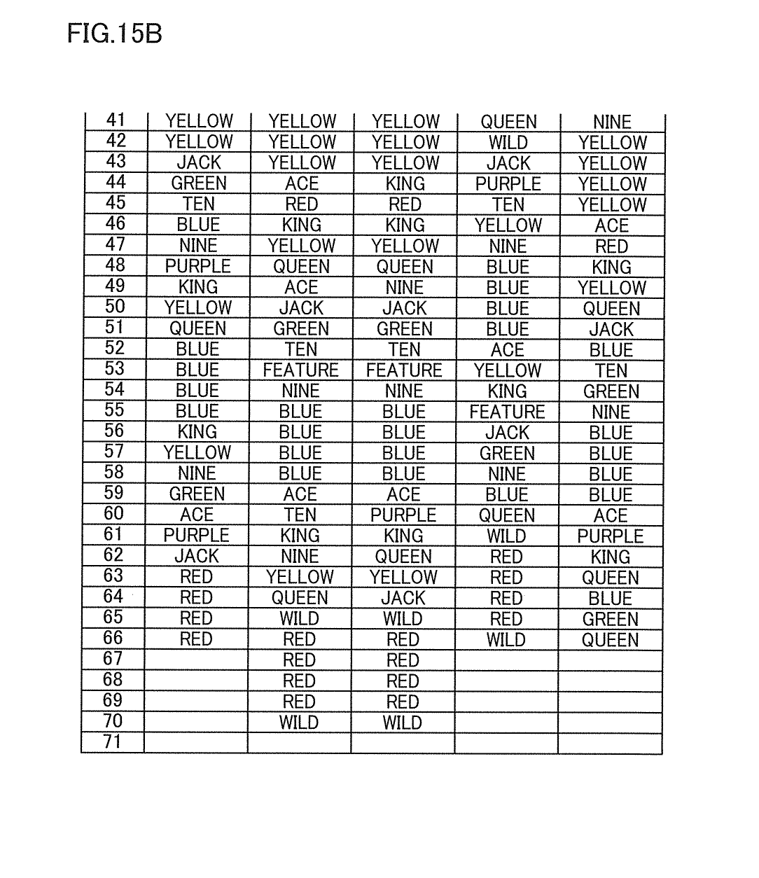

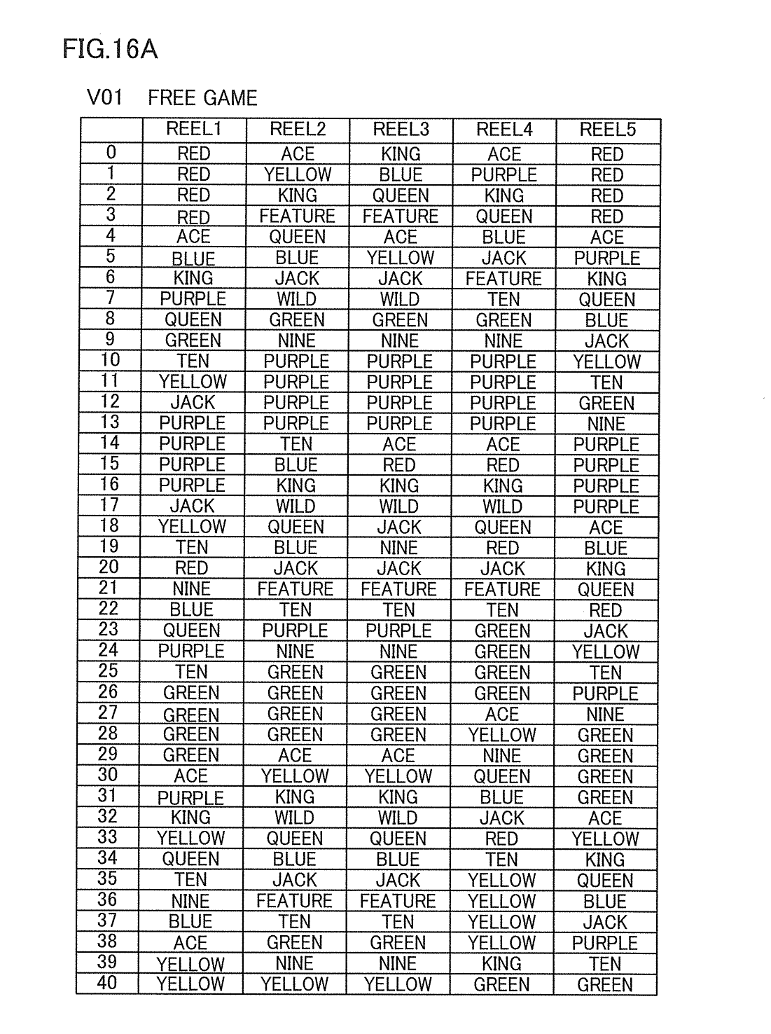

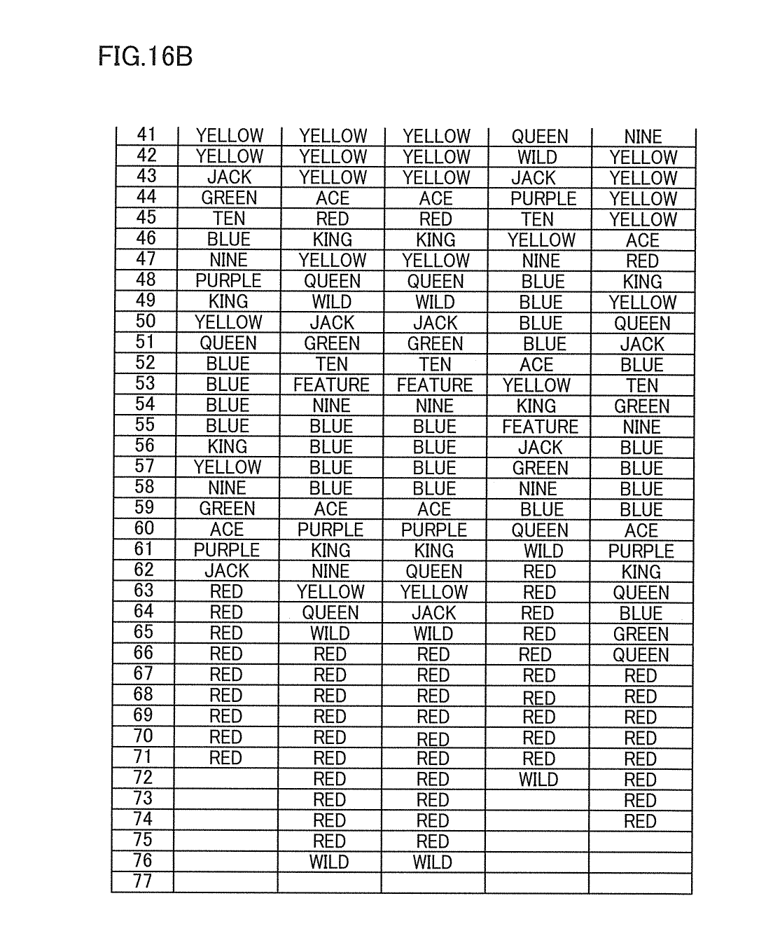

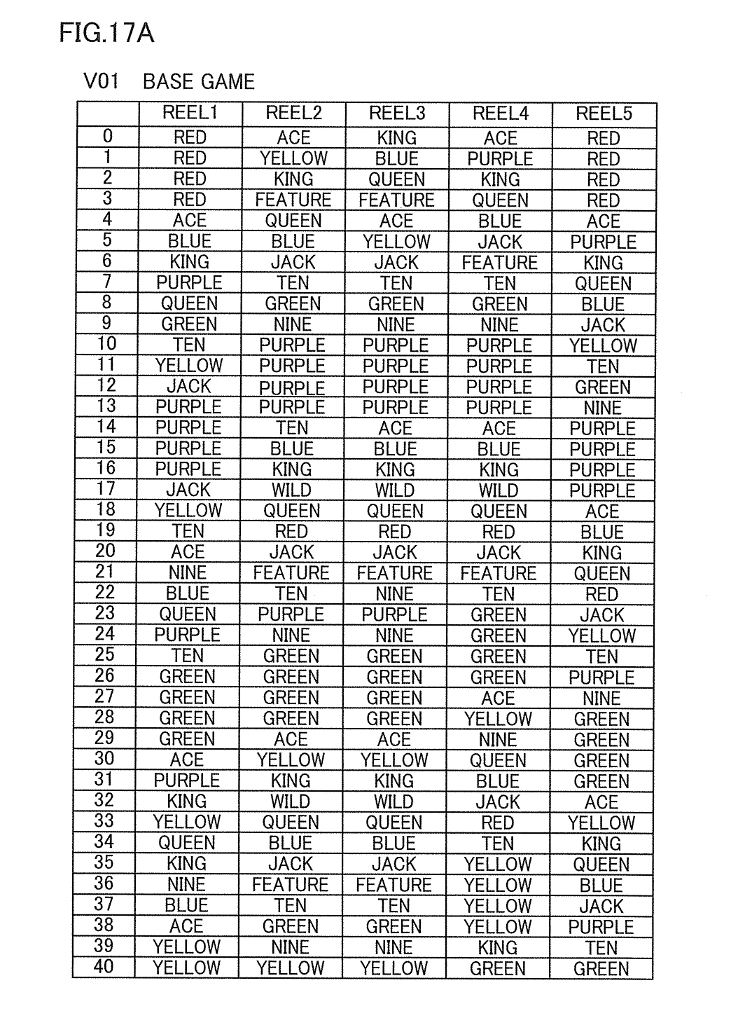

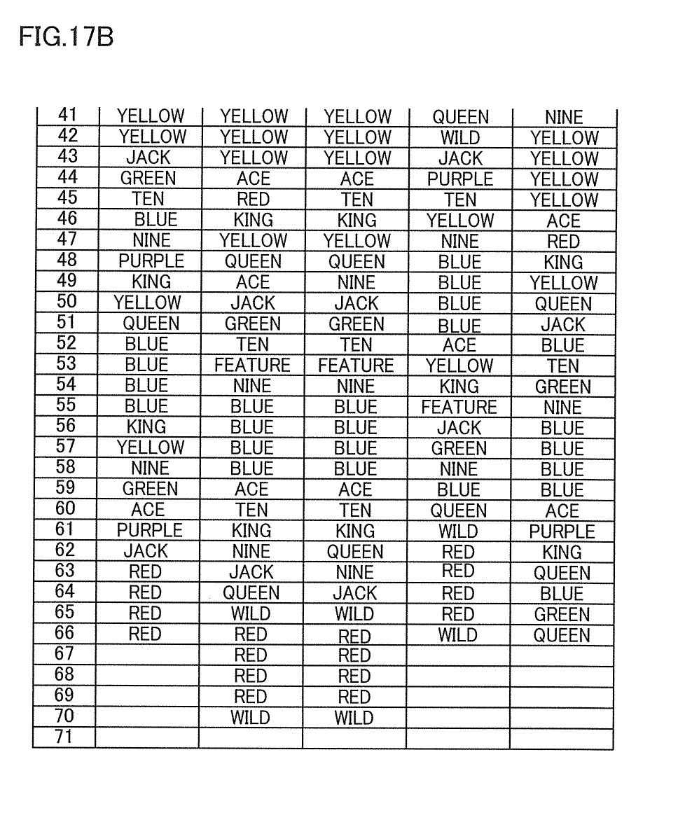

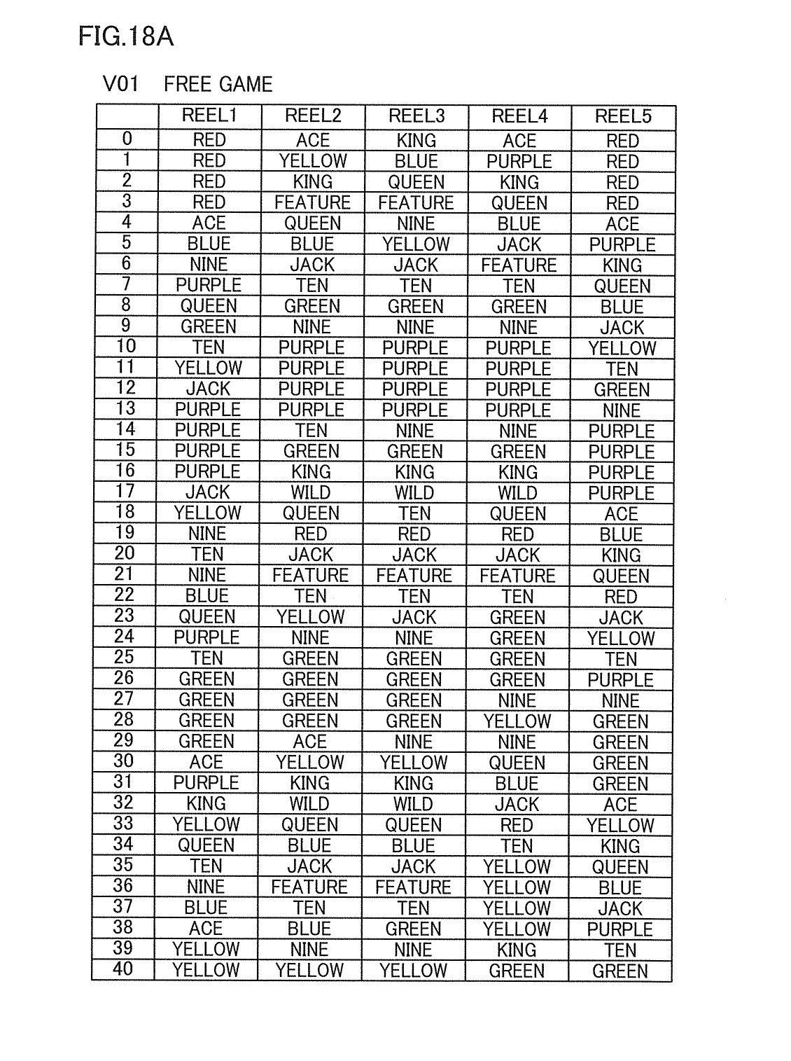

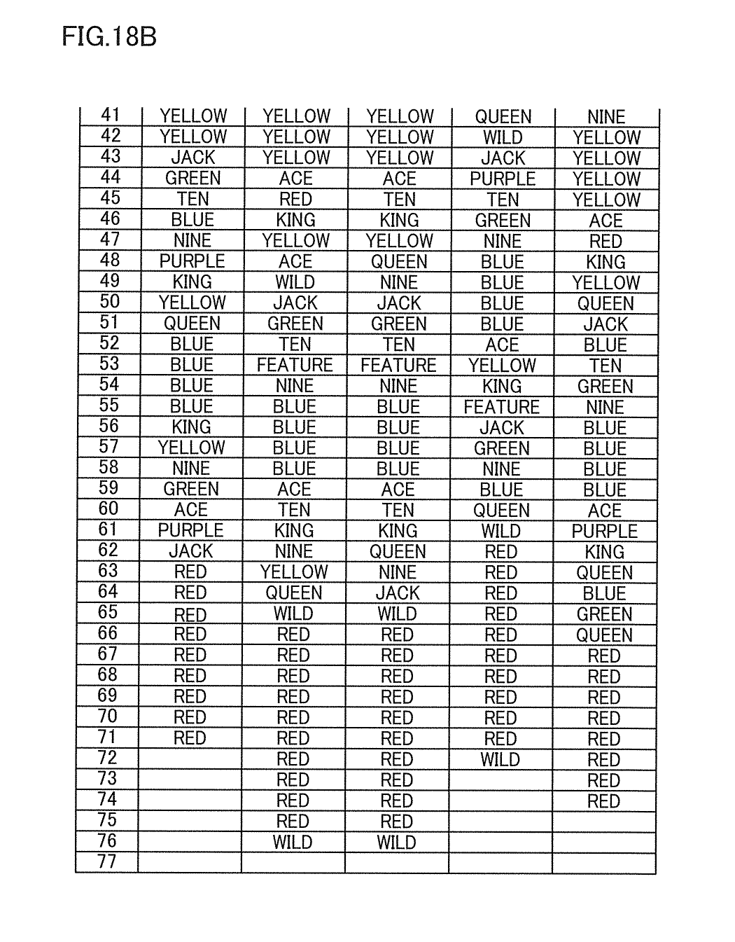

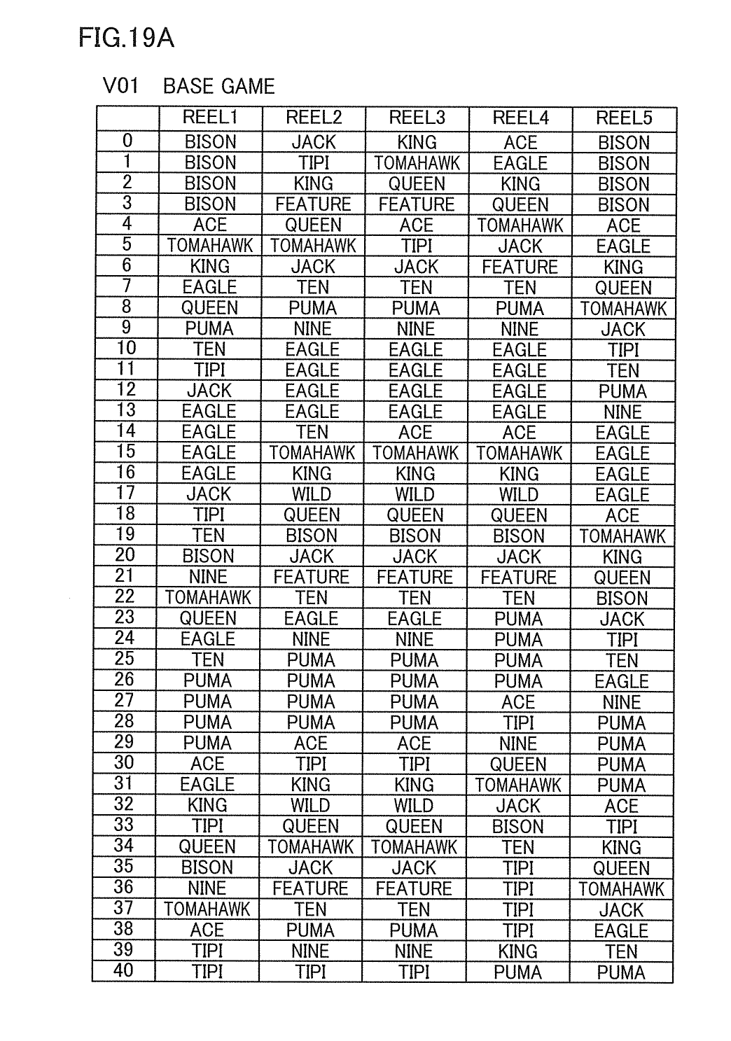

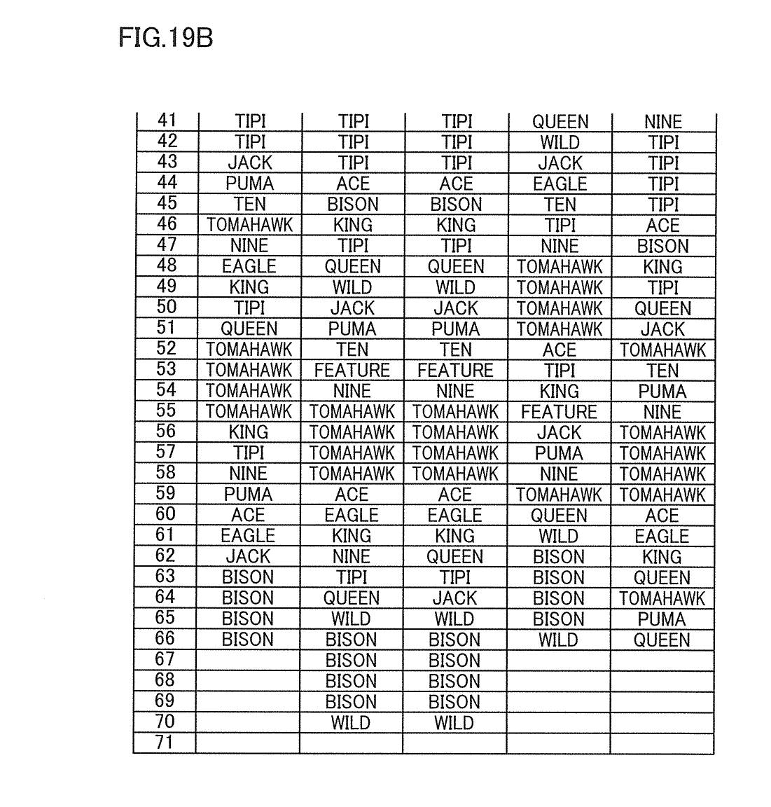

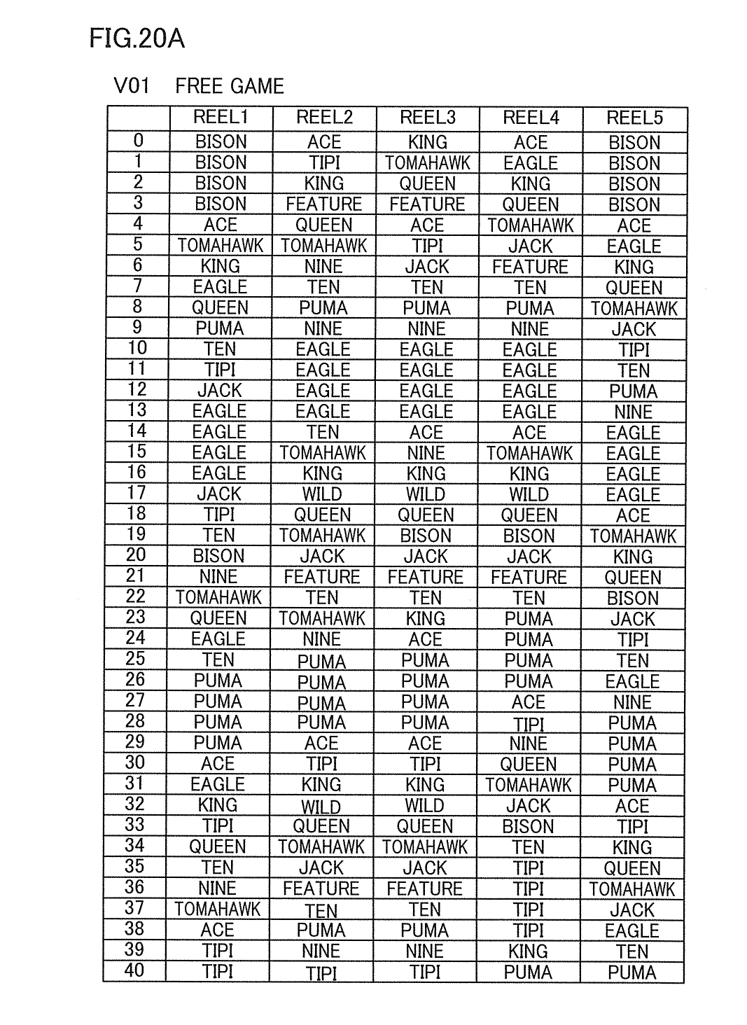

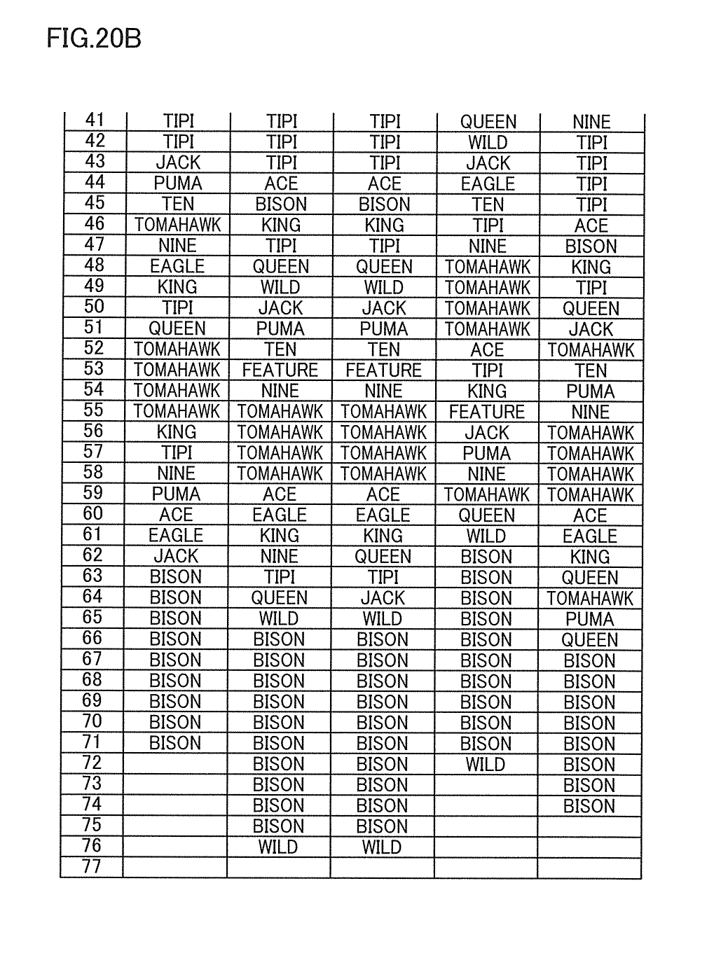

The symbol tables of FIG. 11A and FIG. 11B are selected when the number of winning combination patterns is 4 in a normal game. The symbol tables of FIG. 12A and FIG. 12B are selected when the number of winning combination patterns is 4 in a free game. The symbol tables of FIG. 13A and FIG. 13B are selected when the number of winning combination patterns is 16 in a normal game. The symbol tables of FIG. 14A and FIG. 14B are selected when the number of winning combination patterns is 16 in a free game. The symbol tables of FIG. 15A and FIG. 15B are selected when the number of winning combination patterns is 64 in a normal game. The symbol tables of FIG. 16A and FIG. 16B are selected when the number of winning combination patterns is 64 in a free game. The symbol tables of FIG. 17A and FIG. 17B are selected when the number of winning combination patterns is 256 in a normal game. The symbol tables of FIG. 18A and FIG. 18B are selected when the number of winning combination patterns is 256 in a free game. The symbol tables of FIG. 19A and FIG. 19B are selected when the number of winning combination patterns is 1024 in a normal game. The symbol tables of FIG. 20A and FIG. 20B are selected when the number of winning combination patterns is 1024 in a free game.

The numerical range of 0 to 65535 in each symbol table may be equally or unequally divided. When unequally divided, it is possible to adjust the probabilities of wining for the respective types of the symbols by changing the ranges of the random numbers. In this regard, the ranges corresponding to the “BONUS” of the trigger symbol 503a of the specific symbol 503 and the “WILD” of the wild symbol may be arranged to be narrower than the ranges of the other types of the symbols. In this case, results of games can be easily adjusted in accordance with the progress of the games, by arranging valuable types of the symbols to be less likely to be won.

(Control Panel 30)

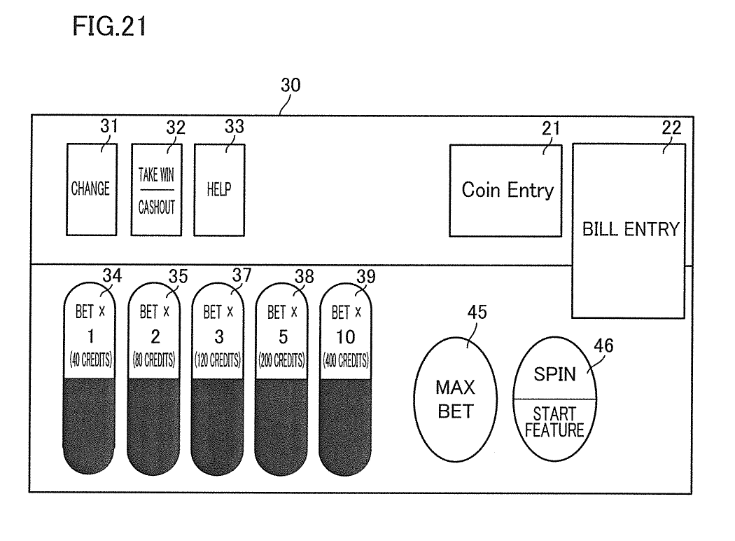

Below the lower image display panel 141, as shown in FIG. 21, a control panel 30 is provided. The control panel 30 is provided not only with buttons but also units such as the coin entry 21 that allows coins to enter the cabinet 11 and the bill entry 22.

More specifically, on the control panel 30, a change button 31, a cash-out button 32, and a help button 33 are provided on the upper stage of the left area in front elevation, a 1-BET button 34, a 2-BET button 35, a 3-BET button 37, a 5-BET button 38, and a 10-BET button 39 are provided in the middle stage of the left area.

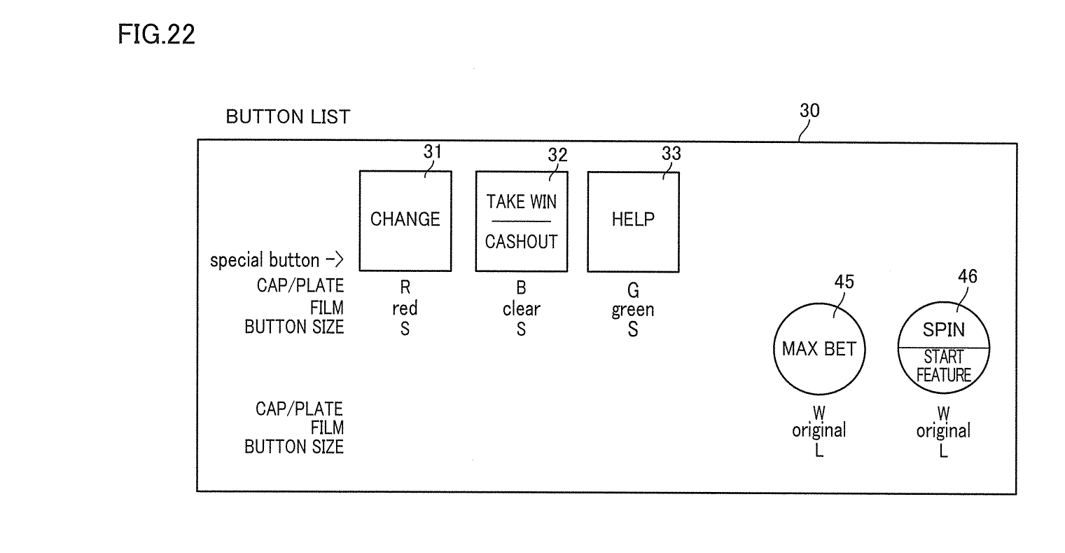

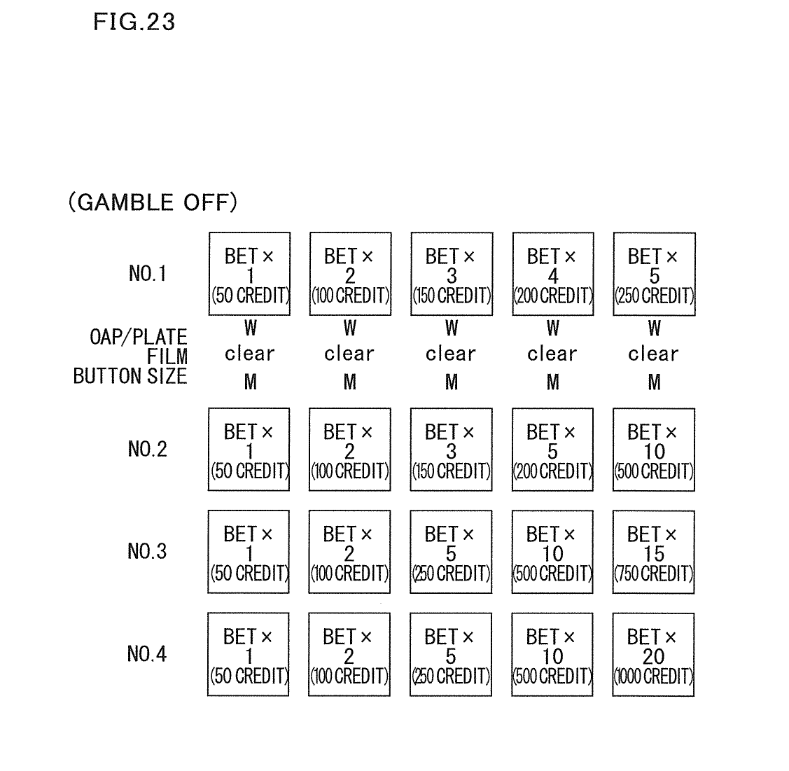

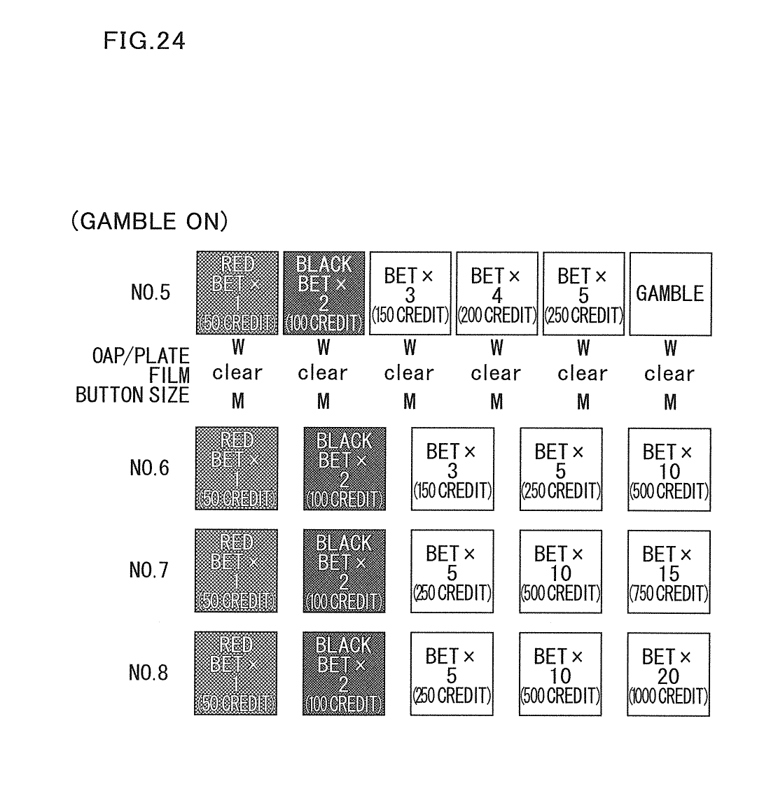

Furthermore, the control panel 30 is formed by combining the components on the “BUTTON LIST” shown in FIG. 22. FIG. 23 shows the configuration in the state of GAMBLE OFF. FIG. 24 shows the configuration in the state of GAMBLE ON.

The control panel 30 makes it possible to conduct selections in the same manner as those by the touch panel, on various types of selection screens. For example, a cursor is moved leftward as the 1-BET button 34 is touched, and the cursor is moved rightward as the 10-BET button 39 is touched. When the operation is carried out, the light source in each button is preferably turned on.

In addition to the above, on the control panel 30, the coin entry 21 and the bill entry 22 are provided on the upper stage of the right area, whereas a maximum BET button 45 and a spin button 46 are provided on the lower stage of the right area.

The change button 31 is used when a player leaves the machine or when the player asks a staff person of the gaming facility to exchange money. The cash-out button 32 is a so-called settlement button by which credit data concerning credits obtained in games is added to the credit data stored in an IC card inserted into the PTS terminal 700. The help button 33 is pressed when, for example, it is unclear how to play a game. As the help button 33 is pressed, various help information is displayed on the later-described upper image display panel 131 and the lower image display panel 141.

Each time the 1-BET button 34 is pressed, one of the credits currently owned by the player is bet. The 2-BET button 35 is used to start a game with two credits bet. The 3-BET button 37 is used to start a game with three credits bet. The 5-BET button 38 is used to start a game with five credits bet. The 10-BET button 39 is used to start a game with ten credits bet. The MAX-BET button 45 is used to start a game with the maximum credits bet.

The gamble button 45 is an operation button used for, for example, shifting to the gamble game after the end of the bonus game or the like. The gamble game is a game played with the consumption of an obtained credit.

The spin button 46 is a button used for starting the scroll of the symbols. This spin button 46 also functions as a button for starting a bonus game and for adding a payout awarded in a bonus game to the credits. The coin entry 21 is used for receiving coins into the cabinet 11. The bill entry 22 validate bills and receives genuine bills into the cabinet 11.

(Details of Operation of Control Panel 30)

The operations of the control panel 30 are changed or restricted in accordance with the content of the display screen and the operations on the lower image display panel 141.

(Details of Operation of Control Panel 30: Immediately after Clearance of RAM)

The change button 31 is in the off state and disabled, and is turned on/off as pressed. The cash-out button 32 is in the off state and disabled. The help button 33 is in the on state and active. The 1-BET button 34 to 10-BET button 39 are in the off state but active. The gamble button 44 is in the off state and disabled. The maximum BET button 45 is in the off state and disabled. The spin button 46 is in the off state and disabled.

The gamble button 44 appears only when GAMBLE ENABLE is set. The gamble button 44 is basically in the on state and active only when “PLAY ON, GAMBLE OR TAKE WIN” is displayed. The button is in the off state and disabled in other cases.

(Details of Operation of Control Panel 30: Idle State (without Credits))

The change button 31 is in the off state but active. The button is turned on/off as pressed. The cash-out button 32 is in the off state but active. The help button 33 is in the on state and active. The 1-BET button 34 to 10-BET button 39 are in the off state or are in the on state and active. In other words, these buttons retain the state of the previous game play. The gamble button 44 is in the off state but active. The maximum BET button 45 is in the off state but active. The spin button 46 is in the off state but active.

(Details of Operation of Control Panel 30: Idle State (with Credits))

The change button 31 is in the off state but active. The button is turned on/off as pressed. The cash-out button 32 is in the on state and active. The help button 33 is in the on state and active. The 1-BET button 34 to 10-BET button 39 are in the off state or are in the on state and active. In other words, these buttons retain the state of the previous game play. The gamble button 44 is in the off state and disabled. The maximum BET button 45 is turned on when MAX BET is possible, and a game starts with “MAX BET” when the button pressed. When the credits are less than MAX BET, the button is turned on, and the maximum credits bettable are selected when the button is pressed. When the credits are less than the amount for one bet, the button is in the off state and disabled. The spin button 46 is in the on state and active in a bet pattern in which the remaining credits are selected. When the remaining credits are smaller than the selected bet pattern, the button is in the off state and disabled.

(Details of Operation of Control Panel 30: Continuous Pressing of Spin Button 46)

Auto bet starts as the spin button 46 is continuously pressed. The maximum BET button 45 is in the off state and disabled. The other buttons are in the off state and disabled. The auto bet function (button) is the operation identical with those during the reel spin and the WIN increment. However, during the WIN increment, the next game starts rather than the GAME OVER, when the illuminated button is pressed. The button operation when a payout occurs is identical with that of the WIN increment. The button operation when losing the game is identical with the operation during the reel spin. When the feature is waited for, it is necessary to press the spin button 46 again to execute the function of the spin button.

(Details of Operation of Control Panel 30: During Help Screen)

The change button 31 is in the off state but active. The button is turned on/off as pressed. The cash-out button 32 is in the off state and disabled. The help button 33 is in the on state and active. The help ends when the button is pressed. The 1-BET button 34 is in the on state and active. The next page of the help screen is displayed when the button is pressed. The 2-BET button 35 is in the on state and active. The previous page of the help screen is displayed when the button is pressed. The maximum BET button 45 is in the on state and active. The help ends when the button is pressed. The spin button 46 is in the on state and active. The help ends when the button is pressed. The other buttons are in the off state and disabled.

(Details of Operation of Control Panel 30: During Reel Spin (the Same Applies During Free Game))

The change button 31 is in the off state but active. The button is turned on/off as pressed. The cash-out button 32 is in the off state and disabled. The help button 33 is in the off state and disabled. The maximum BET button 45 is in the on state and active. Quick stop is executed when the button is pressed. The spin button 46 is in the on state and active. Quick stop is executed when the button is pressed. The other buttons are in the off state and disabled.

(Details of Operation of Control Panel 30: During Cancelable Effect Screen)

The change button 31 is in the off state but active. The button is turned on/off as pressed. The cash-out button 32 is in the off state and disabled. The help button 33 is in the off state and disabled. The maximum BET button 45 is in the on state and active. The effect is canceled when the button is pressed. The spin button 46 is in the on state and active. The effect is canceled when the button is pressed. The other buttons are in the off state and disabled.

(Details of Operation of Control Panel 30: In WIN Increment—During Normal Game)

The change button 31 is in the off state but active. The button is turned on/off as pressed. The cash-out button 32 is in the on state and active. The increment is canceled when the button is pressed. The help button 33 is in the off state but active. The 1-BET button 34 to the 10-BET button 39 are in the off state or are in the on state and active. The increment is canceled when one of the buttons is pressed, and the GAME OVER is executed and the selected bet is set and the button is turned on. In other words, these buttons retain the state of the previous game play. The following structure is also possible: these buttons are in the on state and active; and the increment is canceled when one of the buttons is pressed, and the GAME OVER is executed. The maximum BET button 45 is in the on state and active. The increment is canceled when the button is pressed, and the processes from Take WIN to GAME OVER are executed. The spin button 46 is in the on state and active. The increment is canceled when the button is pressed, and the processes from Take WIN to GAME OVER are executed. When credits allowing repeat bet are retained, the next game starts. The spin button 46 may be in the on state and active, and the increment may be canceled when pressed and the GAME OVER may be executed. The gamble button 44 is in the on state and active when Gamble is active. The increment is canceled when the button is pressed, and a gamble screen is displayed. The button is in the off state and disabled when Gamble is disabled.

(Details of Operation of Control Panel 30: In WIN Increment—During Free Game)

The change button 31 is in the off state but active. The button is turned on/off as pressed. The cash-out button 32 is in the on state and active. The next game starts when the number of remaining games is not zero. When the number of remaining games is zero, the shifting to a total WIN signboard is executed. The help button 33 is in the off state and disabled. The 1-BET button 34 to 10-BET button 39 are in the off state or are in the on state and active. Each button is turned on only at the time of betting with the triggering of a free game. The next game starts when the number of remaining games is not zero. When the number of remaining games is zero, the shifting to a total WIN signboard is executed. The maximum BET button 45 is in the on state and active. The next game starts when the number of remaining games is not zero. When the number of remaining games is zero, the shifting to a total WIN signboard is executed. The spin button 46 is in the on state and active. The next game starts when the number of remaining games is not zero. When the number of remaining games is zero, the shifting to a total WIN signboard is executed. The gamble button 44 is in the off state and disabled.

(Details of Operation of Control Panel 30: In Trigger Payout Increment after Winning Free Game)

The change button 31 is in the off state but active. The button is turned on/off as pressed. The cash-out button 32 is in the on state and active. The increment is canceled when the button is pressed, and the shifting to the next step is executed. The help button 33 is in the off state and disabled. The 1-BET button 34 to 10-BET button 39 are in the off state or are in the on state and active. Each button is turned on only at the time of betting with the triggering of a free game. The increment is canceled when the button is pressed, and the shifting to the next step is executed. The maximum BET button 45 is in the on state and active. The increment is canceled when the button is pressed, and the shifting to the next step is executed. The spin button 46 is in the on state and active. The increment is canceled when the button is pressed, and the shifting to the next step is executed. The gamble button 44 is in the off state and disabled.

(Details of Operation of Control Panel 30: Waiting for Selection—Direct Selection of Control Panel 30)

The change button 31 is in the off state but active. The button is turned on/off as pressed. The cash-out button 32 is in the off state and disabled. The help button 33 is in the off state and disabled. The 1-BET button 34 to the 10-BET button 39 are in the on state and active when allocated to selection buttons. The buttons are in the off state and disabled when not allocated to selection buttons. The maximum BET button 45 is in the off state and disabled. The spin button 46 is in the off state and disabled. The gamble button 44 is in the off state and disabled.

(Details of Operation of Control Panel 30: Waiting for Selection—Selection by Moving Cursor)

The change button 31 is in the off state but active. The button is turned on/off as pressed. The cash-out button 32 is in the off state and disabled. The help button 33 is in the off state and disabled. The 1-BET button 34 is in the on state and active. The cursor is moved to the next option when the button is pressed. The 10-BET button 39 is in the on state and active. The cursor is moved to the previous option when the button is pressed. The maximum BET button 45 is in the on state and active when an icon is selected by the cursor. When no icon is selected by the cursor, the button is in the off state and disabled. The spin button 46 is in the on state and active when an icon is selected by the cursor. When no icon is selected by the cursor, the button is in the off state and disabled. The gamble button 44 is in the off state and disabled.

(Details of Operation of Control Panel 30: When Total WIN Signboard is Displayed after Free Game)

The change button 31 is in the off state but active. The button is turned on/off as pressed. The cash-out button 32 is in the off state and disabled. The help button 33 is in the off state and disabled. The maximum BET button 45 is in the off state and disabled until four seconds elapse. The button is in the on state and active after four seconds elapse. The spin button 46 is in the off state and disabled until four seconds elapse. The determination is confirmed when the button is pressed. The button is in the on state and active after four seconds elapse. The increment is canceled when the button is pressed. The gamble button 44 is in the off state and disabled.

(Details of Operation of Control Panel 30: When PLAY ON, GAMBLE or TAKE WIN is Displayed) The change button 31 is in the off state but active. The button is turned on/off as pressed. The cash-out button 32 is in the on state and active. Take WIN and GAME OVER are conducted when the button is pressed. The help button 33 is in the on state and active. The help is displayed when the button is pressed. The 1-BET button 34 to 10-BET button 39 are in the off state or are in the on state and active. In other words, these buttons retain the state of the previous game play. Take WIN and GAME OVER are conducted when the button is pressed. The maximum BET button 45 is in the on state and active. The increment is canceled when the button is pressed and GAME OVER is executed. The spin button 46 is in the on state and active. Take WIN and GAME OVER are conducted when the button is pressed. Then the next game starts. The increment may be canceled and the GAME OVER may be executed when the spin button 46 is pressed. The gamble button 44 is in the on state and active. Gamble is executed when the button is pressed.

(Details of Operation of Control Panel 30: In Gamble)

The change button 31 is in the off state but active. The button is turned on/off as pressed. The cash-out button 32 is in the on state and active. Take WIN and GAME OVER are conducted when the button is pressed. The help button 33 is in the on state and active. The help is displayed when the button is pressed. The 1-BET button 34 is in the on state and active. Red is selected when the button is pressed. The 2-BET button 35 is in the on state and active. Black is selected when the button is pressed. The maximum BET button 45 is in the on state and active. Take WIN and GAME OVER are conducted when the button is pressed. The spin button 46 is in the on state and active. Take WIN is conducted when the button is pressed, and the next game starts. Take WIN and GAME OVER may be conducted when the spin button 46 is pressed. The other buttons are in the off state and disabled.

(Details of Operation of Control Panel 30: In RESIDUAL GAMBLE)

The change button 31 is in the off state but active. The button is turned on/off as pressed. The cash-out button 32 is in the on state and active in case of GAMBLE-ODD SUM. ATTENDANT PAY is conducted when the button is pressed. The button is in the off state and disabled in case of GAMBLE-NONE. The help button 33 is in the off state and disabled. The maximum BET button 45 is in the off state and disabled. The spin button 46 is in the on state and active. The normal game comes back when the button is pressed. The gamble button 44 is in the on state and active. RESIDUAL GAMBLE starts when the button is pressed. The other buttons are in the off state and disabled.

(Details of Operation of Control Panel 30: When Error Occurs)

The change button 31 is in the off state but active. The button is turned on/off as pressed. The cash-out button 32 is in the off state and disabled. The other buttons are in the off state and disabled.

(Details of Operation of Control Panel 30: After Return from Error)

The change button 31 is in the off state and disabled. The button remains in the off state but active after 120 seconds elapse. The cash-out button 32 is in the on state and active. The help button 33 is in the on state and active. The 1-BET button 34 to 10-BET button 39 are in the off state or are in the on state and active. In other words, these buttons retain the state of the previous game play. The gamble button 44 is in the off state and disabled. The maximum BET button 45 is turned on when MAX BET is possible, and a game starts with “MAX BET” when the button pressed. When the credits are less than MAX BET, the button is turned on, and the maximum credits bettable are selected when the button is pressed. When the credits are less than the amount for one bet, the button is in the off state and disabled. The spin button 46 is in the on state and active when the remaining credits>selected bet pattern. The button is in the off state and disabled when the remaining credits<selected bet pattern.

(Image Display on Upper Image Display Panel 131 and Lower Image Display Panel 141)

An example of image display on the upper image display panel 131 and the lower image display panel 141 during the operation of the slot machine 10 above will be specifically described.

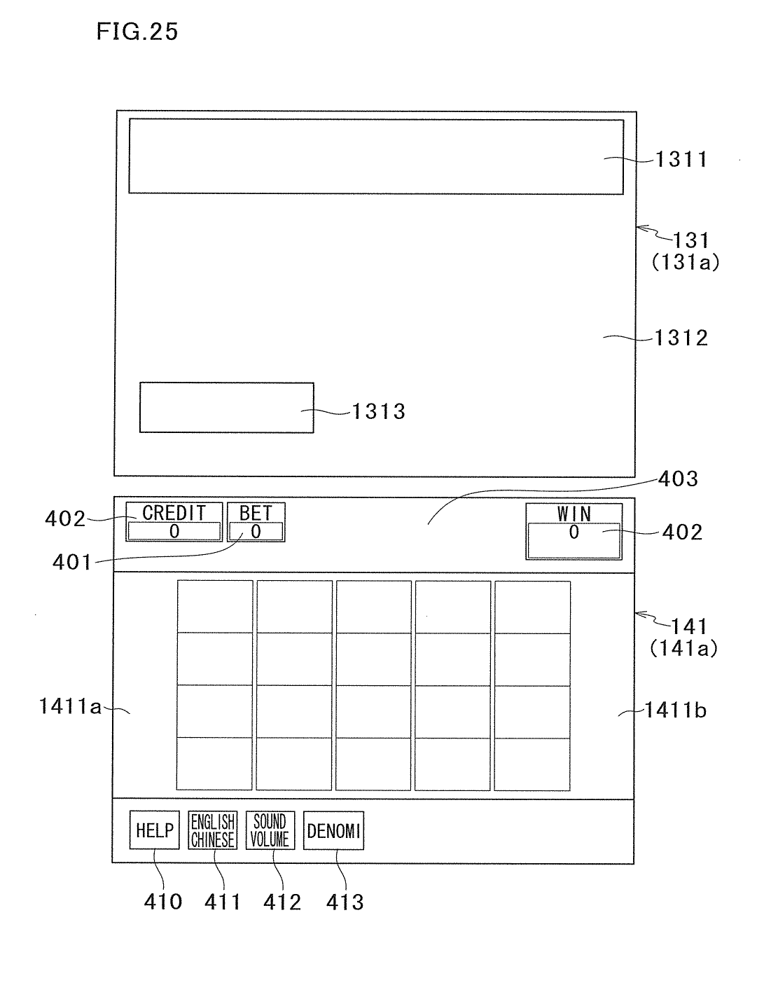

FIG. 25 shows image display on the upper image display panel 131 and the lower image display panel 141 in a normal mode. The upper image display panel 131 includes a game title region 1311, an image region 1312, and a catch copy region 1313. The game title region 1311 displays a logotype of the game title. When the language is switched to English or Chinese, the title is displayed in that language. For example, transliteration “SUTAKKIN URUFU” is displayed in katakana when Japanese is selected, whereas “STACKIN′ Bison” is displayed when English is selected. The image region 1312 displays a main image of the game. The catch copy region 1313 displays a catch copy representing the characteristic of the game. The displayed contents do not change in the normal game and in the free game. When the language is switched to English or Chinese, the title is displayed in that language. For example, transliteration “1024 tori no kachi ga arimasu!” is displayed in katakana when Japanese is selected, whereas “1024 WAYS TO WIN” is displayed when English is selected.

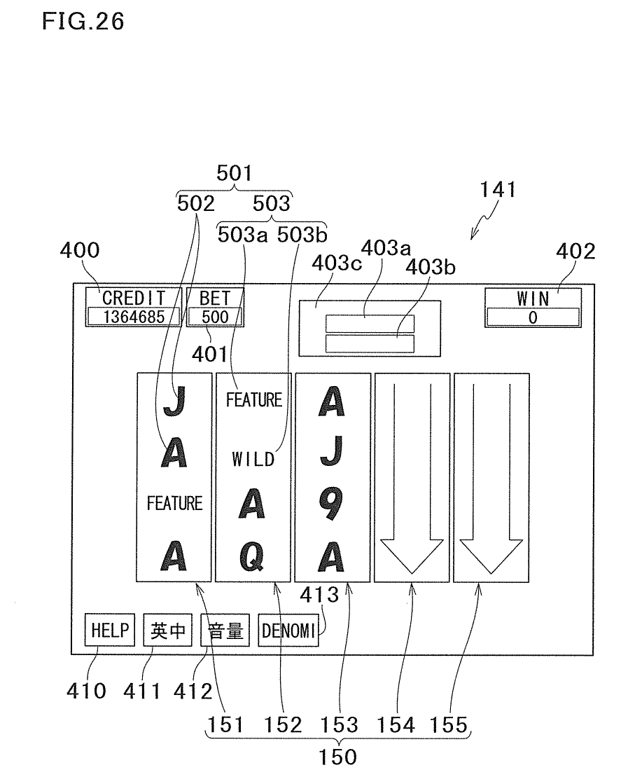

As shown in FIG. 26, the lower image display panel 141 has, at its upper part, a credit meter 400, a bet meter 401, and a WIN meter 402. Between the bet meter 401 and the WIN meter 402, a system font area 403c is provided. Furthermore, the lower image display panel 141 has, at its lower part, a help touch button 410, a language switching touch button 411, a sound volume switching touch button 412, and a denomination button 413.

The system font area 403c displays bet information and a game state. That is to say, the system font area 403c displays bet information of the game (or the last game).

The help touch button 410 displays the first page of the help screen when touched. The button is darkened when it is invalidated, e.g., during the rotation of the reels. As the language switching touch button 411 is touched, the language is switched between English and Chinese. The language switching touch button 411 is activated only during the advertisement. The button is darkened when it is invalidated, e.g., during the rotation of the reels. Through setting of “AUDIT”, the displayed national flags are changed to “Britain/China” or “United States/China”. When the switching of the language is set at “DISABLE”, a “PAYTABLE” button is displayed. In other words, the button is changed to a button displaying a paytable for help. The sound volume switching touch button 412 is used for switching the game sound volume at three stages. Each time the button is touched, the game sound volume is switched such that, for example, from low to middle to high to small to middle. The denomination button 413 displays the current denomination. Details will be given later.

(Display Screen: Normal Game Screen)

FIG. 26 shows an example of a normal game screen which is the display screen of the normal game.

More specifically, the normal game screen has a display window 150 which is provided at the central portion and has five columns of reels 151 to 155. In the machines of NGCB version, the WAY bet pattern is 1024 WAYS only. In machines of SABS or MACAU version, the WAY bet pattern is able to be changed depending on the selected region. More specifically, in this case, 4 WAYS is associated with a region 1, 16 WAYS is associated with a region 2, 64 WAYS is associated with a region 3, 256 WAYS is associated with a region 4, and 1024 WAYS is associated with a region 5.

Above the display window 150, a credit meter 400, a bet meter 401, and a WIN meter 402. The credit meter 400 and the bet meter 401 are provided at the left edge part when viewed from the player. In the meantime, the WIN meter 402 is provided at the right edge part when viewed from the player. Between the bet meter 401 and the WIN meter 402, the system font area 403c is provided. The system font area 403c has, in an upper stage and a lower stage, a bet information display region 403a and a game state display region 403b, respectively.

The credit meter 400 displays the total number of credits. The default value is 0. The value is increased and decreased as follows: When “take WIN”, which indicates winning in a game, is achieved, the credit won in the game is added to the credit meter. When a game is played, the bet number is subtracted from the credit meter. The bet number is also subtracted when the “collect” ends.

The bet meter 401 displays “Total Bets”. The value is re-calculated in each game play. The WIN meter 402 displays the total obtained credits in an increment manner. The default value is 0. Every number of credits displayed on the WIN meter 402 is the real number of credits obtained, which is calculated by multiplying a payout amount by the BET PER REEL value.

The bet information display region 403a displays the bet information of a game (or the last game). In the first line, the number of bets per way is displayed. The display content is either singular or plural in line with the number of bets. Specifically, in the first line, displayed is “BET MULTIPLIER 1”, for example. The game state display region 403b displays a current state of the game. A state display message is not displayed during the game, and the message “GAME OVER” is displayed when the game is over. During waiting for Gamble, “PLAY ON, GAMBLE or TAKE WIN” is displayed. The message is displayed until a button operation instructing Play-on or Gamble is conducted during the idle state or after the occurrence of winning

In the meantime, below the display window 150 are provided the help touch button 410, the language switching touch button 411, the sound volume switching touch button 412, and the denomination button 413. These buttons 410, 411, 412, and 413 are provided left to right when viewed from the player.

The help touch button 410 displays the first page of the help screen 4101 when touched. The help touch button 410 is darkened when it is disabled, e.g., during the rotation of the reels. The button is displayed while the normal screen is displayed. The button disappears in the help screen 4101, the free game screen and the double-up screen.

As the language switching touch button 411 is touched, the language is switched between English and Chinese. The language switching touch button 411 is active only during the advertisement, and is darkened when it is disabled, e.g., during the rotation of the reels. By setting in “AUDIT”, the national flags displayed on the language switching touch button 411 are changed to “Britain/China” or “United States/China”. When the switching of the language is set at “DISABLE”, a “PAYTABLE” button, through which a payout table for HELP is displayed, replaces the language switching touch button 411.

The sound volume switching touch button 412 is used for switching the game sound volume at three stages. Each time the button is touched, the game sound volume is switched such that, for example, from low to middle to high to low to middle. The button is displayed while the normal screen is displayed. The button disappears when the help screen 4101 is displayed.

The denomination button 413 displays the current denomination set in the AUDIT. This button is displayed while screens other than the AUDIT are displayed.

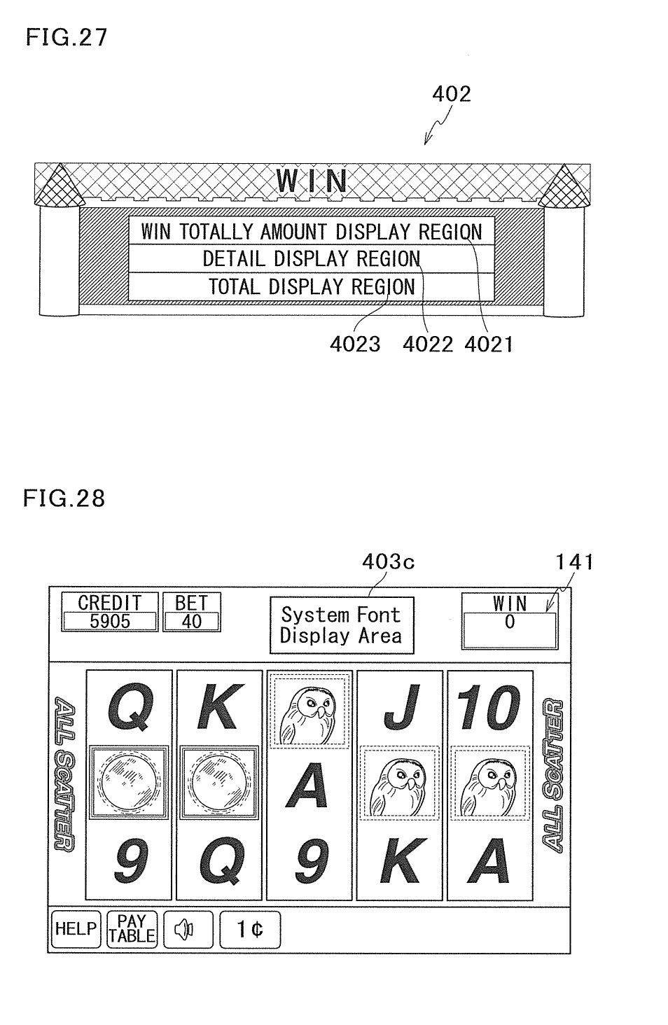

(Details of Display Screen: WIN meter 402) As shown in FIG. 27, the WIN meter 402 displays obtained credits and the details thereof in an integrated meter, when a winning is achieved. The WIN meter 402 includes a WIN total amount display region 4021, a detail display region 4022, and a total display region 4023.

(Details of Display Screen: WIN Meter 402: WIN Total Amount Display Region 4021)

The WIN total amount display region 4021 displays a WIN total amount display region WIN credit and a money amount. Increment display is performed based on a WIN increment speed sheet, when performed. More specifically, the WIN total amount display region 4021 displays the number of credits obtained in the current game cycle (or in the previous game cycle). When a credit is obtained more than once in one game cycle, the credit is added to the WIN total amount display region 4021 each time it is obtained.

0 is displayed either when the next game cycle starts or when lost in Gamble. When won in Gamble, increment is not performed and the displayed amount is immediately doubled. During the idle state, the state display shows the total amount of WIN immediately after the winning, or 0 in other cases. 0 is displayed when SPIN is pressed. Increment display is performed during WIN increment. At the introduction of the free game, the total amount of WIN in that game up to the present time is displayed. During the free game, the total amount of WIN in that game up to the present time is displayed.

(Details of Display Screen: WIN Meter 402: Detail Display Region 4022)

The detail display region 4022 displays the WIN credit after the stop of the fifth reel, when winning is achieved in the normal game or the free game. The state display is carried out as below. Immediately after a normal winning in the idle state, the detail of the payout is displayed. When there are more than one payout, the details of the payouts are switched at intervals of 0.5 seconds. Nothing is displayed in other cases. Furthermore, nothing is displayed when the spin button is pressed. The detail of the payout is displayed during WIN increment. When there are more than one payout, the details of the payouts are switched at intervals of 0.5 seconds. Furthermore, nothing is displayed at the time of the introduction of the free game. Furthermore, nothing is displayed during the rotation of the reels in the free game.

(Details of Display Screen: WIN Meter 402: Total Display Region 4023)

The total display region 4023 displays the total credits of the detail display region 4022 when the increment in the WIN total amount display region 4021 is completed. Nothing is not displayed until the increment in the WIN total amount display region 4021 is completed. More specifically, the total credit amount obtained by the spinning in the game is displayed. After the increment is finished in the WIN total amount display region 4021, the total amount is displayed.

The state display is carried out as below. In the idle state, total WIN is displayed immediately after normal WIN. Zero is displayed in other cases. Nothing is displayed when SPIN is pressed. Nothing is displayed during the WIN increment. The total WIN is displayed after the WIN increment. Nothing is displayed at the time of the introduction of a free game. Furthermore, nothing is displayed during the rotation of the reels in a free game.

(Details of Display Screen: System Font Area 403c)

As shown in FIG. 28, the system font area 403c has the bet information display region 403a and the game state display region 403b. The system font area 403c shows the bet information of the game (or the last game) to the player.

The display contents on the game state display region 403b of the system font area 403c are as follows. Immediately after the RAM is cleared, “GAME OVER” is displayed. When the spin button 46 is pressed, nothing is displayed if the reel is rotating, and GAME OVER is displayed in other cases. If winning is achieved immediately after the reel stop (without trigger) and Gamble is possible, “PLAY ON, GAMBLE or TAKE WIN” is displayed, while in other cases, “GAME OVER” is displayed.

Nothing is displayed at the time of bonus trigger. If winning is achieved immediately after the bonus and Gamble is possible, “PLAY ON, GAMBLE or TAKE WIN” is displayed. Immediately after the end of the jackpot, “GAME OVER” is displayed. When the help button 33 is pressed (to display the help screen 4101), nothing is displayed if Gamble is possible on condition that winning is achieved. “GAME OVER” is displayed in other cases.

When the help button 33 is pressed (to return to the game screen), the state before the help screen 4101 is displayed comes back. When the gamble button 44 is pressed (to display the gamble screen), nothing is displayed if Gamble is possible on condition that winning is achieved. The button cannot be operated in other cases. “GAME OVER” is displayed when the BET buttons 34 to 39 are pressed. “GAME OVER” is displayed when Take Win is selected. The previous states come back when returning from the AUDIT or in case of power failure.

(Details of Display Screen: Details of Screen Touch Buttons)

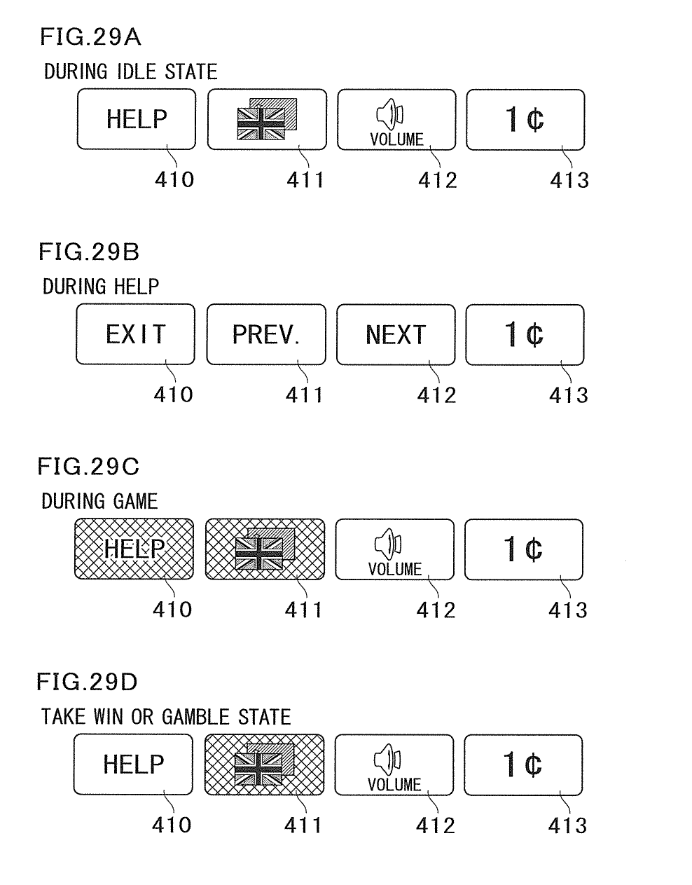

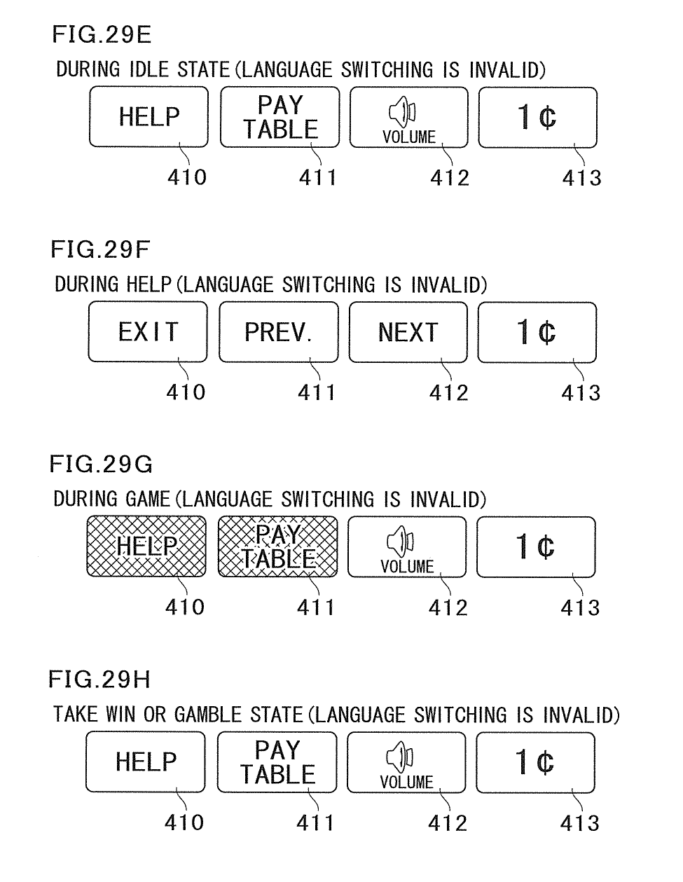

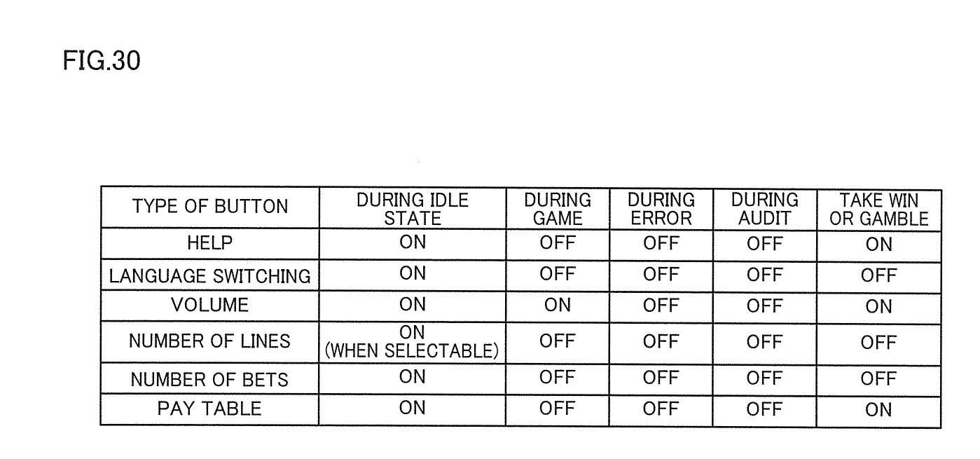

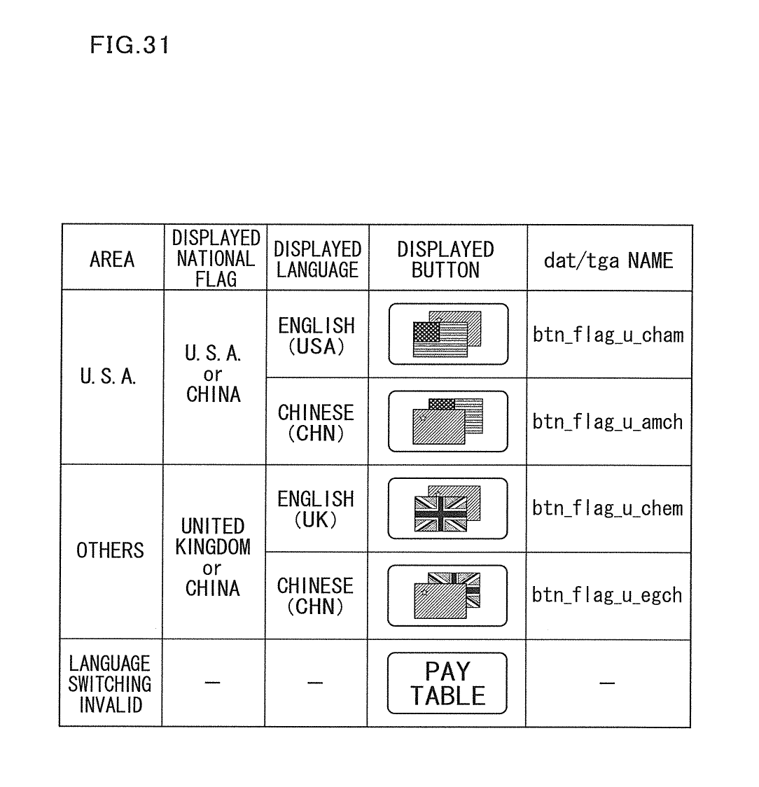

The positions and operations of the help touch button 410, the language switching touch button 411, the sound volume switching touch button 412, and the denomination button 413 are illustrated in the positional configuration in various operation states shown in FIGS. 29A to 29H, a lighting table shown in FIG. 30, and the language setting shown in FIG. 31. For example, the buttons are operable only in the idle state (game over state) regardless of the presence of credits. The switching is impossible during the help, during games, during an error, and during the AUDIT. (The buttons are in the off state and disabled, or are replaced with other buttons). The national flag associated with the currently used language is displayed on the top. The states of the previous game are maintained even after the switching. The default language in English-speaking countries is English. The default language in Chinese-speaking countries is Chinese.

(Details of Display Screen: Sound Volume Switching Touch Button 412)

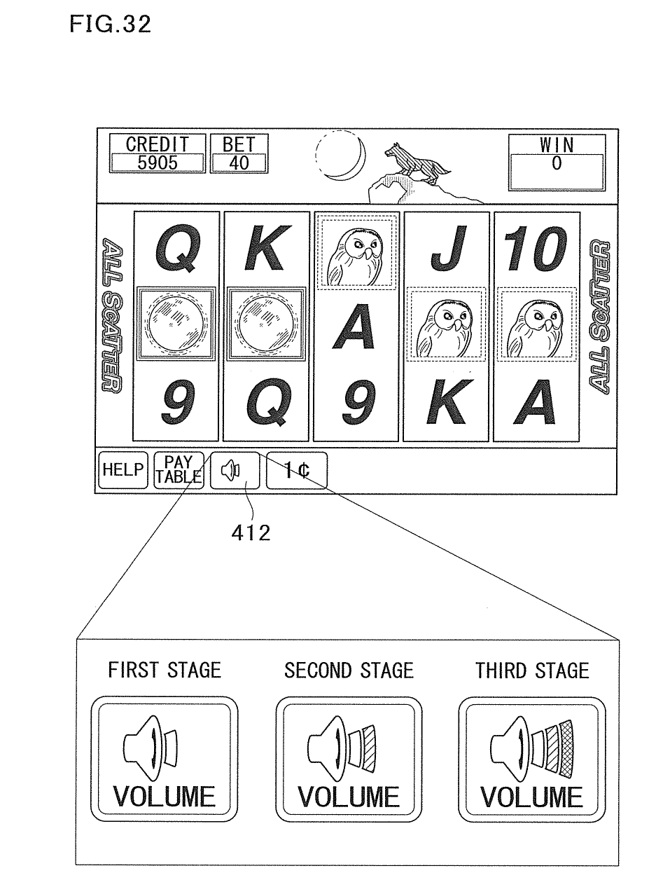

As shown in FIG. 32, the sound volume switching touch button 412 has a function of allowing the player to switch the sound volume at will. The volume is switchable at, for example, three stages. The volume may be linearly changeable. The first stage corresponds to the minimum volume. The second stage corresponds to the medium volume. The third stage corresponds to the maximum volume. The volume stages are switched such that from the first stage to the second stage to the third stage to the first stage.

The default volume stage is the first stage. The default volume stage is set when (1) a game is activated and (2) at the return from the AUDIT (regardless of whether the volume in the AUDIT is changed). The coefficients of volume changes are 30% in the first stage, 70% in the second stage, and 100% in the third stage. The sound volume switching touch button 412 is always active unless the button is hidden. The button is active when GUI (Graphical User Interface) such as the help touch button 410 is displayed. However, while the help screen is displayed, the sound volume switching touch button 412 disappears from the GUI (i.e., is covered with the NEXT button), and therefore the button is not operable. The operation invalidation time of the sound volume switching touch button 412 after the touch, i.e., the minimum interval between serial touching is 0.15 second (150 msec). The default sound volume setting value in the AUDIT is 12. The default value is 5 when no sound volume adjustment touch panel function is provided. The reproduction sound volume of the volume setting change sound in the AUDIT is identical with the default volume of the sound volume switching touch button 412 (i.e., the volume reflecting the coefficient in the default stage).

(Details of Display Screen: AUDIT Screen)

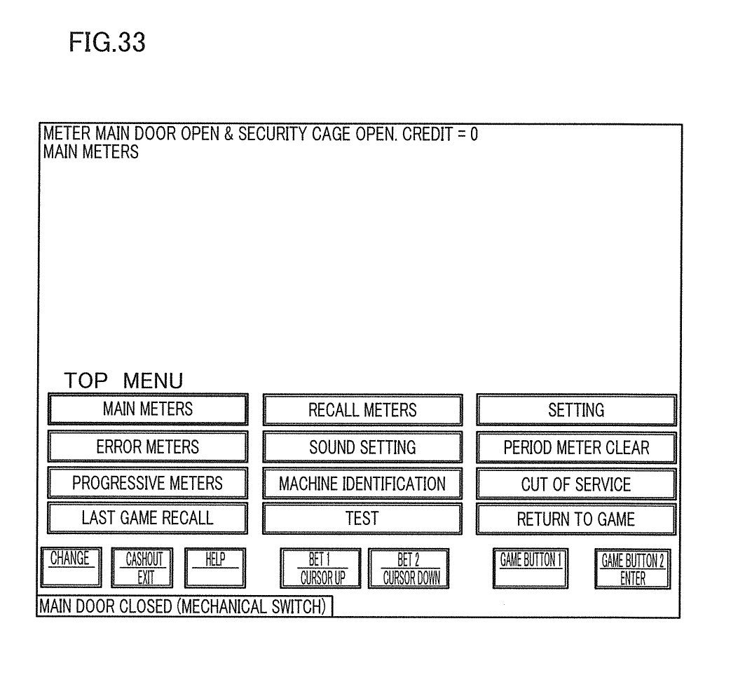

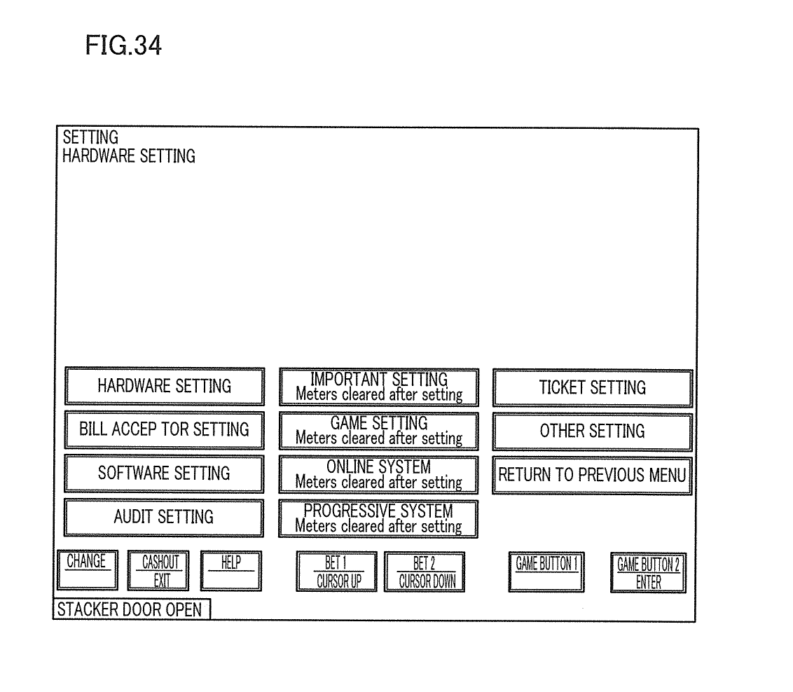

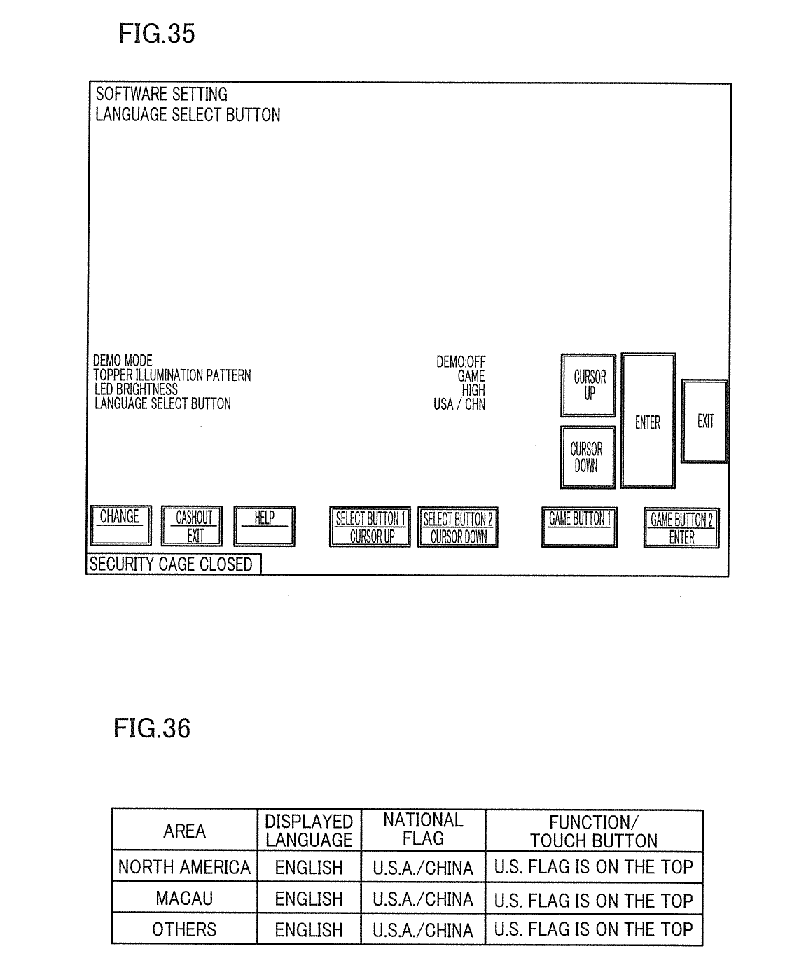

As shown in FIG. 33, the AUDIT screen allows the switching of the national flag on an AUDIT menu. In the switching of the national flag on the AUDIT menu, “national flag” displayed on the touch button at the switching of the language can be set on the AUDIT menu. For example, the operator enters the “AUDIT menu”. Then “SETTING” is pressed, and “SOFTWARE SETTING” is pressed as shown in FIG. 34. Then, a screen shown in FIG. 35 appears.

On the screen shown in FIG. 35, the item “LANGUAGE SELECT BUTTON DISPLAY” is added. In regard to the language switching button, the display content in this layer is one of the followings. That is, for “LANGUAGE SELECT BUTTON DISPLAY”, one of “DISABLED”, “UK/CHN”, and “US/CHN” is selected.

In addition to the above, the initial display after the clearance of the RAM is shown in FIG. 36. That is to say, in North America, the display language is English, the national flags are U.S./China, and the U.S. flag is on the front on the function/touch button. In the Macau area, the display language is English, the national flags are U.K./China, and the U.K. flag is on the front on the function/touch button. In the other areas, the display language is English, the national flags are U.K./China, and the U.K. flag is on the front on the function/touch button.

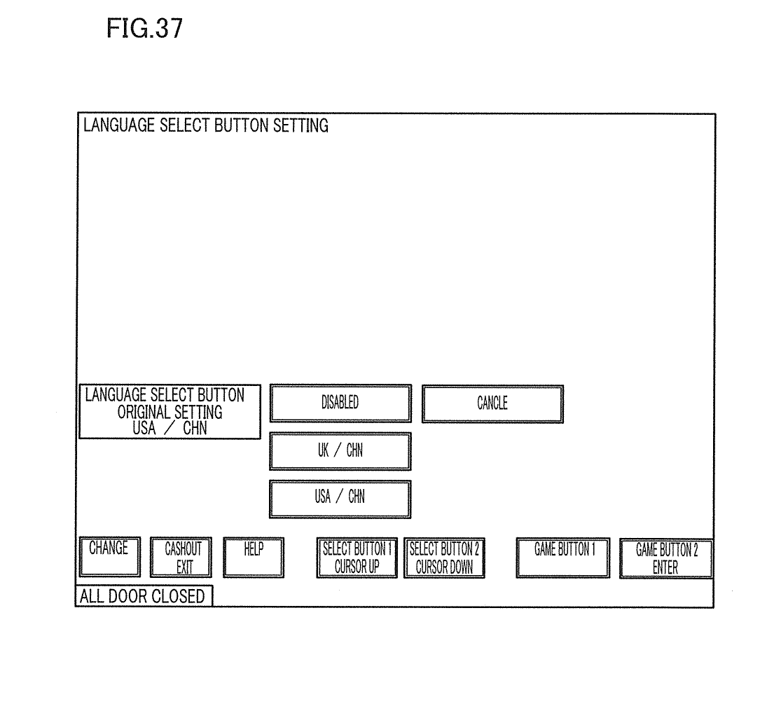

When the item “LANGUAGE SELECT BUTTON DISPLAY” is selected, a screen shown in FIG. 37 is displayed. It is noted that the selected item is enclosed by a red frame. It is noted that the operations through the control panel 30 or the like are not changed from the current settings. DISABLED is setting with which the switching function is disabled (only English). The language switching touch button is switched to “PAYTABLE touch button”. After the touch (i.e., the determination by the button), the screen of the immediately above layer is displayed and the determination is confirmed. UK/CHN indicates that the U.K. flag is set. USA/CHN indicates that the U.S. flag is set. The button also functions as the activation of the switching function (i.e., the switching touch button is displayed). After the touch (i.e., the determination by the button), the screen of the immediately above layer is displayed and the determination is confirmed. The selected national flag is on the front on the touch button (Chinese flag is positioned behind). By “CANCEL”, the screen is canceled and the screen of the immediately above layer comes back. The contents that were previously set remain the same.

(Details of Display Screen: Help Screen 4101)

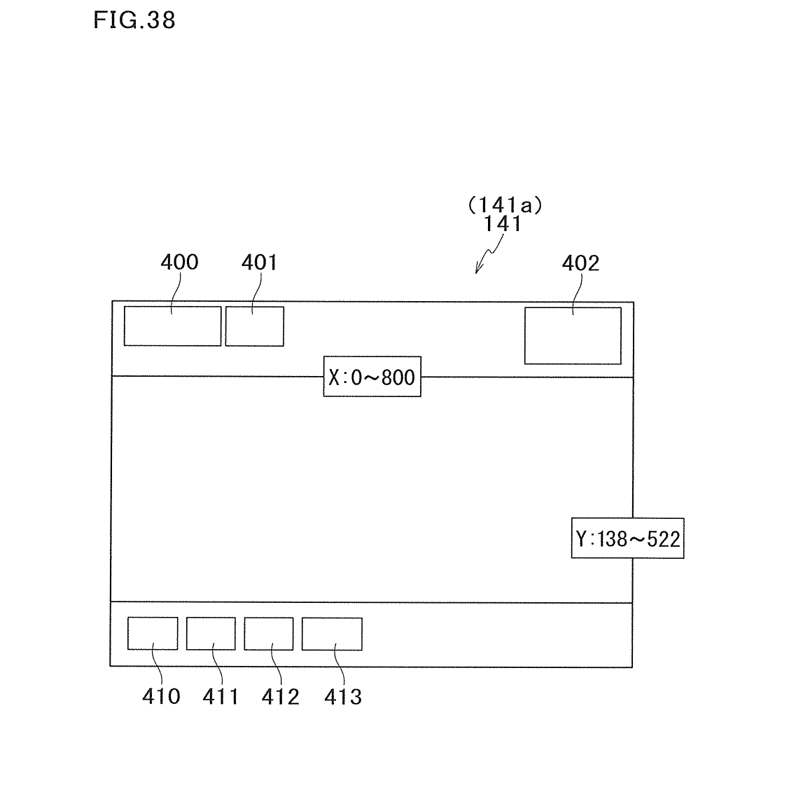

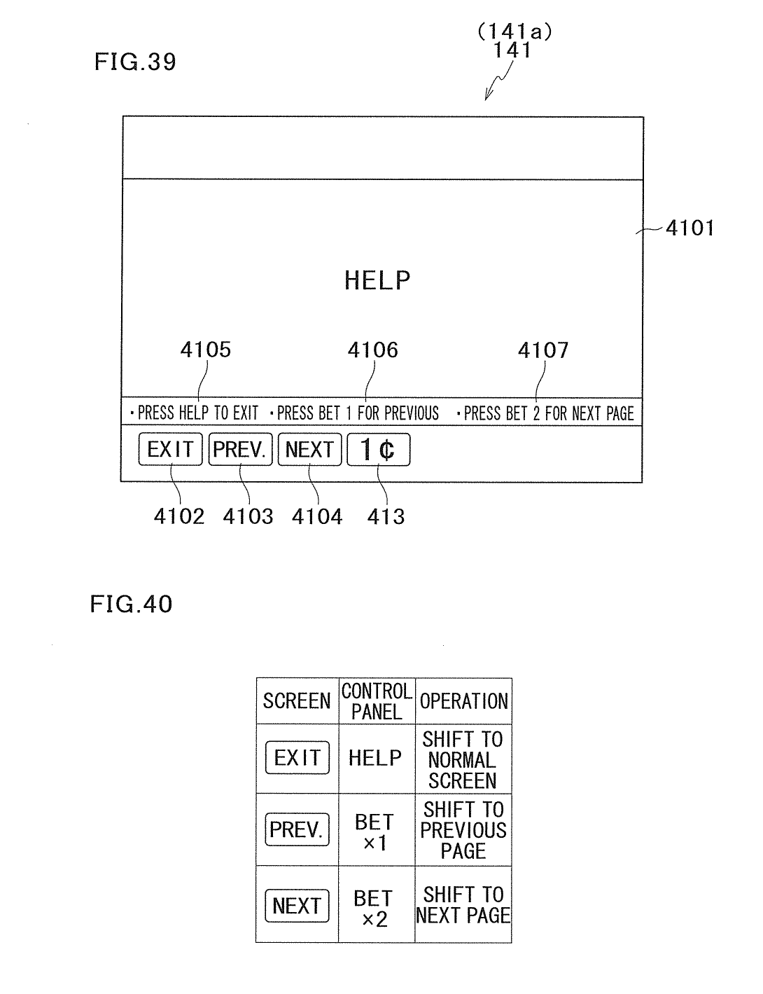

As shown in FIG. 38, the lower image display panel 141 displays the help screen 4101 as the help touch button 410 is operated. Below the help screen 4101 are provided text display regions 4105, 4106, and 4107, as shown in FIG. 39. On the text display regions 4105, 4106, and 4107, texts are displayed with the system font. The help touch button 410 is switched to an EXIT button 4102, the language switching touch button 411 is switched to a PREV button 4103, and the sound volume switching touch button 412 is switched to a NEXT button 4104. When the EXIT button 4102 is touched, the help is terminated and the normal game screen comes back. As the PREV button 4103 is touched, the previous help page is displayed. As the NEXT button 4104 is touched, the next help page is displayed.

An example of the text displayed on the text display region 4105 is PRESS HELP TO EXIT. The maximum number of the characters is 25. An example of the text displayed on the text display region 4106 is PRESS BET 1 FOR PREVIOUS PAGE. The maximum number of the characters is 36. An example of the text displayed on the text display region 4107 is PRESS BET 2 FOR NEXT PAGE. The maximum number of the characters is 33.

As shown in FIG. 40, these buttons 4102, 4103, and 4104 and the text display regions 4105, 4106, and 4107 are linked to the control panel 30. Even if the patterns are altered and the values are changed, the text display regions 4105, 4106, and 4107 display correct contents in accordance with the changes.

(Details of Display Screen: Help Screen 4101: Operations: Operation when Entering the Help Screen 4101)

When the help touch button 410 is pressed in the idle state, only the 1st screen 141a is changed to the help screen 4101 while the 2nd screen 131a keeps displaying the basic screen of the idle state. In this regard, the 2nd screen 131a is displayed on the upper image display panel 131, whereas the 1st screen 141a is displayed on the lower image display panel 141. The help screen 4101 is displayed only on the 1st screen 141a. During an error or AUDIT, the LED of the help touch button 410 is not illuminated so as not to allow the player to enter the help screen 4101. Whether it is possible to enter the help screen 4101 during games is different in each game. Basically, at the destinations of shipment, it is possible to enter the help screen 4101 only in the idle state. The help screen 4101 must be displayed from the first page.

(Details of Display Screen: Help Screen 4101: Operations: Operation on the Help Screen 4101)

When an error or door open occurs, the help screen 4101 ends (i.e., the game screen is reinstated) and “ERROR/DOOR OPEN” is displayed. When a bill or a coin is inserted, the help screen 4101 ends and the credit is received. When an AUDIT key is turned, the help screen 4101 ends and the AUDIT is displayed. After the end of the AUDIT, the idle state comes back. When power interruption occurs, the help screen 4101 is not displayed when the power is turned on and the machine becomes in the idle state. When no input is made for three minutes while the help screen 4101 is being displayed, the help screen 4101 ends and the machine becomes in the idle state.

(Details of Display Screen: Help Screen 4101: Help 1)

Help 1 includes the following contents to be displayed. “This game requires 50 credits at minimum.” “Please select the amount of credit to be bet per game.” “Whether WIN is established is determined on all successive reels from the leftmost, except [FEATURE].” “Each of the symbols appear on the reels is counted once for each winning combination.” “All WINs are displayed in the amount of credit.” “Only the highest WIN is an object to be displayed.” “Every WIN except SCATTER WIN is multiplied by a bet multiplier.” “The amounts of credit of simultaneous WINs are added up.” “The amount of credit of SCATTER WIN is added to that of EVERY WAY WIN.” “All payouts and game plays become invalidated when malfunction occurs.” “Player should check whether correct credits are registered before a game starts.”

(Details of Display Screen: Help Screen 4101: Help 2)

Help 2 explains EVERY WAY. That is, the followings are displayed: “EVERY WAY provides maximum 1024 WAYs.” “Whether EVERY WAY WIN is established is determined on successive reels, with respect to all the positions on the selected ways, from the leftmost, except [FEATURE].” “Each winning combination on one way is formed by symbols of respective reels (one symbol per reel).”

Help 2 includes the explanatory diagrams of FIG. 41A to FIG. 41E, to be displayed. FIG. 41A illustrates 4 WAYS bet for 1 credit. FIG. 41B illustrates 16 WAYS bet for 10 credits. FIG. 41C illustrates 64 WAYS bet for 20 credits. FIG. 41D illustrates 256 WAYS bet for 30 credits. FIG. 41E illustrates 1024 WAYS bet for 50 credits. Note that the symbol positions shade with lines in these figures are excluded from a play of EVERY WAY.

(Details of Display Screen: Help Screen 4101: Help 3)

Help 3 explains Bison free game (free game name). More specifically, the following contents are displayed. “When three feature symbols stop on the second, third, and fourth reels, Bison free game awarding 8 times of execution of free game is triggered.” “Different reel strips are used in the free game.” “In the Bison free game, two WILD symbols may appear only on the second, third, and fourth reels.” “If one or more WILD symbols appear during the Bison free game, a payout is multiplied by a multiplying factor depending on the number of appearing WILD symbols.” “Every WIN is multiplied by 2 when one WILD symbol appears.” “Every WIN is multiplied by 4 when two WILD symbols appear.” “Every WIN is multiplied by 8 when three WILD symbols appear.” “Another Bison free game may be triggered during a Bison free game.” “The amount of credit bet and the type of WAY in the Bison free game are the same as those in the game in which the Bison free game is triggered.”

(Details of Display Screen: Help Screen 4101: Help 4)

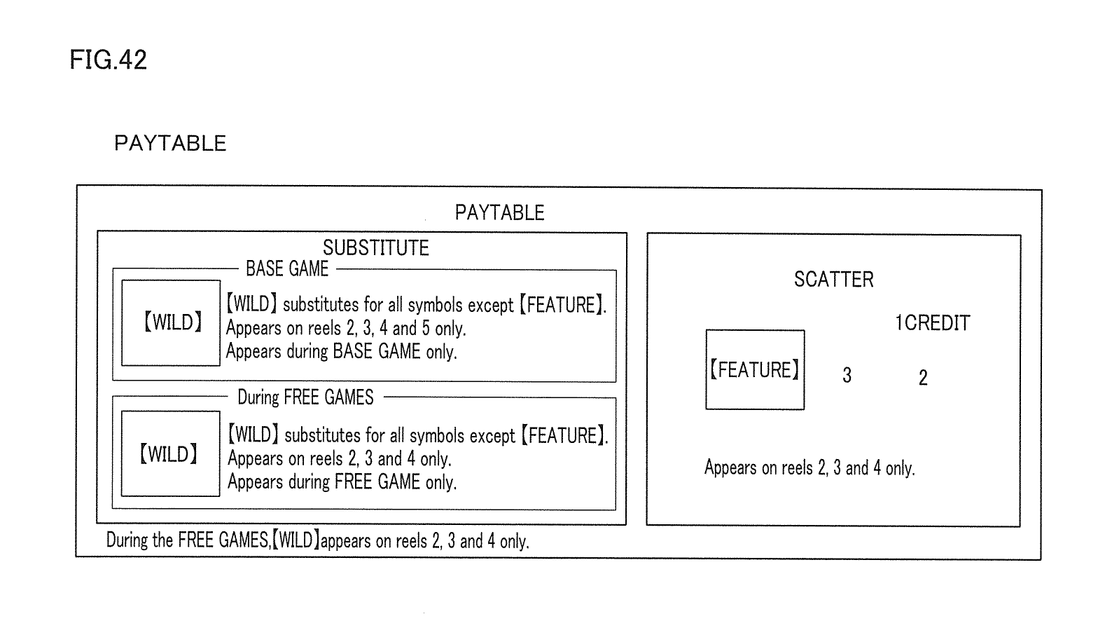

Help 4 explains the paytable as shown in FIG. 42. More specifically, the following contents are displayed. Explained is how [WILD] appears in the base game which is the normal game. That is, the [WILD] has a function of substituting for any symbols except the feature symbol. The [WILD] can appear on the second, third, fourth, and fifth reels. The [WILD] can appear only in the base game. Also explained is how [WILD] appears in a free game. That is, the [WILD] has a function of substituting for any symbols except the feature symbol. The [WILD] can appear on the second, third, and fourth reels. The [WILD] can appear only in a free game. As for scatter symbols, the feature symbol can appear on the second, third, and fourth reels only.

(Details of Display Screen: Help Screen 4101: Help 5)

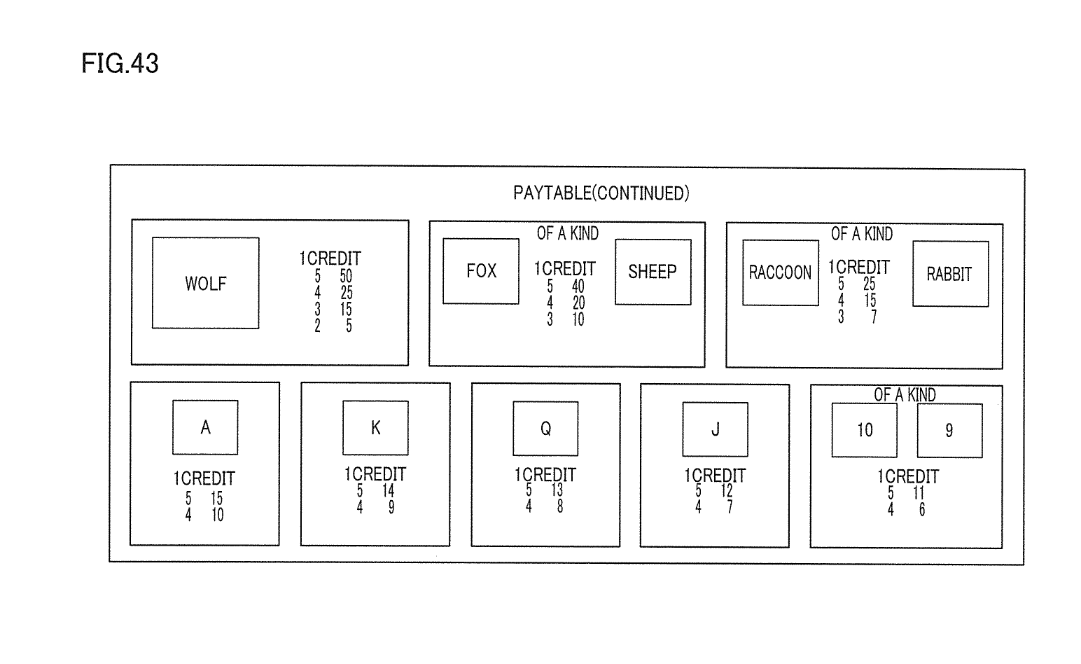

Help 5 explains the second page of the paytable shown in FIG. 43. In Help 5, “PLAY 40 TO 1000 CREDIT” and “ALL WINS PAID BY MACHINE OR ATTENDANT” are displayed.

(Various Operation Versions)

The slot machine 10 includes programs for executing operation versions such as a show mode and a debug mode. More specifically, the show version is used in international fairs and presentation for executives. In the show version, the appeal of a game is easily reproduced by a specific operation. In the show version, even if the game is played without selecting a command, a feature occurs at a high probability, with the result that players enjoy the feature even if they play the game for a short time in an international fair or the like. The show version automatically starts when power is turned on or when a presentation command is used.

When the game is played in the normal mode, the mode is unchanged until the change button is pressed. Each time the change button is pressed, the next presentation command appears. After the last presentation command, the first presentation command appears. In the free game, the free game is forcibly stopped when the change button is continuously pressed.

The following will describe command names in a demonstration mode and their respective brief descriptions. With “SHOW MODE”, three feature symbols appear with a probability of 1/20. With “NORMAL MODE”, the game is played with a normal probability. With “FREE GAME”, three feature symbols appear. With “FG RETRIGGER”, re-triggering occurs in the free game. With “FG BIG WIN”, a large payout is awarded in the free game. With “BG ALL SAME SYMBOL”, symbols of the same type appear in the base game. With “FG ALL SAME SYMBOL”, symbols of the same type appear in the free game. With “BG MAX SPIN BONUS”, the maximum payout is awarded in the normal game. With “FG MAX SPIN BONUS”, the maximum payout is awarded in the free game.

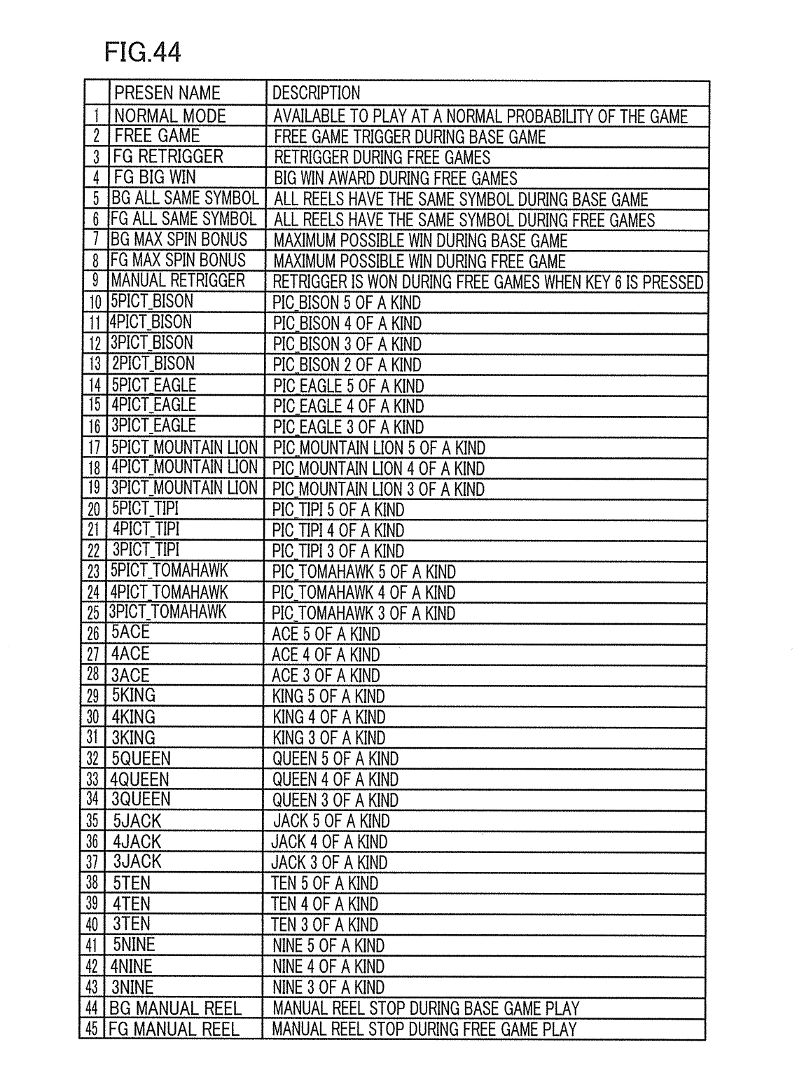

FIG. 44 illustrates command names in a presentation mode and their respective brief descriptions. For example, with “NORMAL MODE”, the game is played with a normal probability. With “FREE GAME”, the free game is triggered in the base game. With “FG RETRIGGER”, re-triggering occurs in a free game.

(Operations of Slot Machine 10: Normal Game Execution Process)

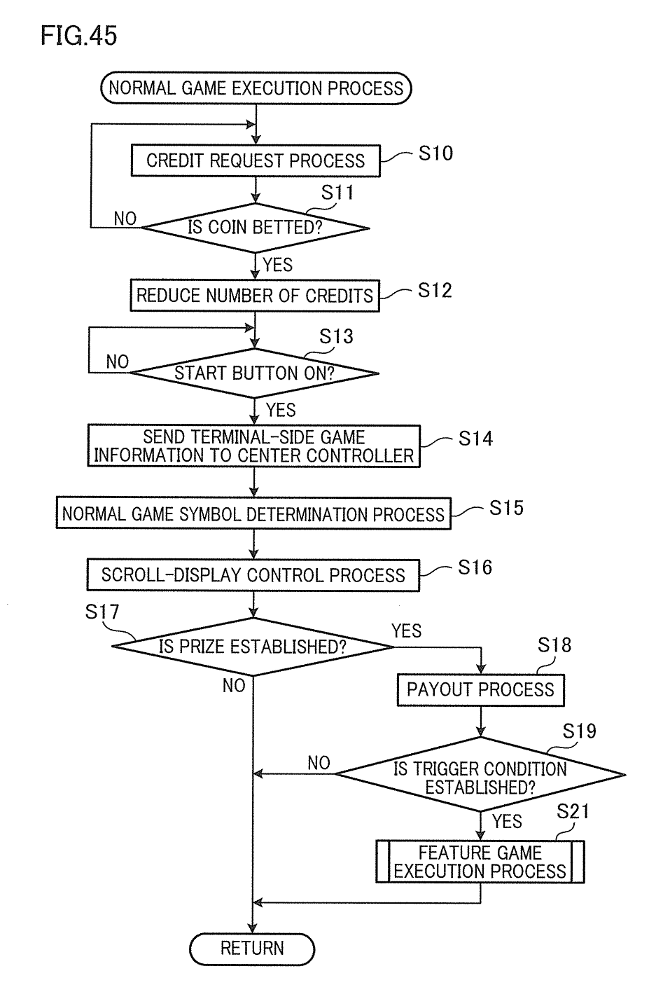

The operation of the slot machine 10 arranged as above will be described. The normal game execution process shown in FIG. 45 is executed by the main CPU 71 of the slot machine 10. The slot machine 10 has been activated in advance.

To begin with, the main CPU 71 executes a credit request process (S10). In this process, the player determines how many credits are used from the credits stored in the IC card.

Then whether a coin is bet is determined (S11). In this process, the main CPU 71 determines whether an input signal output from the 1-BET switch 34S when the 1-BET button 34 is pressed and an input signal output from the 10-BET switch 39S when the 10-BET button 39 is pressed are received. When it is determined that no coin is bet, the process goes back to S10.

In the meanwhile, if it is determined in S11 that a coin is bet, the main CPU 71 executes a process of decreasing the number of credits stored in the RAM 73 in accordance with the number of coins bet (S12). When the number of coins bet is larger than the number of credits stored in the RAM 73, the step of decreasing the number of credits stored in the RAM 73 is not carried out and the process goes back to S11. When the number of coins bet is larger than the maximum number bettable in one game (X in the present embodiment), the step of decreasing the number of credits stored in the RAM 73 is not carried out and the process proceeds to S13.

Then the main CPU 71 determines whether the spin button 46 is pressed (S13). In this step, the main CPU 71 determines whether an input signal output from the start switch 46S when the spin button 46 is pressed is received. When it is determined that the spin button 46 is not pressed, the process goes back to S13. It is noted that, when the spin button 46 is not pressed (e.g., when an instruction to end a game is input while the spin button 46 is not pressed), the main CPU 71 cancels the reduction result in S12.

In the meantime, if it is determined in S13 that the spin button 46 is pressed, the main CPU 71 sends terminal-side game information to the center controller 200 (S14), and then executes a normal game symbol determination process (S15). In the normal game symbol determination process, code numbers when the symbols are stopped are determined. More specifically, a random number is sampled, and the code number for each symbol array stopped in the display block 28 is determined based on the sampled random number and a normal game symbol table.

Thereafter, in S16, the main CPU 71 executes a scroll-display control process. In this process, display control is conducted so that, after the start of the scroll of the symbols, the symbols are rearranged as determined in S15.

Thereafter, the main CPU 71 determines whether a prize is established (S17). In S17, the main CPU 71 makes the determination on the symbols of each type rearranged in accordance with S16. Furthermore, whether a predetermined number or more of scatter symbols (trigger symbols 503a) are rearranged is determined.

When it is determined that a prize is not established in S17 (S17: NO), the routine ends. When it is determined that a prize is established (S17: YES), the main CPU 71 executes a step concerning the payout of coins (S18). In this step, for example, the main CPU 71 determines a payout rate with reference to odds data stored in the RAM 73 and based on the type of symbols rearranged.

Subsequently, whether a trigger condition is established as a result of the rearrangement of a predetermined number or more of scatter symbols (trigger symbols 503a) is determined (S19). When the trigger condition is not established (S19: NO), the routine ends. In the meantime, when the trigger condition is established (S19: YES), a feature game execution process is executed (S21).

(Operations of Slot Machine: Feature Game Execution Process)

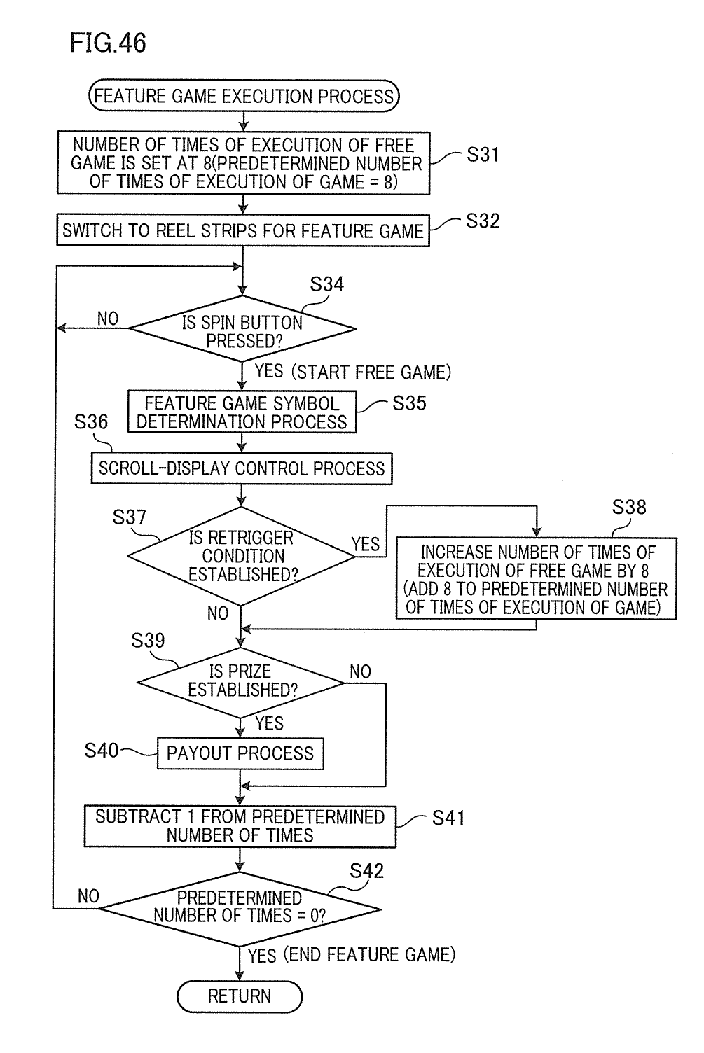

As shown in FIG. 46, to begin with, the number of times of execution of the free game is set at 8 in the feature game execution process. In other words, the predetermined number of times of execution of the game=8 is set (S31). The reel strips are switched to those for the feature game (S32). Subsequently, whether the spin button 46 is pressed to be turned on is determined (S34). When the spin button 46 is not pressed (S34: NO), S34 is executed again. In the meantime, when the spin button 46 is pressed (S34: YES), after a feature game symbol determination process is executed (S35), a scroll-display control process is executed (S36). Then, whether the re-trigger condition (free game addition condition) is established is determined (S37). When the re-trigger condition is not established (S37: NO), S39 is executed, subsequently.

In the meantime, when the re-trigger condition is established (S37: YES), 8 is added to the number of times of execution of the free game (S38). Thereafter, it is determined whether a prize is established (S39). When a prize is not established (S39: NO), S41 is executed. When a prize is established (S39: YES), a payout process is executed (S40), and then S41 is executed. The payout process is specifically described. Whether a prize is established as a result of rearrangement of the symbols is determined for each type of symbols. After the total payout amount is calculated by summing up payout amounts of all the prizes, the total payout amount is multiplied by a multiplying factor depending on the number of rearranged wild symbols, to obtain the amount of a special payout.

Thus, when the number of wild symbols rearranged is 1, for example, the total payout amount is multiplied by the multiplying factor of 2, and thereby the special payout is twice the total payout amount. When the number of wild symbols rearranged is 2, the total payout amount is multiplied by the multiplying factor of 4, and thereby the special payout is four times the total payout amount. When the number of wild symbols rearranged is 3, the total payout amount is multiplied by the multiplying factor of 8, and thereby the special payout is eight times the total payout amount. When the number of wild symbols rearranged is 0, no calculation related to the special payout is performed. That is, the amount to be paid out is the total payout amount. Then, the thus calculated special payout or the total payout amount will be paid out.

In S41, 1 is subtracted from the predetermined number of times of execution of the game (S41). Then whether the predetermined number of times of execution of the game is 0 is determined (S42). When the predetermined number of times of execution of the game is not 0 (S42: NO), it is determined that the feature game is being executed, and the process is executed again from S34. On the other hand, when the predetermined number of times of execution of the game is 0 (S42: YES), it is determined that the feature game is finished, and the routine ends.

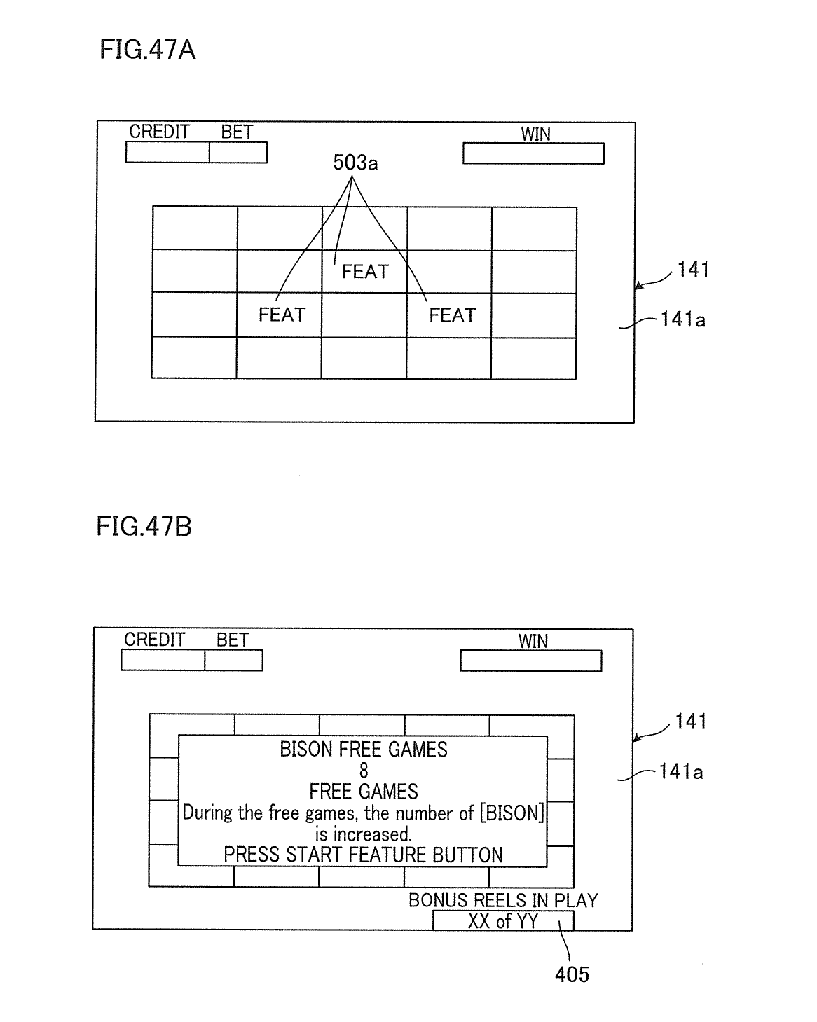

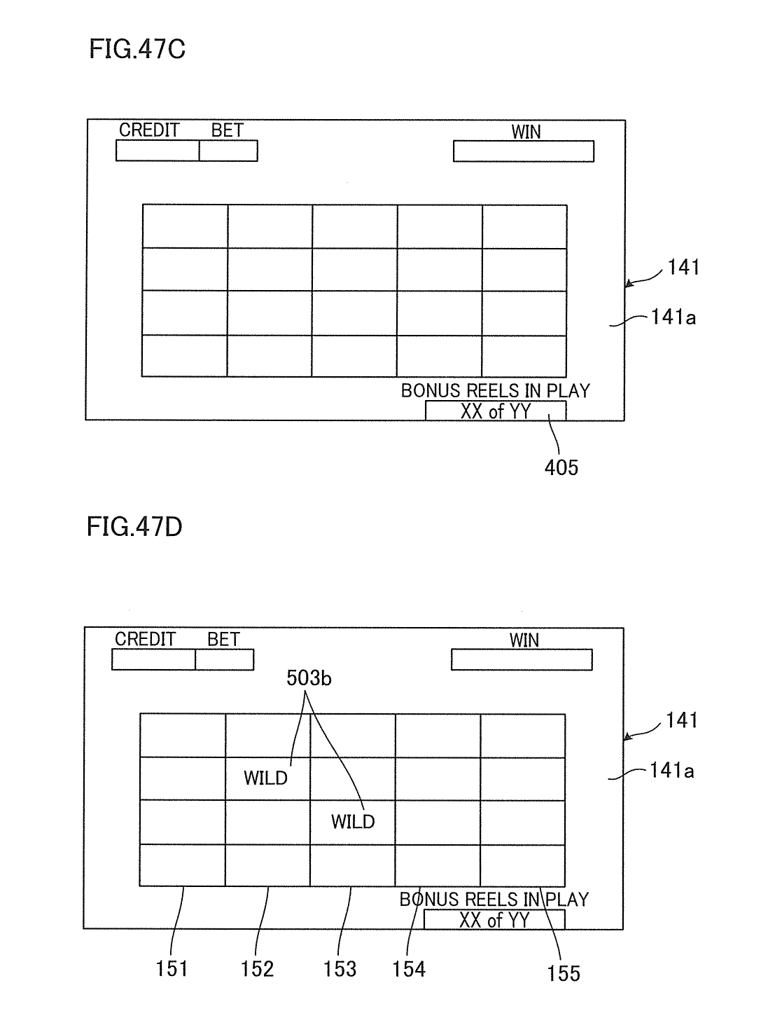

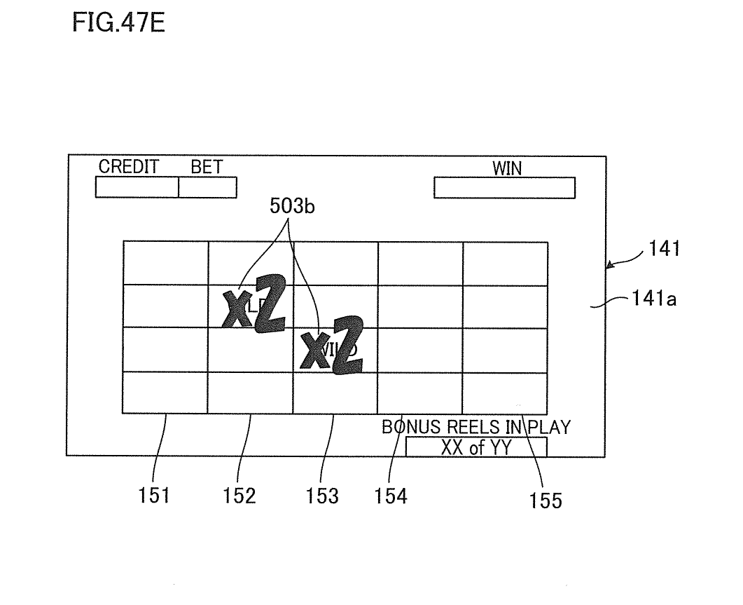

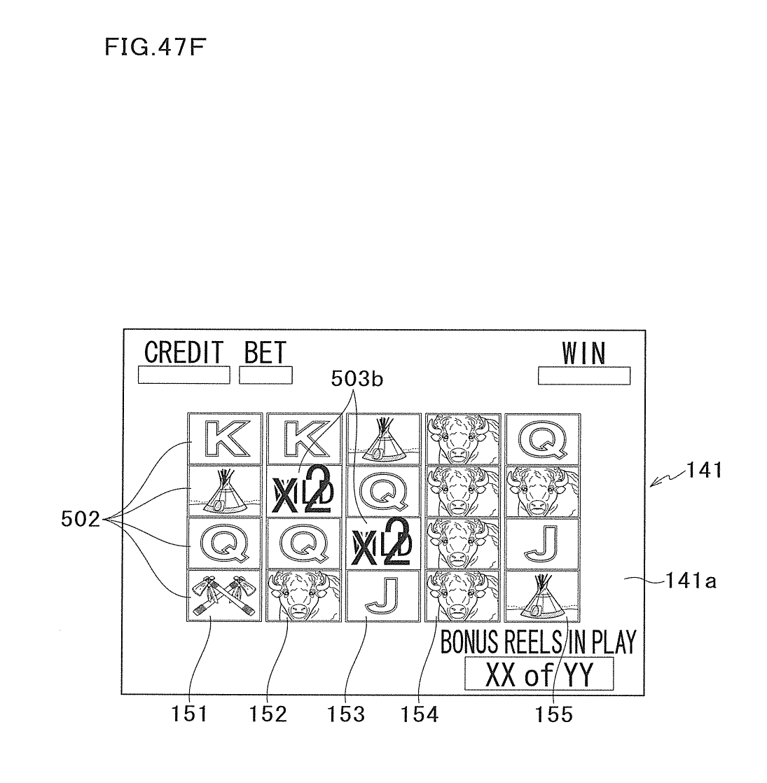

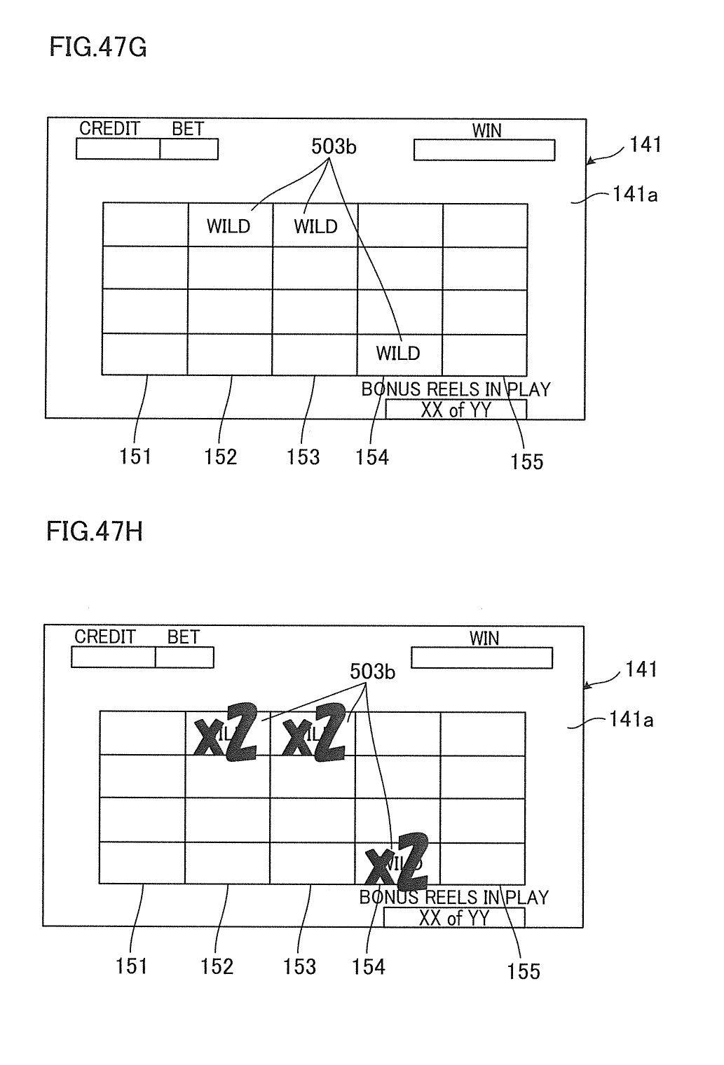

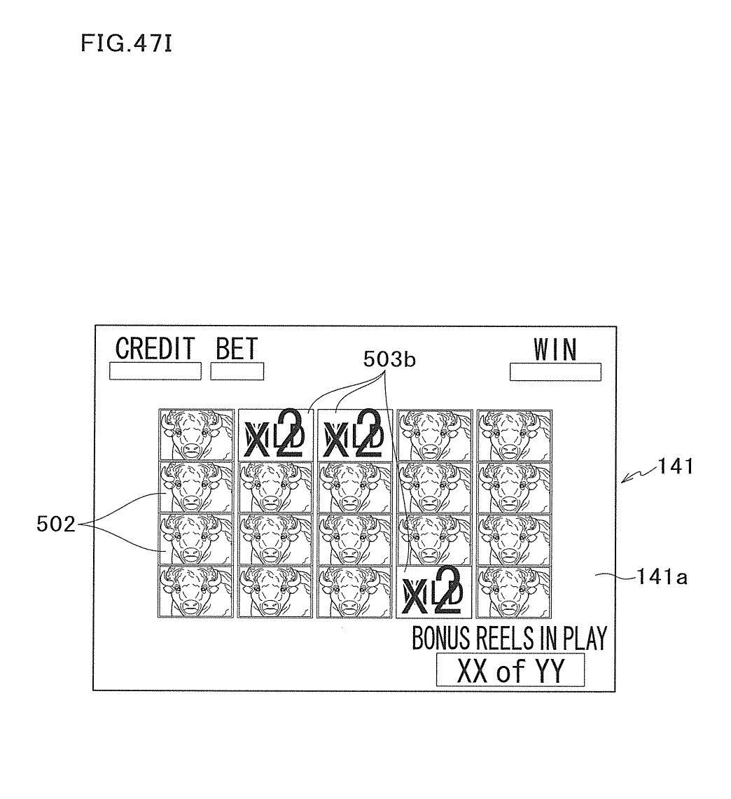

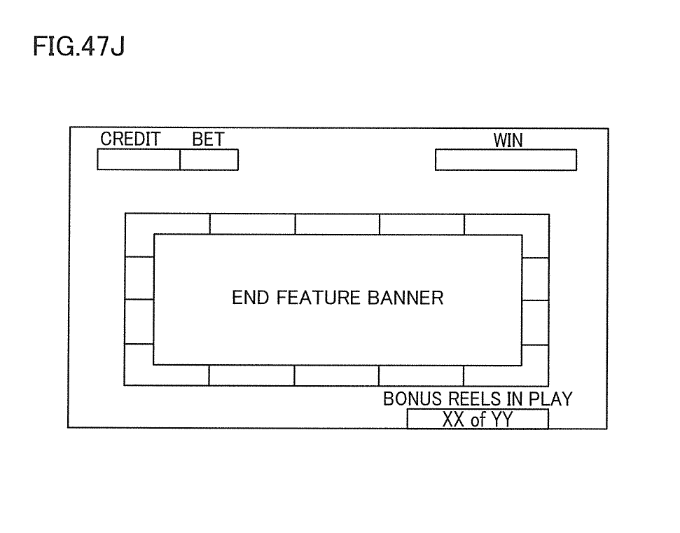

At the timings when the feature game starts and ends, images indicating the start and end of the feature game are respectively displayed on the lower image display panel 141. That is, when three feature symbols (trigger symbols 503a) are rearranged as shown in FIG. 47A, the trigger condition is established, and the contents of the feature game are displayed on the screen, as shown in FIG. 47B. To be more specific, the title of the feature game “BISON FREE GAMES” is displayed, and the number of times of execution of the free game of 8 is displayed. Then, displayed is an instruction to press the feature button to start the feature game. In addition, below the contents of the feature game, there is displayed a free game counter indicating the total number of times of execution of the free game (YY) and the ordinal number of the current free game (XX). Then, after the contents of the feature game disappears, the free game in the feature game is repeatedly executed, as shown in FIG. 47C. At the timing when the free game starts, the ordinal number of the current free game (XX) is magnified for emphasis, thereby to cause the player to be easily aware of the ordinal number of the free game which is going to be started.

When two wild symbols 503b are rearranged on the second reel 152 and the third reel 153 during the free game in the feature game as shown in FIG. 47D, “×2” is displayed over each of the wild symbols 503b, as shown in FIG. 47E. Thus, “×2” is displayed at each of two positions, and this enables the player to be conscious of the fact that the special payout calculated by multiplying the payout for an established prize by 4 will be paid out. Note that the display of “×2” is performed after a predetermined time elapses from the reel stop. Thus, “×2” is displayed over the wild symbol 503b on the second reel 152 after the predetermined time elapses from the stop of the second reel 152, and thereafter, “×2” is displayed over the wild symbol 503b on the third reel 153 after the predetermined time elapses from the stop of the third reel 153.

For example, assuming that the symbols are rearranged as shown in FIG. 47F, the player recognizes that any of the rearranged symbols of “KING”, “TIPI”, “QUEEN”, and “TOMAHAWK” may cause a prize when the first reel 151 stops since whether the prize is established is determined in accordance with “left to right”. Subsequently, when the second reel 152 stops to rearrange the symbols “KING”, “WILD”, “QUEEN”, and “BISON”, the player recognizes that any of the symbols 502 on the first reel 151 may cause a prize due to the substituting function of “WILD”, and that the symbols 502 of the same type may cause a prize. In addition, “×2” is displayed over “WILD”, which enables the player to recognize that the special payout may be paid out, i.e., the payout may be doubled.

Subsequently, when the third reel 153 stops to rearrange the symbols “TIPI”, “QUEEN”, “WILD”, and “JACK”, the player recognizes that the prize of each of “KING”, “TIPI”, “QUEEN”, and “TOMAHAWK” which are rearranged on the first reel 151 is established due to the presence of “WILD”, and that the prize of “QUEEN” is established by the symbols of the same type. Further, “×2” is displayed over “WILD”, which enables the player to recognize that the payout is multiplied by 4.

Thereafter, the fourth reel 154 and the fifth reel 155 sequentially stop, and then the symbols 502 which cause the prizes are emphasized by changing from still images to moving images. This enables the player to easily recognize which of the symbols 502 cause the prizes.

Further, when three wild symbols 503b are respectively rearranged on the second reel 152, the third reel 153, and the fourth reel 154 during the free game in the feature game as shown in FIG. 47G, “×2” is displayed over each of the wild symbols 503b, as shown in FIG. 47H. Thus, “×2” is displayed at each of three positions, and this enables the player to be conscious of the fact that the special payout calculated by multiplying the payout for an established prize by 8 will be paid out.

There can be a case, for example as shown in FIG. 47I, where a plurality of symbols of “BISON” are stacked in a variable display direction, which corresponds to the rotational direction of the reels, and adjacent to some stacks of “BISON”, “WILD” symbols are rearranged upstream or downstream thereof in the rotational direction (variable display direction). That is, the rearranged symbols are constituted by the three “WILD” symbols and “BISON” symbols only. In this case, 1024 patterns of prizes are established by “BISON”, and to be paid out is the special payout calculated by multiplying the total payout amount of these prizes by 8, because of “WILD”s.

When the feature game ends as described above, the end screen shown in FIG. 47J appears, and then shifting to the normal game is performed.

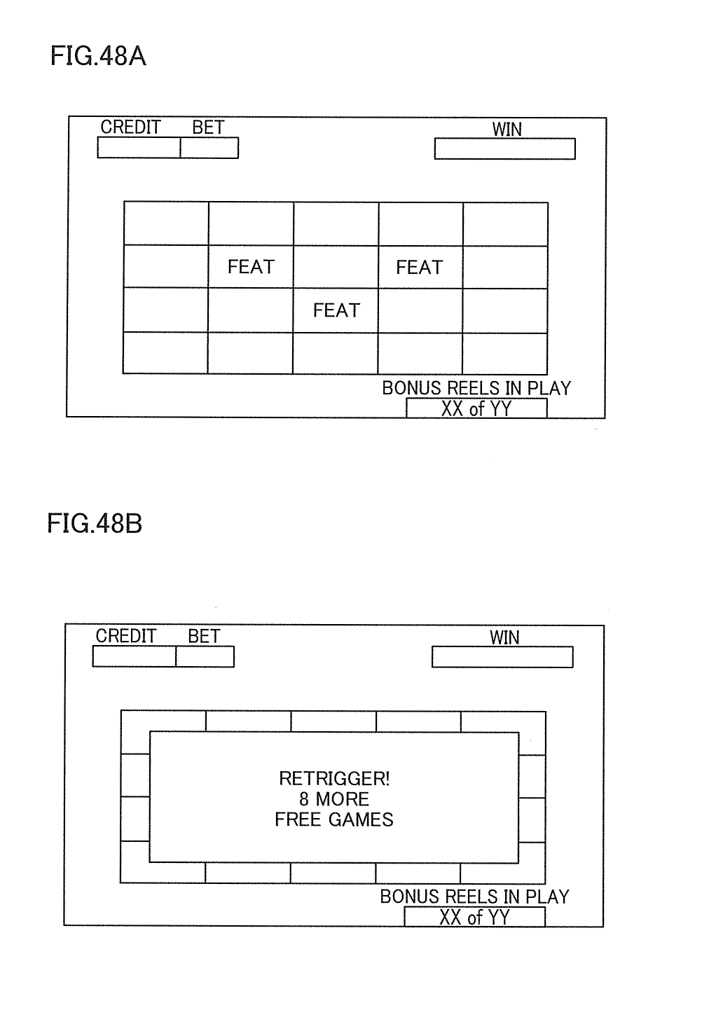

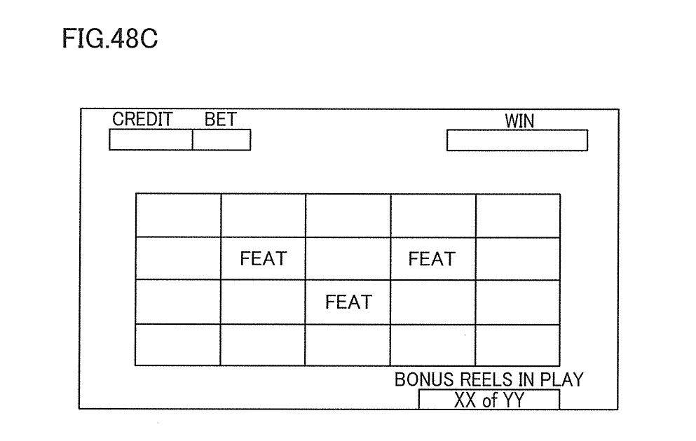

When re-triggering occurs in the feature game, the lower image display panel 141 displays thereon an image indicating the re-triggering. That is, when three feature symbols (trigger symbols) are rearranged as shown in FIG. 48A, the trigger condition is established, and re-triggering notification reporting that 8 is added to the number of times of execution of the free game due to re-triggering is displayed on the screen, as shown in FIG. 48B. Then, after the re-triggering notification disappears, the free game in the feature game is executed, as shown in FIG. 48C.

(Operations of Slot Machine: Outline of WIN Effect)

Now, WIN effect executed during the game as above will be described. The WIN effect is an effect executed when WIN is achieved in the normal game or the free game. The animation of a character on the 2nd screen 131a of the upper image display panel 131 and the animation on the upper part of each reel on the 1st screen 141a of the lower image display panel 141 are not carried out. Only the symbol animation, WIN increment, and the display of a WIN signboard on the 2nd screen 131a are carried out.

(Operations of Slot Machine: WIN Effect: 2nd Screen 131a and WIN Signboard) (where Top Symbol (BISON) is not Related to WIN)

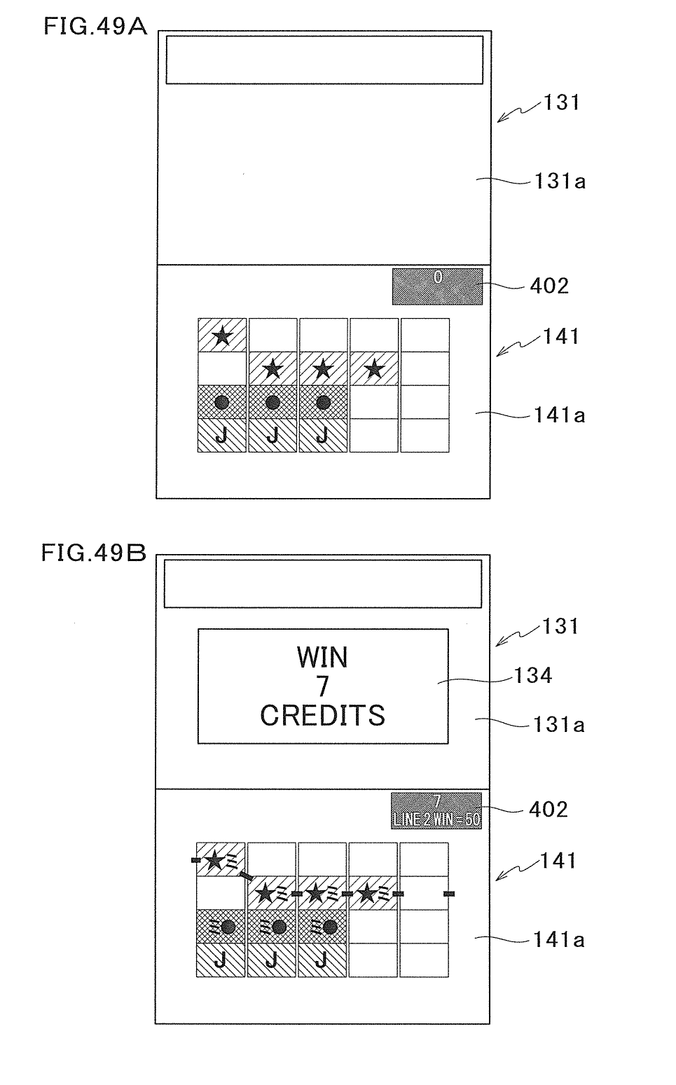

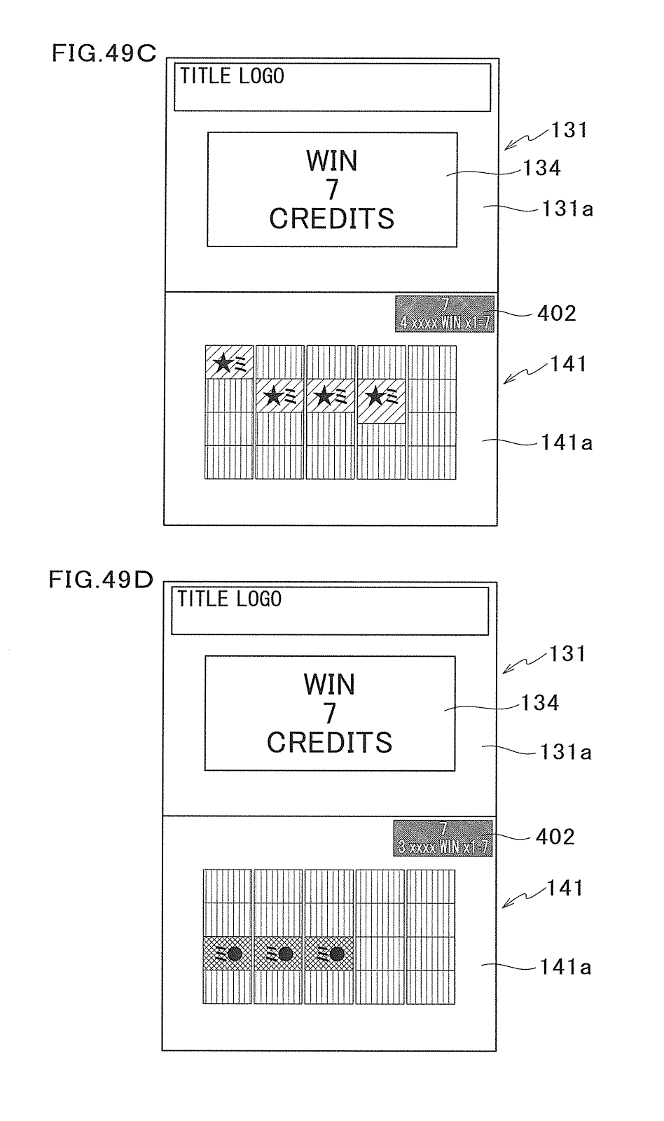

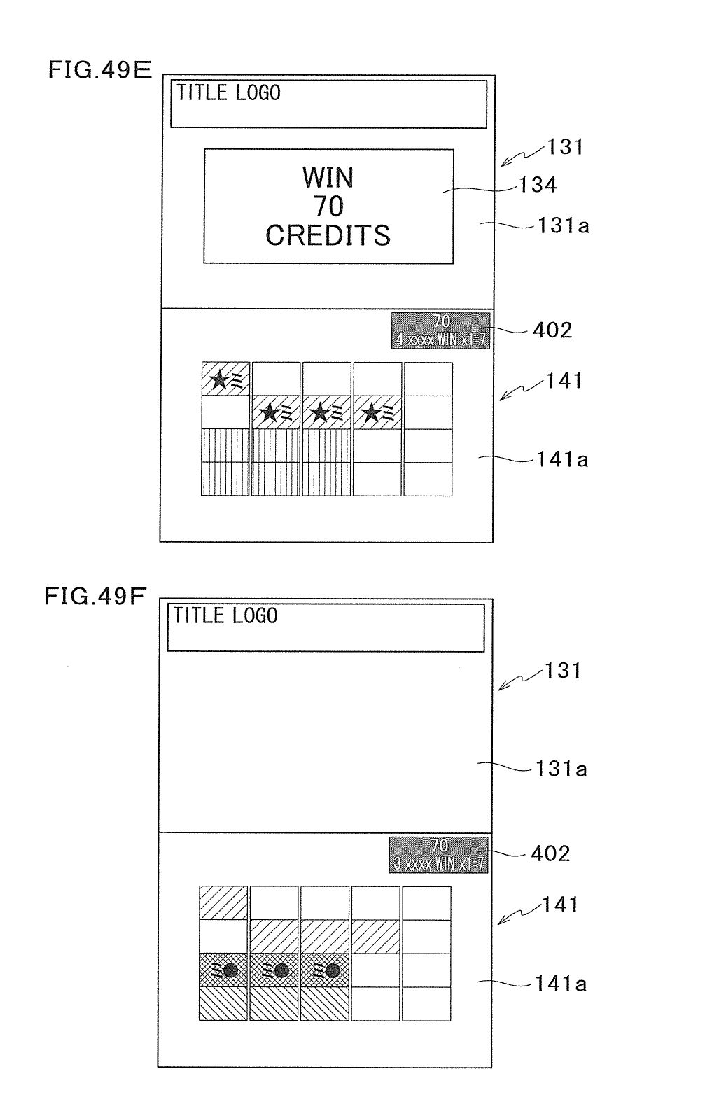

When all the reels stop on the 1st screen 141a as shown in FIG. 49A, the obtained number of credits is displayed in an increment manner in a WIN signboard 134 on the 2nd screen 131a, as shown in FIG. 49B. The WIN signboard 134 is linked to the WIN meter 402 on the 1st screen 141a. Animation display is performed on the 1st screen 141a. The symbols which do not cause any WIN are darkened to be less noticeable. After the display of 1 second, the display is shifted to WIN information for each symbol. The WIN meter 402 starts the increment and displays the payout of the symbols currently turned on. The TOTAL WIN is not displayed.

Thereafter, as shown in FIG. 49C, on the 2nd screen 131a, the obtained number of credits is displayed on the WIN signboard 134 in an increment manner. This display is linked to the WIN meter 402 on the 1st screen 141a. Further, on the 1st screen 141a, WINs are displayed, in order, from the highest lank of symbols. The symbols are animated. The symbols which cause any win but are not currently emphasized are colored light gray. The positions which are not related to the payout are darkened to be less noticeable. After the display of 1 second, the display is shifted to next WIN information. The WIN meter 402 starts the increment and displays the payout of the symbols currently turned on. The TOTAL WIN is not displayed.

Then, as shown in FIG. 49D, the color of the last emphasized win-causing symbols is changed to light gray on the 1st screen 141a while the display on the 2nd screen 131a is maintained. The light gray color of the next symbols is removed and WIN of these symbols is displayed. After the display of 1 second, the display is shifted to the next WIN information.

Thereafter, as shown in FIG. 49E, the increment is finished on the 2nd screen 131a, and the total WIN amount is displayed. On the 1st screen 141a, when the sequential display of the winning symbols is finished once, the display is carried out again from the set of symbols which were turned on first. The WIN meter 402 stops the increment, and after the sequential display of the winning symbols is finished once, repeatedly conducts the display from the symbols of the highest lank. TOTAL WIN is displayed after the increment is finished.

In the state of Gamble ON, the screen shown in FIG. 49F appears after Gamble ends or after TAKE WIN. In the state of Gamble OFF, the screen shown in FIG. 49F appears 5 seconds after the completion of the increment. That is to say, as shown in FIG. 49F, the WIN signboard 134 disappears from the 2nd screen 131a. On the 1st screen 141a, when the sequential display of the winning symbols is finished once, the display is carried out again from the symbols of the highest lank. The WIN meter 402 stops the increment, and after the sequential display of the winning symbols is finished once, repeatedly conducts the display from the symbols of the highest lank. TOTAL WIN is displayed after the increment is finished.

(Where Top Symbol (BISON) is Related to WIN)

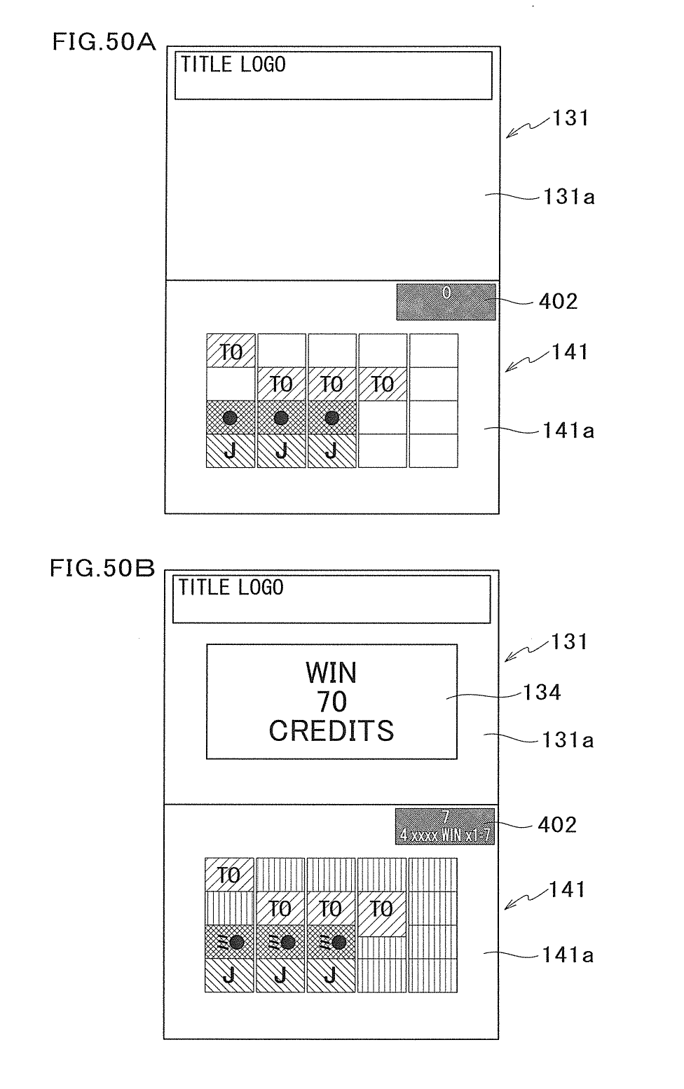

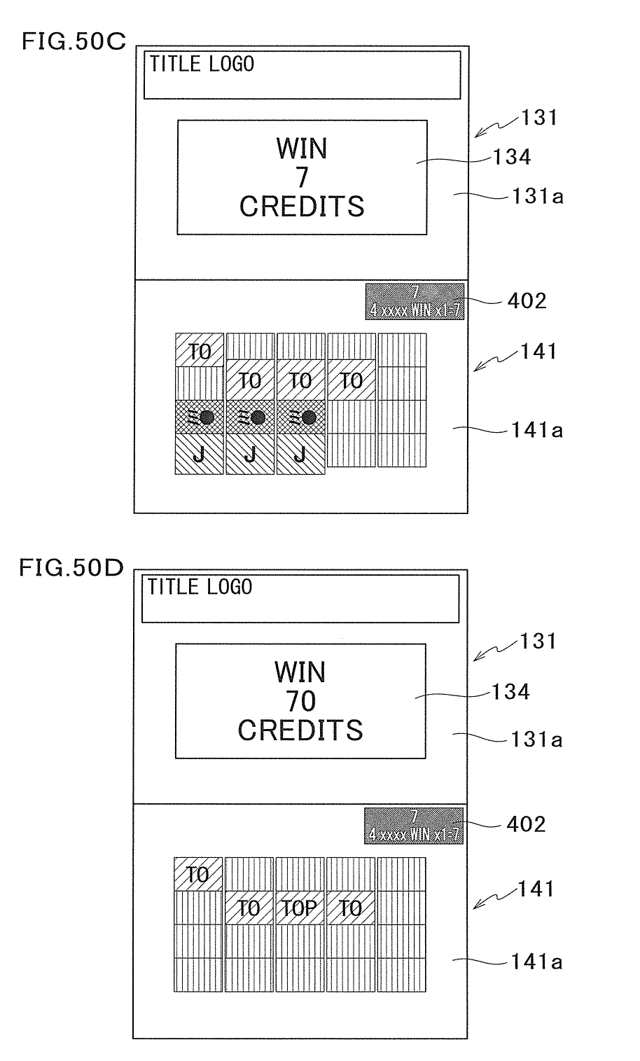

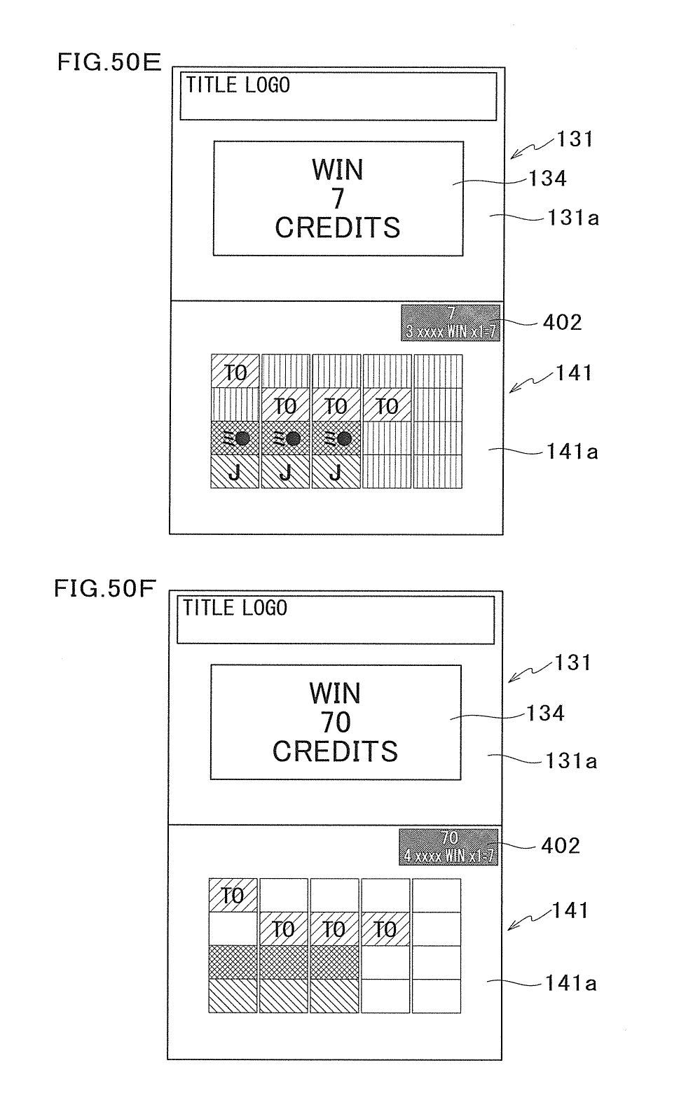

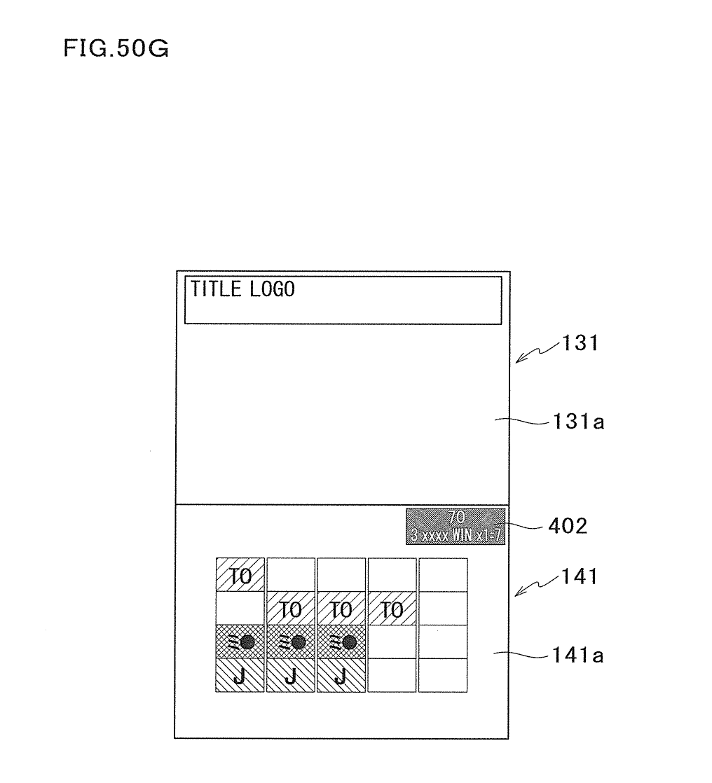

When all the reels stop on the 1st screen 141a as shown in FIG. 50A, the obtained number of credits is displayed in an increment manner in the WIN signboard 134 on the 2nd screen 131a, as shown in FIG. 50B. The WIN signboard 134 is linked to the WIN meter 402 on the 1st screen 141a. When the top symbol is related to WIN, sequential symbol animation is carried out once only for the top symbol. At the same time, a sound effect for the top symbols is also reproduced. Symbol animations for the symbols other than the top symbol is not performed. If there are two kinds of top symbols, executed is the process similar to that in the case where the top symbol is not related to WIN. The WIN meter 402 starts the increment and displays the payout of the symbols currently turned on. The TOTAL WIN is not displayed. Symbol animation in a section A is not performed until the sequential symbol animation for the top symbol is performed once.

Thereafter, as shown in FIG. 50C, on the 2nd screen 131a, the obtained number of credits is displayed on the WIN signboard 134 in an increment manner. This display is linked to the WIN meter 402 on the 1st screen 141a. Further, after the sequential symbol animation of the top symbol with the sound effect are performed once on the 1st screen 141a, all the symbols which cause WINs are animated. The symbols which do not cause any WIN are darkened to be less noticeable. After the display of 1 second, the display is shifted to WIN information for each symbol.

Then, as shown in FIG. 50D, on the 2nd screen 131a, the obtained number of credits is displayed on the WIN signboard 134 in an increment manner. This display is linked to the WIN meter 402 on the 1st screen 141a. On the 1st screen 141a, WINs are displayed, in order, from the highest lank of symbols. The symbols are animated. The symbols which cause any WIN but are not currently emphasized are colored light gray. The positions which are not related to the payout are darkened to be less noticeable. After the display of 1 second, the display is shifted to the next WIN information.

Thereafter, as shown in FIG. 50E, the display state on the 2nd screen 131a is maintained. The color of the last emphasized win-causing symbols is changed to light gray on the 1st screen 141a. The light gray color of the next symbols is removed and WIN of these symbols is displayed. After the display of 1 second, the display is shifted to the next WIN information.

Thereafter, as shown in FIG. 50F, after the increment is finished, the total WIN amount is displayed on the 2nd screen 131a. On the 1st screen 141a, when the sequential display of the winning symbols is finished once, the display is carried out again from the set of symbols which were turned on first. The WIN meter 402 stops the increment, and after the sequential display of the winning symbols is finished once, repeatedly conducts the display from the symbols of the highest lank. TOTAL WIN is displayed after the increment is finished.

In the state of Gamble ON, the screen shown in FIG. 50G appears after Gamble ends or after TAKE WIN. In the state of Gamble OFF, the screen shown in FIG. 50G appears 5 seconds after the completion of the increment. That is to say, as shown in FIG. 50G, the WIN signboard 134 disappears from the 2nd screen 131a. On the 1st screen 141a, when the sequential display of the winning symbols is finished once, the display is carried out again from the symbols of the highest lank. The WIN meter 402 stops the increment, and after the sequential display of the winning symbols is finished once, repeatedly conducts the display from the symbols of the highest lank. TOTAL WIN is displayed after the increment is finished.

(Where Appearing Symbols are Only of One Kind)

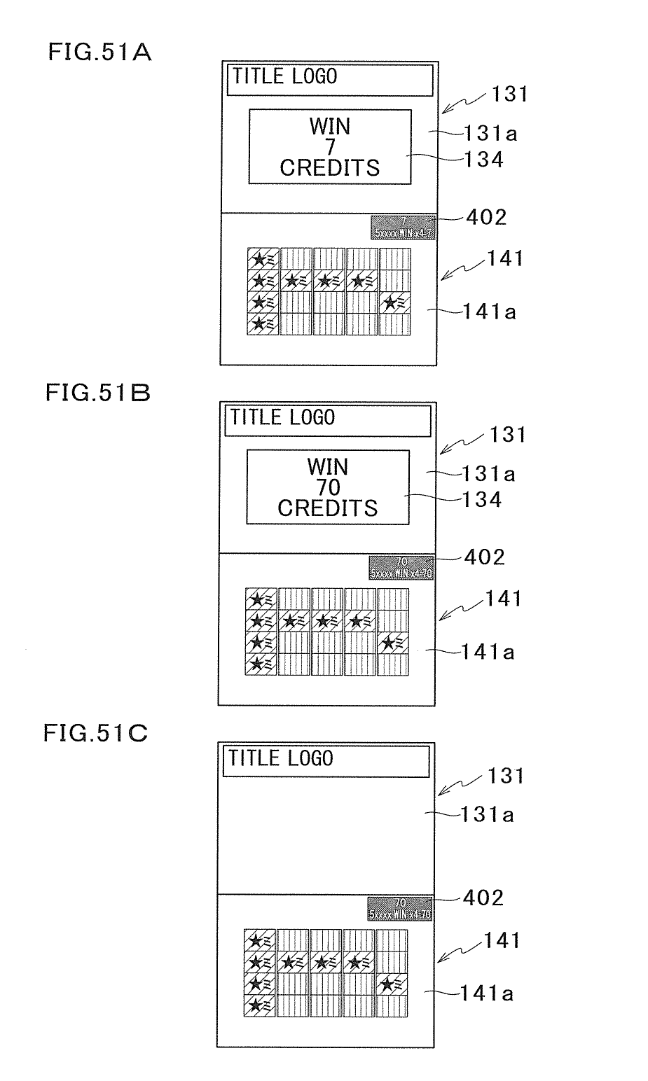

When only one kind of symbols successively appear, as shown in FIG. 51A, symbol animation is performed for all of the symbols. The positions which are not related to the payout are darkened to be less noticeable. The WIN meter 402 starts the increment and displays the payout of the symbols. TOTAL WIN is not displayed.

As shown in FIG. 51B, when the increment in the WIN signboard 134 is finished on the 2nd screen 131a, TOTAL WIN amount is displayed. Further, symbol animation for all the symbols is performed on the 1st screen 141a. The WIN meter 402 stops the increment, and always displays the payout for the symbols. TOTAL WIN is displayed after the increment is finished.

In the state of Gamble ON, the screen shown in FIG. 51C appears after Gamble ends or after TAKE WIN. In the state of Gamble OFF, the screen shown in FIG. 51C appears 5 seconds after the completion of the increment. That is to say, as shown in FIG. 51C, the WIN signboard 134 disappears from the 2nd screen 131a. Further, symbol animation for all the symbols is performed on the 1st screen 141a. The WIN meter 402 stops the increment, and always displays the payout for the symbols. The WIN meter 402 further displays TOTAL WIN for the current spinning.

(WINNER Text on 1st Screen)

There are three kinds of WINNER text on the 1st screen 141a. The WINNER text appears after a loop of symbol animation is completed. The symbol animation is performed repeatedly. During the symbol animation, a common jingle sound is made for picture symbols other than “BISON”. The WINNER text appears, for example, in the following manner: “BIG WINNER” is displayed when the WIN amount range (based on TOTAL BET) is 25 times or more.

(WINNER Text on 1st Screen: Flow of Signboard Display)

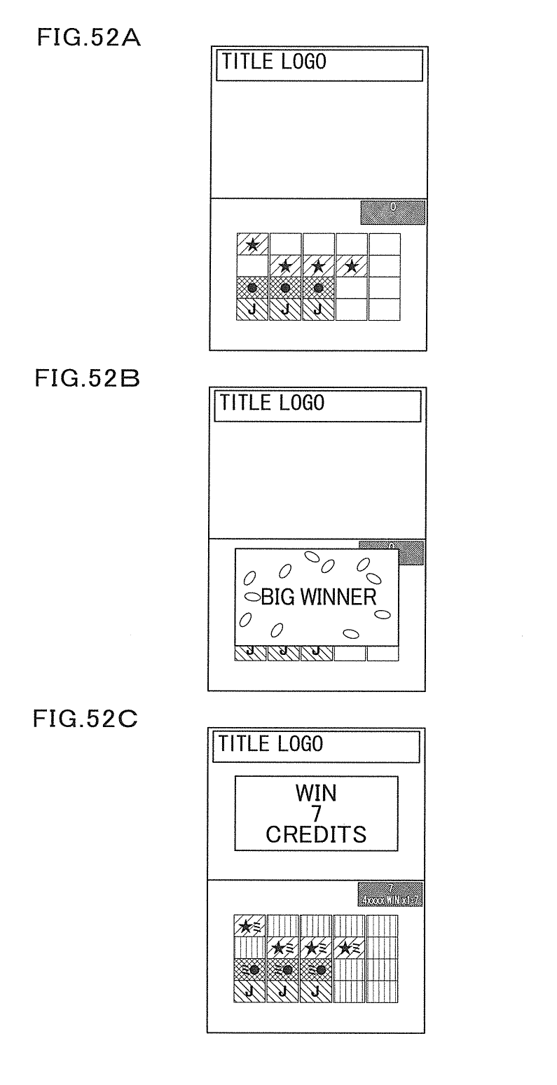

When the top symbol is related to WIN as shown in FIG. 52A, sequential symbol animation for the top symbol is carried out once, and an exclusive sound effect (SE) is made. All the symbols related to WIN are animated. When “BIG WINNER” appears for the symbols other than the top symbol, a common sound effect is made, and all the symbols related to WIN are animated.

Then, as shown in FIG. 52B, “BIG WINNER” is displayed after the sequential symbol animation is carried out once. During “BIG WINNER”, the overall reels are made less noticeable. The symbol animation is kept.

Then, as shown in FIG. 52C, on the 2nd screen 131a, the obtained number of credits is displayed on the WIN signboard 134 in an increment manner. This display is linked to the WIN meter 402 on the 1st screen 141a. Further, all the symbols causing any WIN are animated on the 2nd screen 131a. The symbols which do not cause any WIN are darkened to be less noticeable. After the display of 1 second, the display is shifted to WIN information for each symbol. The WIN meter 402 starts the increment and displays the payout of the symbols currently turned on. The TOTAL WIN is not displayed thereon.

(Operations of Slot Machine: WIN Effect: Types of WIN Signboards)

There are three types of WIN signboards 134 in total. That is to say, “Silver Signboard”, “Gold Signboard 1”, and “Gold Signboard 2”. Silver Signboard is displayed when the TOTAL WIN in the spinning is less than 15 times as large as the bet. BIG WIN in “Gold Signboard 1” is displayed when the TOTAL WIN in the spinning is not less than 15 times and less than 50 times as large as the bet. Coins fall down. Gold Signboard 1 is changed to “GREAT” of “Gold Signboard 2” when the increment amount becomes more than 50 times as large as the bet. Coins and bills fall down. When the WIN amount range (TOTAL BET standard) is less than 15 times, the effect of Silver Signboard is carried out. When the WIN amount range is not smaller than 15 times and smaller than 50 times, the effect of Gold Signboard+Coins is carried out. When the WIN amount range is not smaller than 50 times the effect of Gold signboard+Coins+Bills is carried out.

(Operations of Slot Machine: WIN Effect: Display of WIN Signboard)

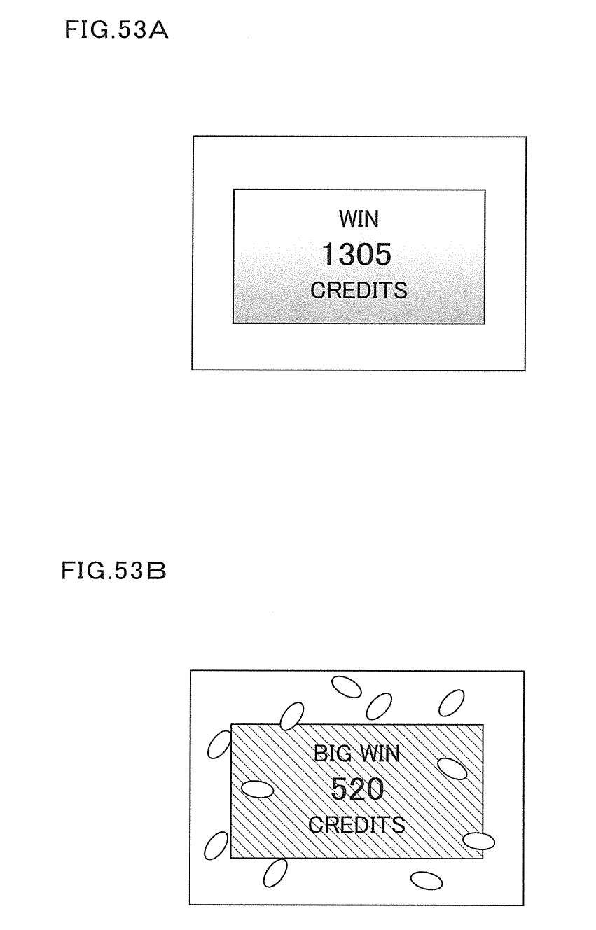

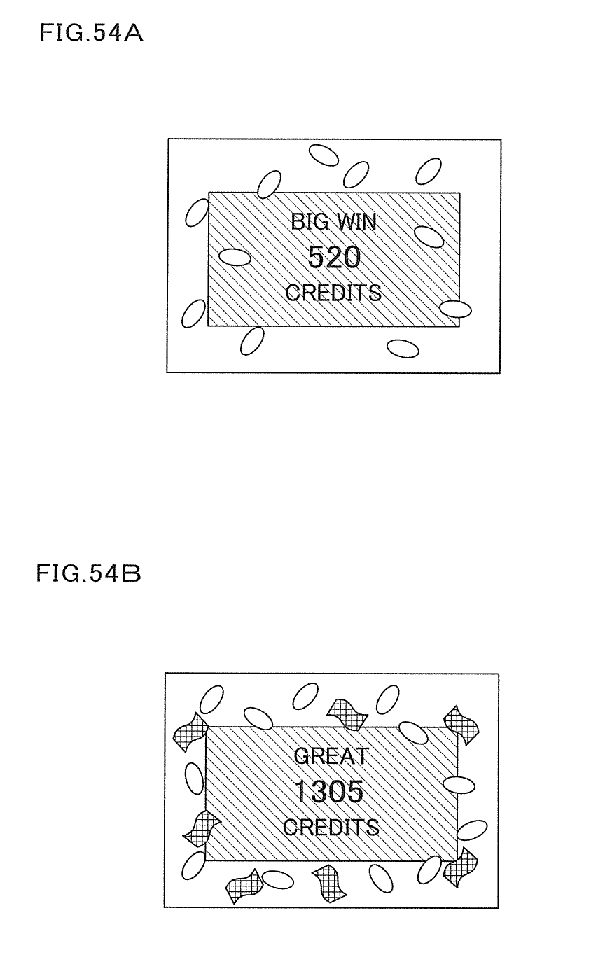

The display of the Gold Signboard 1 or the Silver Signboard is carried out such that, as shown in FIG. 53A, after only the Silver Signboard is displayed, the Gold Signboard 1 and the coins are displayed as shown in FIG. 53B. The display of the Gold Signboard 2 is, as shown in FIG. 54A, carried out such that, the Gold Signboard 1 and the coins are displayed first, and the obtained number of credits is displayed in an increment manner in accordance with the increment on the WIN meter 402. Thereafter, as shown in FIG. 54B, the WIN signboard 134 is rewritten to the Gold Signboard 2 when the increment amount exceeds 50 times as large as the bet, and the coins and bills start to fall down.

(Operations of Slot Machine: WIN Effect: Increment Speed and WIN Sound)

The increment speed and WIN sound are arranged such that, 24 ranks of WIN are identified, and the increment speed and the WIN sound are set for each rank.

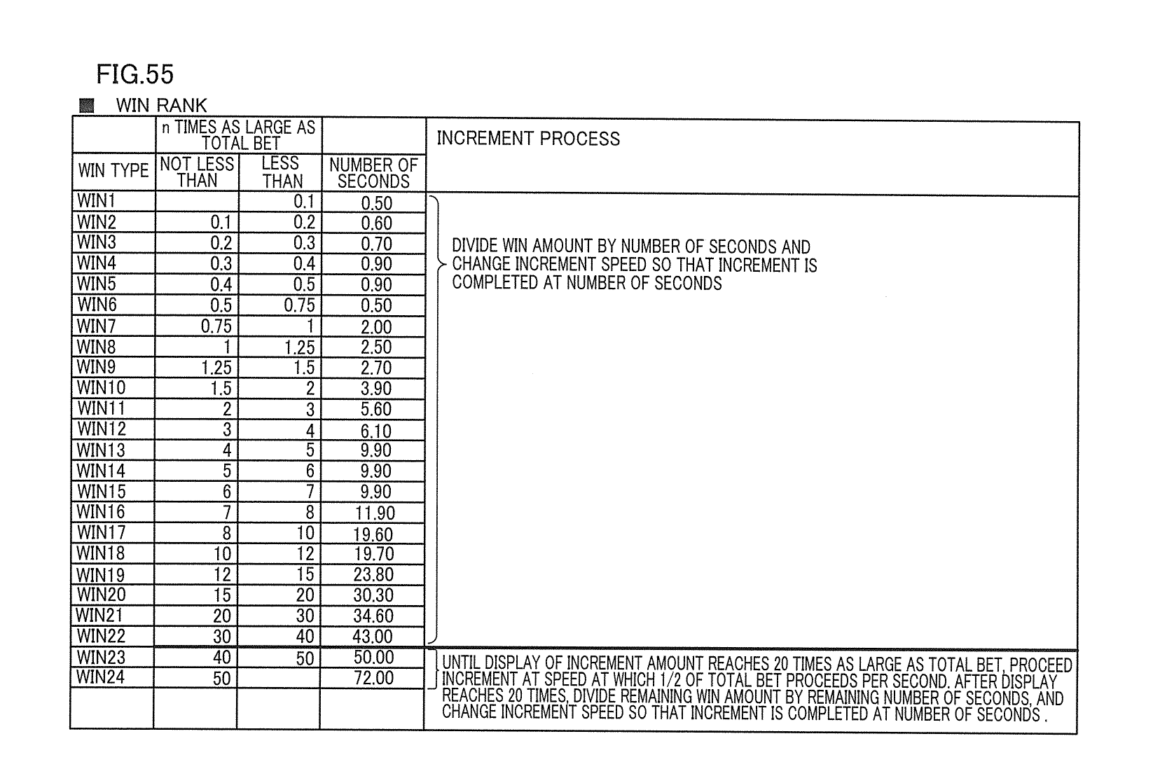

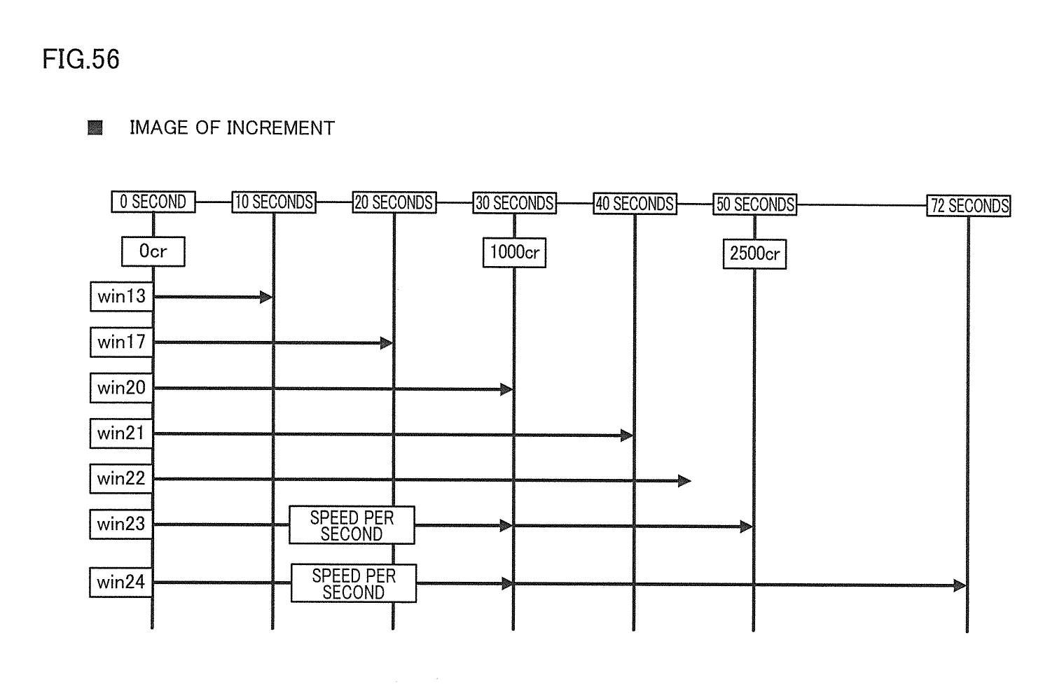

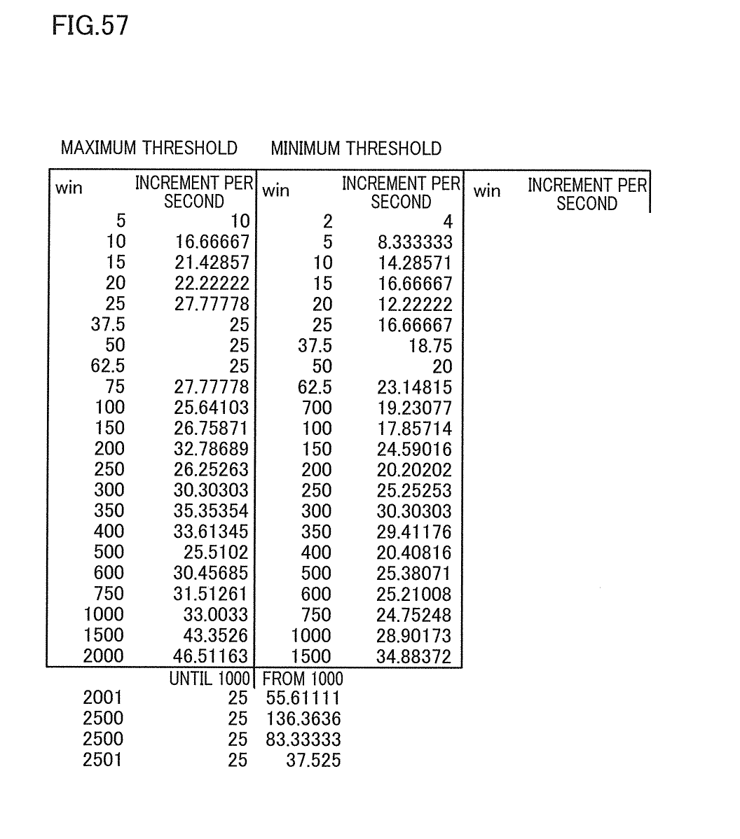

More specifically, as shown in FIG. 55, a WIN rank is a relationship between a WIN type and an increment process. In “WIN 1” to “WIN 22”, a WIN amount is divided by the number of seconds, and the increment speed is adjusted so that the increment is completed at that number of seconds. In “WIN 23” to “WIN 24”, the increment proceeds at a speed at which ½ of the total bet proceeds per second, until the display of the increment amount reaches 20 times as large as the total bet. After 20 times the total bet, the remaining WIN amount is divided by the remaining number of seconds, and the increment speed is adjusted so that the increment is completed at that number of seconds. Therefore, the increment is executed as shown in FIG. 56, for example. That is to say, the increment shown in FIG. 57 is executed.

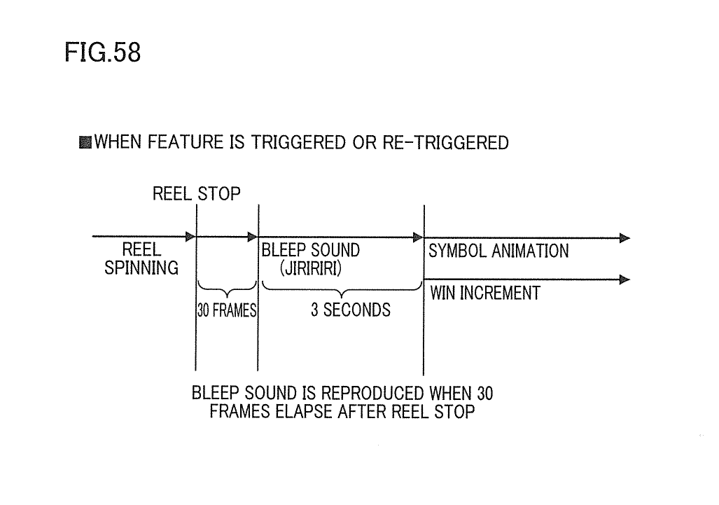

(Operations of slot machine: WIN effect: Sound effect when 3 feature symbols appear) When three feature symbols appear, “bleep sound (Jiririri)” is reproduced as a sound effect. As shown in FIG. 58, the reproduction of the sound is continued for 3 seconds after the time for 20 frames elapses from the stop of all the reels and before the increment starts. While the “bleep sound (Jiririri)” is reproduced, the symbol animation and the Symbol WIN are displayed. The increment is stopped. The same is applied when re-triggering occurs during the free game. If re-triggering has already occurred in that free game, the 30 frame waiting and reproduction of the “bleep sound (Jiririri)” are not performed.

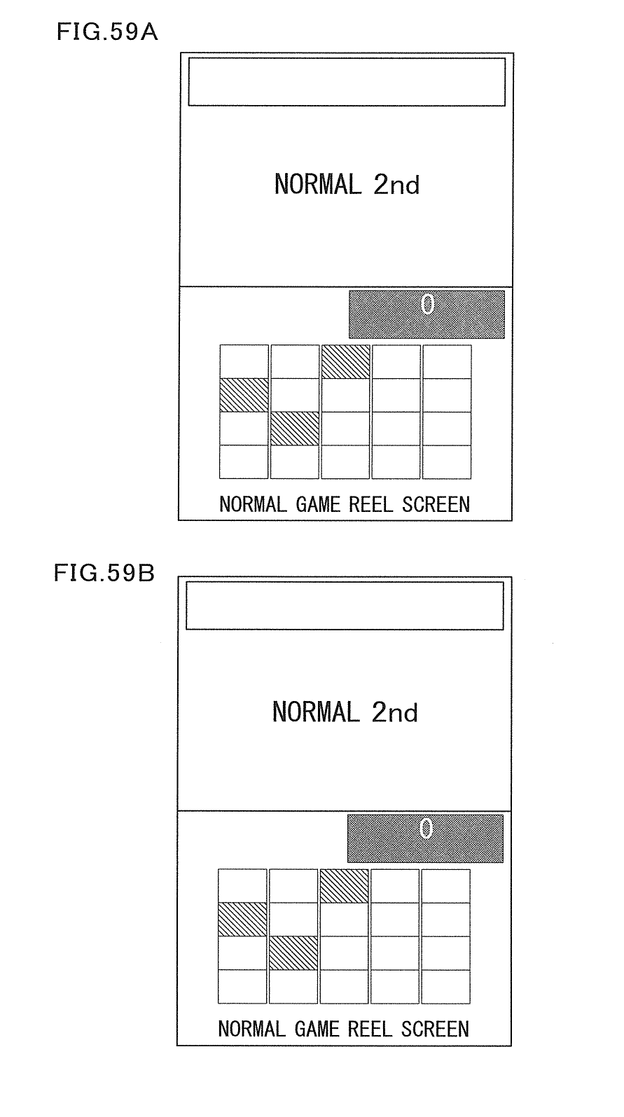

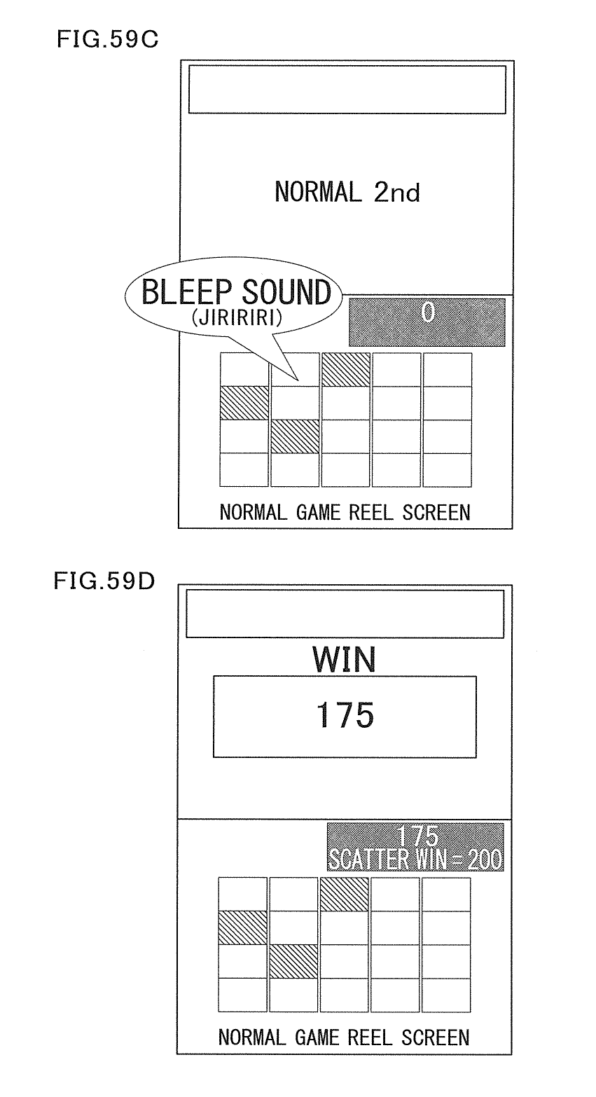

More specifically, as shown in FIG. 59A, when all the reels stop, the waiting time for 30 frames is taken as shown in FIG. 59B. Thereafter, the “bleep sound (Jiririri)” is reproduced as shown in FIG. 59C. The process proceeds to the next step after 3 seconds elapse. The symbol animation starts as shown in FIG. 59D. On the WIN signboard 134, the increment starts. The increment of the WIN meter 402 starts. The reproduction of the increment sound starts. The processes after the above are identical with those in the normal WIN.

(Operations of Slot Machine: WIN Effect: Blank Frames after Reel Stop in Large WIN)

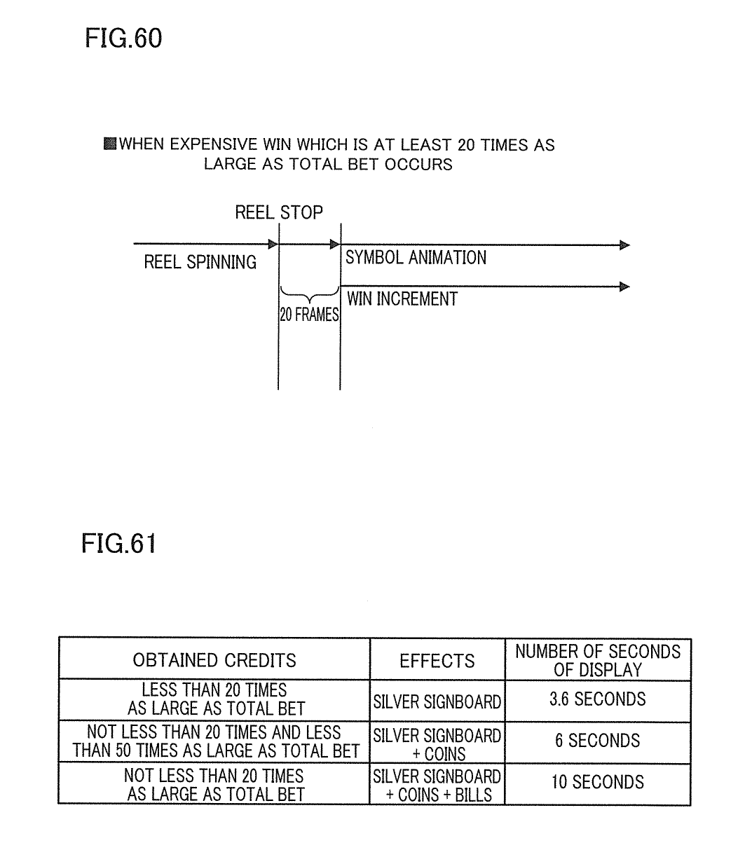

As shown in FIG. 60, when expensive WIN which is more than 20 times as large as the total bet occurs, the data between the reel stop and the start of the increment is arranged to be blank for 20 frames. The blank data for 20 frames is provided when WIN which is at least 20 times as large as the total bet occurs and the combination of 3, 4, or 5 “BISON” symbols is not achieved.

(Operations of Slot Machine: WIN Effect: TOTAL WIN Signboard after Free Game)

After the end of the free game, the total number of obtained credits is displayed on the 1st screen 141a. In accordance with the obtained credit amount (i.e., how many times as large as the total bet), one of three types of effects is used.

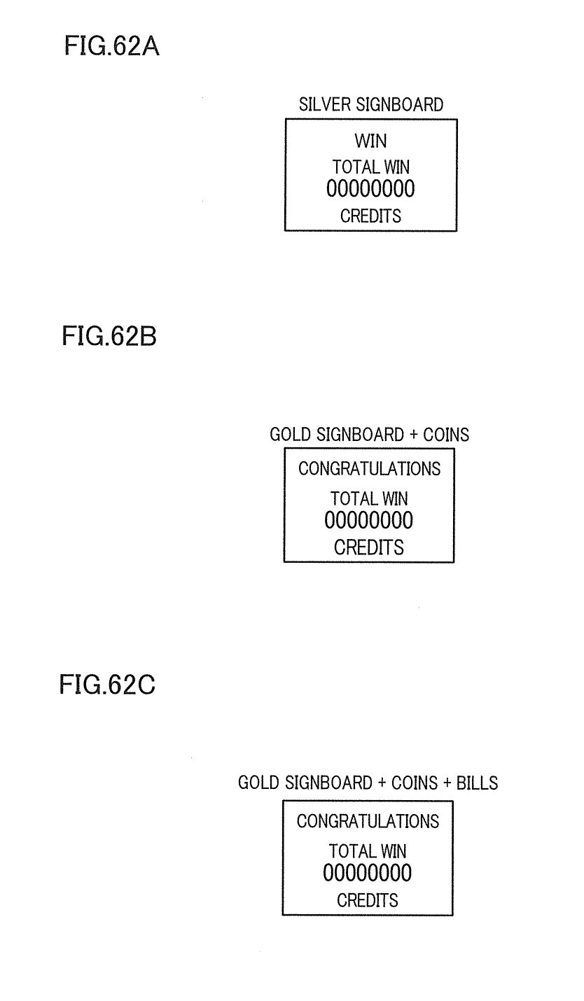

To be more specific, as shown in FIG. 61, the relationship between the obtained credit amount, the effect, and display seconds is as below. When the total obtained credit is less than 20 times as large as the total bet, the Silver Signboard is displayed for 3.6 seconds as shown in FIG. 62A. When the total obtained credit is not less than 20 times and less than 50 times as large as the total bet, the Gold Signboard and coins are displayed for 6 seconds as shown in FIG. 62B. When the total obtained credit is more than 50 times as large as the total bet, the Gold Signboard and coins and bills are displayed for 10 seconds as shown in FIG. 62C. When the “display seconds” elapse, the total WIN signboard disappears. Furthermore, after four seconds elapse from the start of the image display, the image display can be skipped by pressing the spin button or the MAX-BET button.

(Operations of Slot Machine 10: Gamble Game)

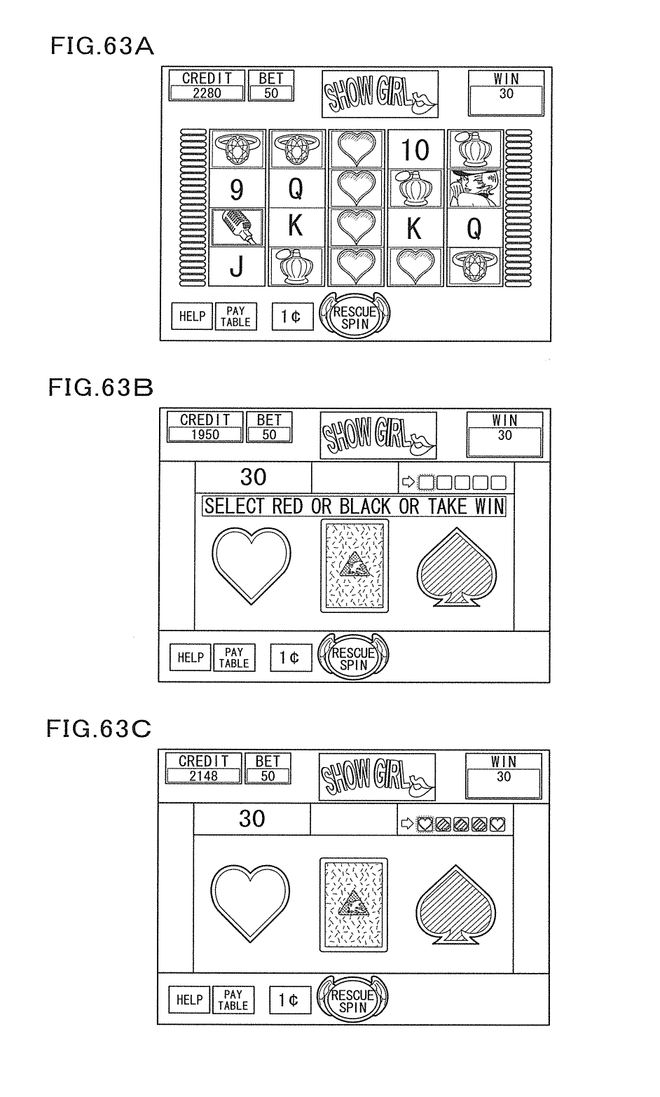

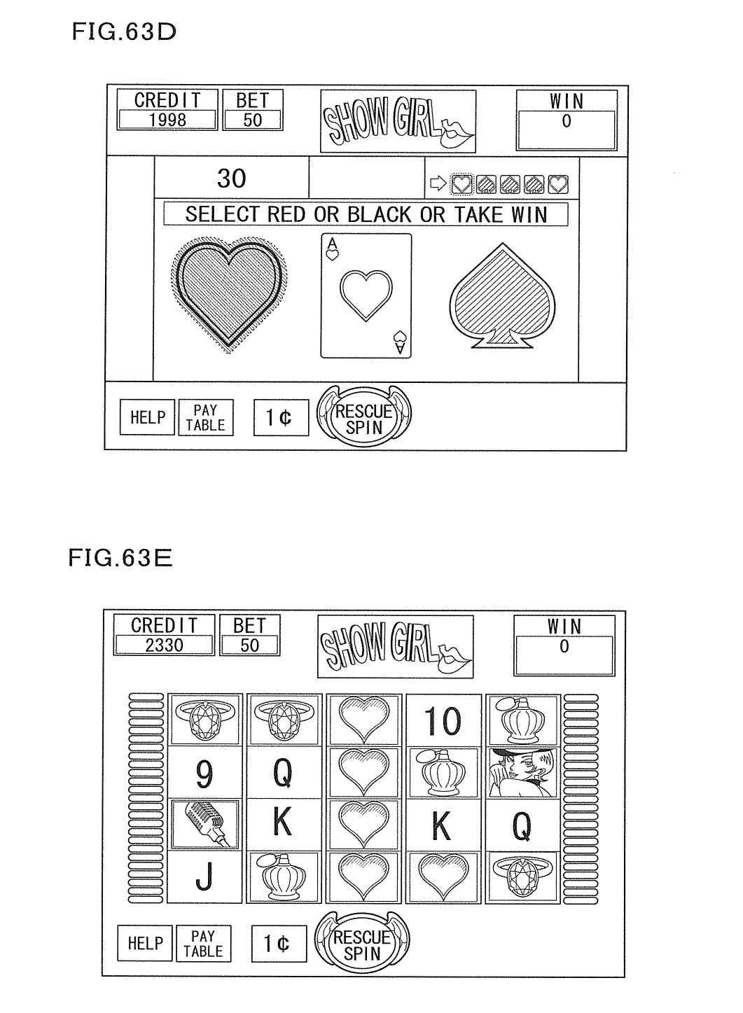

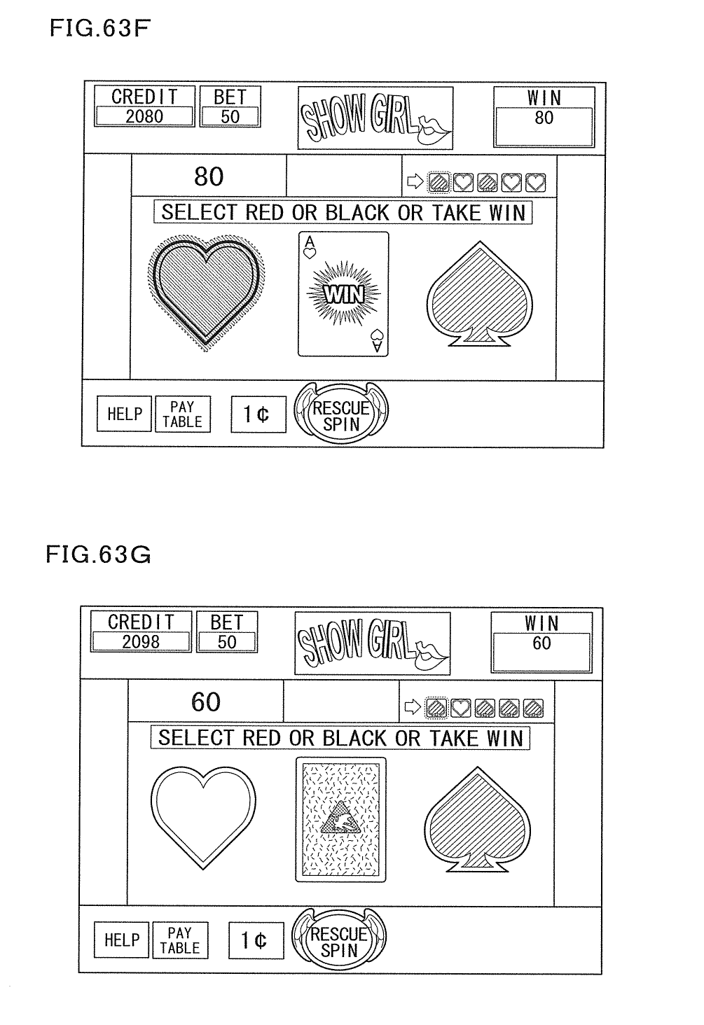

FIG. 63A to FIG. 63G show the operations of a gamble screen. The limit of the value winnable in Gamble is set in the AUDIT. The maximum number of times of Gamble is also set in the AUDIT. For example, the ultimate maximum number of times is five and the number of times of Gamble can be set so as to be five or lower. Whether the touch panel can be used is switchable in some countries.

More specifically, as shown in FIG. 63A, the amount of WIN is 30 dollars, and 1 credit corresponds to 1 dollar. As shown in FIG. 63B, when the shifting to the Gamble screen occurs, the message “PLAY ON, GAMBLE or TAKE WIN” disappears. Immediately after the clearance of the RAM, the card history is empty until the Gamble game is played. At this stage, the red button is turned on, the black button is turned on, and TAKE WIN button is turned on. The other buttons are turned off except the change button.

As shown in FIG. 63C, the amount bet is displayed on “GAMBLE AMOUNT”. For the selection of “Red” or “Black”, the operation proceeds to the process shown in FIG. 63D in case of failure, or proceeds to the process shown in FIG. 63F in case of success. If TAKE WIN is selected, the amount of WIN is added to the credit at once and the idle state returns. At this stage, if “Red” or “Black” is selected, the red button, the black button, and the TAKE WIN button are turned off. If TAKE WIN is selected, the button LED returns to the idle state.

In case of failure in Gamble, as shown in FIG. 63D, the non-selected option is darkened. At the left edge of the gamble history field, the card history is displayed at once. The preceding card history moves right. The trace of the movement is not presented in animation, and hence the history is rewritten at once. The central card result is displayed at once. At this stage, there are no change in the WIN meter and the gamble amount meter. Failure sound is reproduced and the shifting to the main game screen is performed after 1.2 seconds pass. At the same time, the red button, the black button, and the TAKE WIN button are turned off.

As shown in FIG. 63E, at the same time as the switching to the main game screen, the display on the WIN meter becomes 0. The button LED also returns to the idle state. In case of success in Gamble, as shown in FIG. 63F, the non-selected option is darkened. At the left edge of the gamble history field, the card history is displayed at once. The preceding card history moves right. The trace of the movement is not presented in animation, and hence the history is rewritten at once. Thereafter, a normal card and a card with the WIN text are alternated on the central card in each frame, and success sound is reproduced (for 1.2 second). To the value on the WIN meter, the value obtained in Gamble is added at once. The gamble amount is unchanged at this stage.

When Gamble is played until reaching the upper limit number of times, the amount of WIN is added to the credit at once and the idle state returns. When the number of times of playing of Gamble has not reached to the upper limit number of times, the operation shifts to the process shown in FIG. 63G. At the same time, the red button, the black button, and the TAKE WIN button are turned off.

As shown in FIG. 63G, the card is overturned. Then the operation goes back to the process shown in FIG. 63D. At this stage, if “Red” or “Black” is selected, the red button, the black button, and the TAKE WIN button are turned off. If TAKE WIN is selected, the button LED returns to the idle state.

(Operations of Slot Machine 10: Residual Gamble Game)

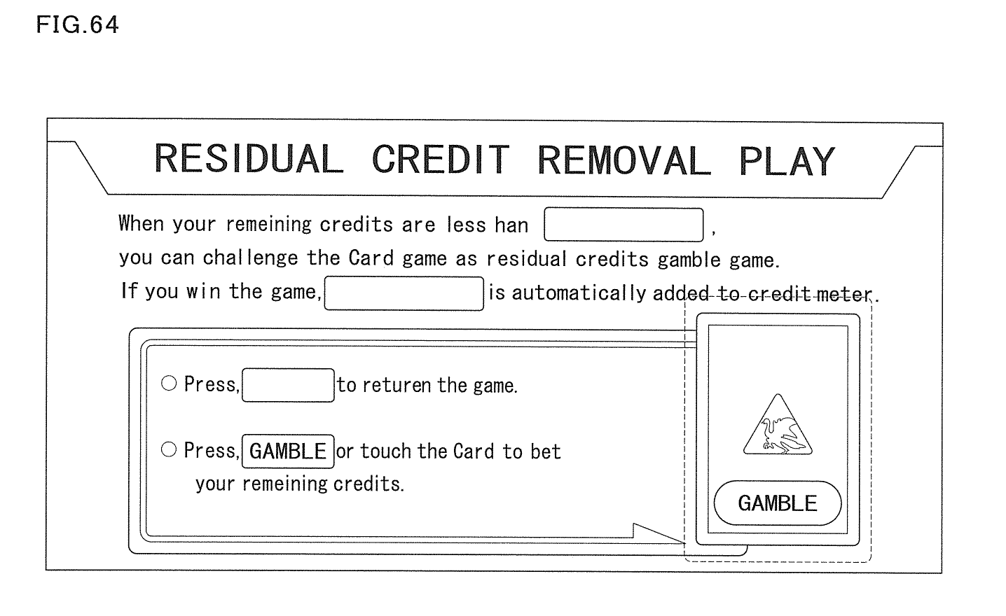

As shown in FIG. 64, when the money is lower than the processable value such as one dollar, a “RESIDUAL GAMBLE” screen is displayed if a gamble start condition such as pressing of the collect button is satisfied. When the gamble button is pressed, Gamble starts. On the other hand, when the collect button is pressed, “Call Attendant” is displayed. When the spin button 46 is pressed, the screen of the normal game comes back.

When “WIN” is achieved in Gamble, a predetermined amount of money such as one cent is awarded and a token is paid out through the hopper. In addition to the above, addition to the credit meter is executed. Thereafter, after a predetermined time such as two seconds elapses, the screen of the normal game comes back. On the other hand, when “LOSE” appears in Gamble, a LOSE screen is displayed. Thereafter, after a predetermined time such as two seconds elapses, the screen of the normal game comes back.

The roles of the buttons in the progress of the gamble game will be described. The cash-out button 32 functions as “TAKE WIN” in the state of GAMBLE ON and functions as “TAKE WIN” in the state of GAMBLE OFF. The gamble button 44 functions as “Gamble Start” in the state of GAMBLE ON and functions as “-” in the state of GAMBLE OFF. The MAX-BET button 45 functions as “Invalidated” in the state of GAMBLE ON and functions as “Gamble Start” in the state of GAMBLE OFF. The spin button 46 functions as “To Normal Game” in the state of GAMBLE ON and functions as “To Normal Game” in the state of GAMBLE OFF.

The “RESIDUAL GAMBLE” screen has a card display area, a navigation area, and a meter area. In the card area is displayed a card image. The entirety of the card area has a touch sensor function. On the navigation area, various navigation texts are displayed. The used card image is included in the common images. The system font is identical with the font used in the denomination. There is a blank corresponding to 7 characters. The numbers may include a dot.

The limit of the value winnable in Gamble is set in the AUDIT. The maximum number of times of Gamble is also set in the AUDIT. For example, the ultimate maximum number of times is five and the number of times of Gamble can be set so as to be five or lower. Whether the touch panel can be used is switchable in some countries.

In regard to the game progress, the buttons function as follows: in the state of Gamble ON, the cash-out button functions as “Take Win”, the gamble button functions as “GAMBLE Start”, the MAX-BET button functions as “Invalid”, the spin button functions as “Shift to Normal Game”. The other buttons are not used.

The above embodiment thus described solely serves as a specific example of the present invention, and the present invention is not limited to such an example. Specific structures and various means may be suitably designed or modified. Further, the effects of the present invention described in the above embodiment are not more than examples of most preferable effects achievable by the present invention. The effects of the present invention are not limited to those described in the embodiments described above.

Further, the detailed description above is mainly focused on characteristics of the present invention to for the sake of easier understanding. The present invention is not limited to the above embodiments, and is applicable to diversity of other embodiments. Further, the terms and phraseology used in the present specification are adopted solely to provide specific illustration of the present invention, and in no case should the scope of the present invention be limited by such terms and phraseology. Further, it will be obvious for those skilled in the art that the other structures, systems, methods or the like are possible, within the spirit of the present invention described in this specification. The description of claims therefore shall encompass structures equivalent to the present invention, unless otherwise such structures are regarded as to depart from the spirit and scope of the present invention. Further, the abstract is provided to allow, through a simple investigation, quick analysis of the technical features and essences of the present invention by an intellectual property office, a general public institution, or one skilled in the art who is not fully familiarized with patent and legal or professional terminology. It is therefore not an intention of the abstract to limit the scope of the present invention which shall be construed on the basis of the description of the claims. To fully understand the object and effects of the present invention, it is strongly encouraged to sufficiently refer to disclosures of documents already made available.

The detailed description of the present invention provided hereinabove includes a process executed on a computer. The above descriptions and expressions are provided to allow the one skilled in the art to most efficiently understand the present invention. A process performed in or by respective steps yielding one result or blocks with a predetermined processing function described in the present specification shall be understood as a process with no self-contradiction. Further, the electrical or magnetic signal is transmitted/received and written in the respective steps or blocks. It should be noted that such a signal is expressed in the form of bit, value, symbol, text, terms, number, or the like solely for the sake of convenience. Although the present specification occasionally personifies the processes carried out in the steps or blocks, these processes are essentially executed by various devices. Further, the other structures necessary for the steps or blocks are obvious from the above descriptions.

What is claimed is:

1. A gaming machine including one or more reels each of which is configured to allow a predetermined type of symbols to be stacked thereon, the gaming machine comprising:
a symbol display device configured to variably display and rearrange symbols including the predetermined type of symbols and one or more wild symbols which are able to substitute for the predetermined type of symbols on reels in a plurality of columns; and
a controller programmed to execute the processes of: (a1) executing a free game when a trigger condition is established based on a rearrangement manner of the symbols on the symbol display device, and (a2) awarding a special payout when, in the free game, there is caused a rearrangement manner where a prize is established with the one or more wild symbols rearranged, the special payout being calculated by multiplying a payout for the prize by a multiplying factor depending on the number of the rearranged wild symbols.

2. A gaming machine including one or more reels each of which is configured to allow a predetermined type of symbols to be stacked thereon, the gaming machine comprising:
a symbol display device configured to variably display and rearrange symbols including the predetermined type of symbols and one or more wild symbols which are able to substitute for the predetermined type of symbols on reels in a plurality of columns;
a symbol data table in which the symbols are stored in association with the reels in the plurality of columns; and
a controller programmed to execute the processes of: (b1) executing a normal game by rearranging the symbols on the symbol display device based on the symbol data table; (b2) determining whether a trigger condition is established in the normal game based on a rearrangement manner of the symbols; (b3) when it is determined that the trigger condition is established, executing a free game as a feature game by rearranging the symbols based on the symbol data table, and changing setting so that, in the feature game, the wild symbols function as substitute symbols for the predetermined type of symbols and as symbols used for determining a multiplying factor; and (b4) awarding a special payout when, in the free game as the feature game, there is caused a rearrangement manner where a prize is established with the one or more wild symbols rearranged, the special payout being calculated by multiplying a payout for the prize by a multiplying factor depending on the number of the rearranged wild symbols.

3. The gaming machine according to claim 2, wherein:
the symbol data table includes a symbol data table for the normal game and a symbol data table for the feature game;
the number of the wild symbols in the symbol data table for the feature game is larger than the number of the wild symbols in the symbol data table for the normal game; and
the controller uses the symbol data table for the normal game as the symbol data table in the process of (b1), and uses the symbol data table for the feature game as the symbol data table in the process of (b3).

4. The gaming machine according to claim 2, wherein:
the symbol data table includes a symbol data table for the normal game and a symbol data table for the feature game;
the symbol data table for the feature game has a data structure in which the number of the predetermined symbols stacked is larger than that in the symbol data table for the normal game; and
the controller uses the symbol data table for the normal game as the symbol data table in the process of (b1), and uses the symbol data table for the feature game as the symbol data table in the process of (b3).

5. The gaming machine according to claim 4, wherein:
the controller is programmed to execute a process of rearranging the symbols, on the symbol display device, for each column sequentially from the first column to the last column of the reels; and
the symbol data table for the feature game has a data structure in which an increase in the number of the predetermined type of symbols stacked on the reel of the last column is the largest among those on all the reels in the columns.

6. The gaming machine according to claim 5, wherein
the symbol data table for the feature game stores therein the wild symbols only in association with the reels of one or more columns interposed between the first column and the last column.

7. The gaming machine according to claim 6, wherein
the symbol data table for the feature game has a data structure in which the wild symbols are placed so as to sandwich a stack of the predetermined type of symbols.

8. The gaming machine according to claim 7, wherein:
in the normal game, the controller determines whether a prize is established utilizing a function of the wild symbols as a substitute for any type of symbols; and
in the free game of the feature game, the controller determines whether a prize is established utilizing the function of the wild symbols as a substitute for any type of symbols, and calculates a payout by multiplying a payout for the prize by a multiplying factor depending on the number of the rearranged wild symbols utilizing a function of the wild symbols as a basis for the multiplying factor.

9. The gaming machine according to claim 3, wherein:
the symbol data table includes a symbol data table for the normal game and a symbol data table for the feature game; the symbol data table for the feature game has a data structure in which the number of the predetermined symbols stacked is larger than that in the symbol data table for the normal game; and
the controller uses the symbol data table for the normal game as the symbol data table in the process of (b1), and uses the symbol data table for the feature game as the symbol data table in the process of (b3).

10. The gaming machine according to claim 9, wherein:
the controller is programmed to execute a process of rearranging the symbols, on the symbol display device, for each column sequentially from the first column to the last column of the reels; and
the symbol data table for the feature game has a data structure in which an increase in the number of the predetermined type of symbols stacked on the reel of the last column is the largest among those on all the reels in the columns.

11. The gaming machine according to claim 10, wherein
the symbol data table for the feature game stores therein the wild symbols only in association with the reels of one or more columns interposed between the first column and the last column.

12. The gaming machine according to claim 11, wherein
the symbol data table for the feature game has a data structure in which the wild symbols are placed so as to sandwich a stack of the predetermined type of symbols.

13. The gaming machine according to claim 12, wherein:
in the normal game, the controller determines whether a prize is established utilizing a function of the wild symbols as a substitute for any type of symbols; and
in the free game of the feature game, the controller determines whether a prize is established utilizing the function of the wild symbols as a substitute for any type of symbols, and calculates a payout by multiplying a payout for the prize by a multiplying factor depending on the number of the rearranged wild symbols utilizing a function of the wild symbols as a basis for the multiplying factor.
